(19) United States
(12) Patent Application Publication
(10) Pub. No.: US 2026/0333177 A1
(43) Pub. Date: Oct. 22, 2026

(54) PROACTIVE CONDITIONAL HANDOVER

(71) Applicant: InterDigital Patent Holdings, Inc., Wilmington, DE (US)

(72) Inventors: Umer Salim, Vallauris (FR); Pascal Adjakple, Great Neck, NY (US); Ravikumar Pragada, Warrington, PA (US)

(73) Assignee: InterDigital Patent Holdings, Inc., Wilmington, DE (US)

(21) Appl. No.: 19/109,458

(22) PCT Filed: Sep. 6, 2023
(86) PCT No.: PCT/US2023/032053

§ 371 Date: Mar. 6, 2025

Related U.S. Application Data
(60) Provisional application No. 63/403,950, filed on Sep. 6, 2022.

(51) Int. Cl. H04W 36/36; H04W 36/00

(52) U.S. Cl. CPC H04W 36/362; H04W 36/0077

(57) ABSTRACT

A WTRU may perform a proactive conditional handover (CHO). A WTRU may provide assistance information to a network (e.g., position, location, panels, FoV, application-QoS, and/or measurement data). The WTRU may receive CHO configuration information and/or network coverage information (e.g., in response to the provided assistance information). The CHO configuration information may include a set of CHO candidates (e.g., a candidate cell and associated beam(s)) that are associated with a respective mobility cause. The WTRU may determine a mobility cause. The WTRU may determine a CHO candidate upon based on the mobility cause and network coverage information. The WTRU may send a RACH transmission to the determined CHO candidate, for example, if an execution condition for the CHO candidate is fulfilled.

### CROSS-REFERENCE TO RELATED APPLICATIONS

This application claims the benefit of Provisional U.S. Patent Application No. 63/403,950, filed Sep. 6, 2022, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for proactive conditional handover (CHO) (e.g., CHO as described herein). Proactive conditional handover may include a wireless transmit/receive unit (WTRU) providing assistance information to a network. The WTRU may receive (e.g., from a base station of the network) coverage information, indicating the network's deployment of cells and/or beams. The WTRU may receive a proactive CHO configuration (e.g., via a WTRU dedicated signal or a broadcast system information). The proactive CHO configuration may include CHO candidates (e.g., cell(s) and associated beam(s) that may be suitable for performing CHO upon a determination of link degradation. The CHO candidates may be associated with (e.g., organized into sets based on) mobility causes, for example, device mobility (e.g., a change in position/orientation of the WTRU) and/or external mobility (e.g., movement of an external object). For example, a candidate CHO of external mobility CHO configuration information (e.g., a configuration set) may be determined/selected by the WTRU if a mobility cause leading to degradation of the WTRU's current link is determined to be external mobility.

A device (e.g., a WTRU) may comprise a processor configured to perform one or more actions. The device may send assistance information. The assistance information may indicate a characteristic associated with the WTRU. The WTRU may receive coverage information, external mobility conditional handover (CHO) configuration information (e.g., an external mobility CHO configuration set), and/or device mobility CHO configuration information (e.g., a device mobility CHO configuration set). The WTRU may determine a mobility cause. The WTRU may determine a CHO candidate cell based on a non-radio measurement, the mobility cause, and/or the coverage information. The WTRU may determine that an execution condition is satisfied for the CHO candidate cell. The WTRU may send a RACH transmission to the CHO candidate cell.

The device may determine, based on the non-radio measurement, a location associated with the WTRU and an orientation associated with the WTRU. The determination of the CHO candidate cell may be further based on the location and/or the orientation of the WTRU.

The WTRU may determine a RACH configuration based on the CHO candidate. The RACH transmission may be sent in accordance with the RACH configuration.

The CHO candidate cell may be associated with one or more beams, and the WTRU may determine a RACH configuration based on a strongest beam of the one or more beams associated with the CHO candidate cell. The RACH transmission may be sent in accordance with the RACH configuration.

The WTRU may determine that a radio link condition indicating the degradation of a serving link is satisfied. The mobility cause may be associated with the radio link condition.

The mobility cause may be external mobility, and the CHO candidate may be indicated in the external mobility CHO configuration information.

The mobility cause may be device mobility, and the CHO candidate may be indicated in the device mobility CHO configuration information.

The determination that the execution condition is satisfied may be based on a radio measurement and the non-radio measurement.

The WTRU may switch an active antenna panel based on the coverage information and a CHO configuration.

The coverage information may indicate a network deployment of cells and beams. The coverage information may be received via one or more of: a WTRU dedicated signal or a broadcast system information.

A wireless transmit/receive unit (WTRU) may provide assistance information to a network, which may include, for example, information on one or more of the following: position, location, panels, field of view (FoV), application-quality of service (QoS) from local sensors, and/or measurement data.

The network (e.g., a node, such as a gNB, of the network) may prepare a proactive conditional handover configuration based on (e.g., in response to) the WTRU assistance information. The network may prepare a proactive CHO configuration based on, for example, a node's knowledge of network deployment. The network may transmit the proactive conditional handover configuration to the WTRU.

A proactive conditional handover configuration may include a set of CHO candidates (e.g., candidate cells and their beams). Beam indices (e.g., relevant beam indices) may be provided for a (e.g., each) CHO candidate cell. A conditional handover configuration may include (e.g., for each CHO candidate) a mapping of a (cell, beam) pair to geographic coordinates (e.g., position/location, angular span, WTRU Panel).

A WTRU may compute updated geographic coordinates and orientation, for example, based on information (e.g., from local sensors) and/or (pre)configured thresholds. A WTRU may compute updated geographic coordinates and orientation, for example, based on (e.g., after) a mobility event (e.g., resulting from device mobility or mobility in the environment) that may lead to compromised link quality.

A WTRU may determine (e.g., derive) the highest priority CHO candidate (e.g., (cell, beam) pair) from the (e.g., network configured) mapping against the (e.g., suitable, estimated) geographical coordinates.

A WTRU may evaluate a CHO execution condition for a determined CHO candidate (e.g., (cell, beam) pair).

A WTRU may perform a conditional handover to a determined CHO candidate (e.g., (cell, beam) pair), for example, if a CHO condition gets fulfilled. A WTRU may perform a conditional handover to a determined CHO candidate (e.g., (cell, beam) pair), for example, by transmitting a random access channel (RACH) to the CHO candidate (e.g., according to (pre)configured parameters).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example timing diagram for performing a WTRU attach.

FIGS. 3A and 3B show example situations for beam failure.

FIG. 4 illustrates an example of parallel running procedures for beam/cell level mobility.

FIG. 5 illustrates an example of an intra-NR inter-gNB handover.

FIG. 6 illustrates an example of an intra-NR RAN conditional handover.

FIG. 7 illustrates an example of mobility resulting from WTRU rotation/orientation.

FIG. 8 illustrates an example of a proactive configuration for a conditional handover (e.g., with rotational motion).

FIG. 9 illustrates an example of a proactive configuration of a conditional handover (e.g., with translational and rotational motion).

FIG. 10 illustrates an example of a proactive beam recovery and conditional handover configuration.

FIG. 11 illustrates an example of a flow chart for a proactive conditional handover with device and external mobility configurations.

FIG. 12 illustrates a flow chart showing an example for a proactive conditional handover with a unified mobility configuration.

FIG. 13 illustrates an example of a proactive CHO with a coverage ensemble, e.g., which may be provided as dedicated signaling.

FIG. 14 illustrates an example of a proactive CHO, e.g., with an SIB based coverage ensemble.

FIGS. 15A, 15B, and 15C illustrate an example where a WTRU may be configured with a proactive BFR configuration and a proactive CHO configuration.

### DETAILED DESCRIPTION

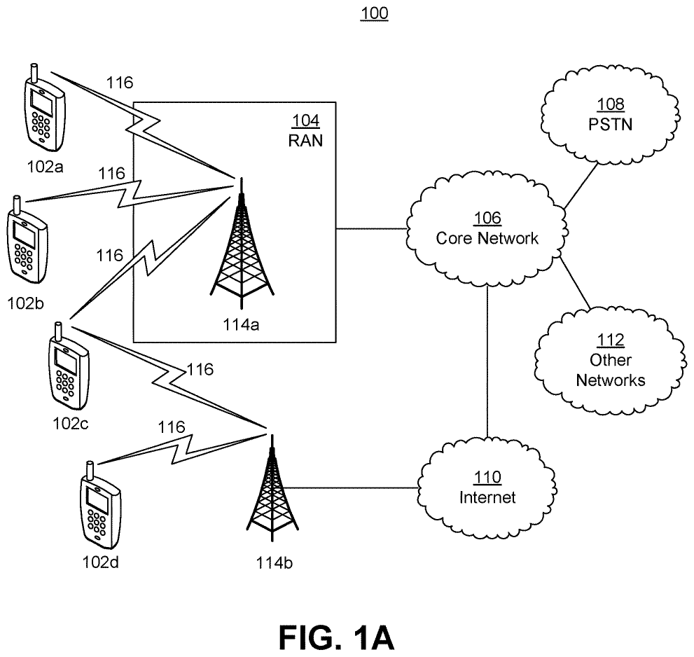

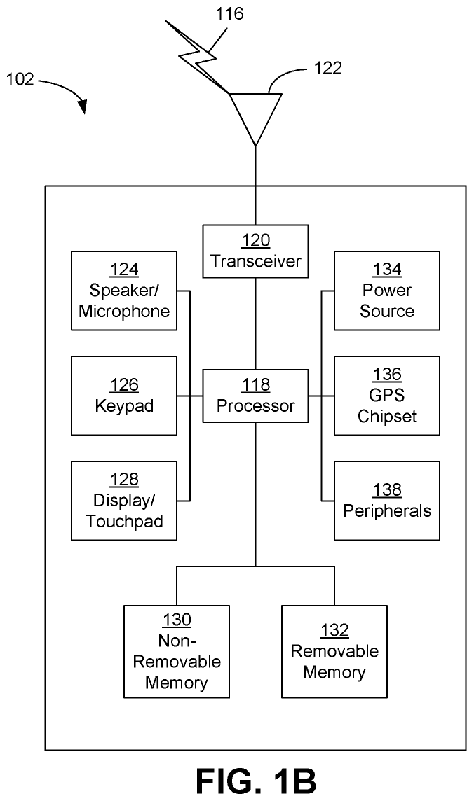

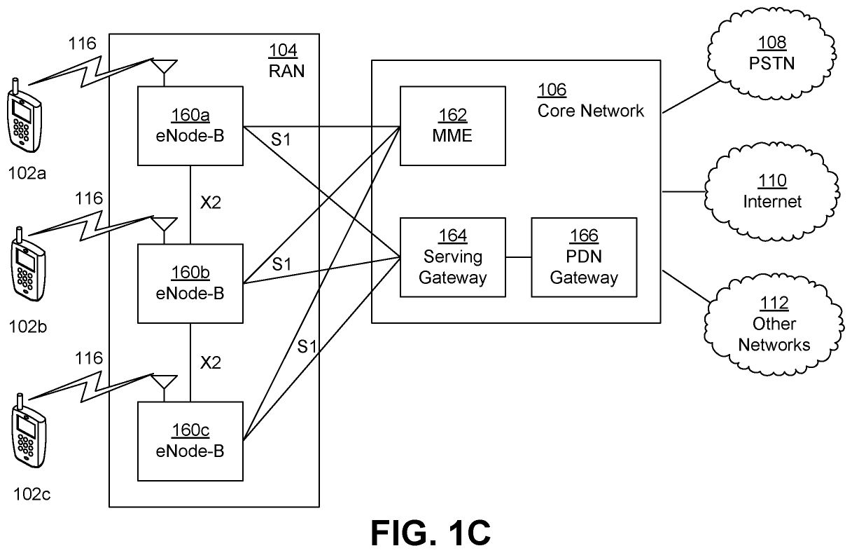

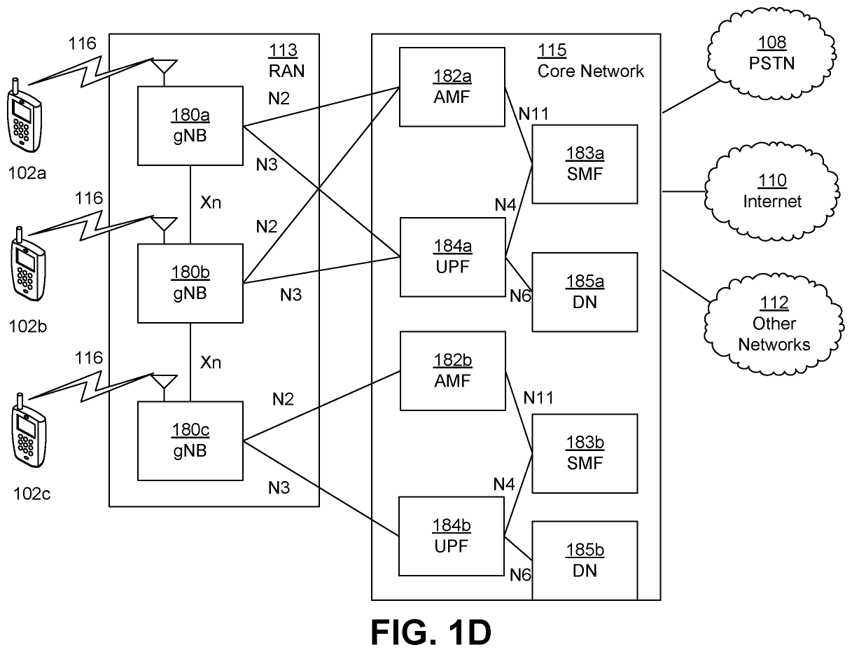

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for proactive conditional handover (CHO). Proactive CHO (e.g., CHO as described herein) may include a wireless transmit/receive unit (WTRU) providing assistance information to a network. The WTRU may receive (e.g., from a base station of the network) coverage information, indicating the network's deployment of cells and/or beams. The WTRU may receive a proactive CHO configuration (e.g., via a WTRU dedicated signal or a broadcast system information). The proactive CHO configuration may include CHO candidates (e.g., cell(s) and associated beam(s)) that may be suitable for performing CHO upon a determination of link degradation. The CHO candidates may be associated with (e.g., organized into sets based on) mobility causes, for example, device mobility (e.g., a change in position/orientation of the WTRU) and/or external mobility (e.g., movement of an external object). For example, a candidate CHO of an external mobility CHO configuration set may be determined/selected by the WTRU if a mobility cause leading to degradation of the WTRU's current link is determined to be external mobility.

A device (e.g., a WTRU) may comprise a processor configured to perform one or more actions. The device may send assistance information. The assistance information may indicate a characteristic associated with the WTRU. The WTRU may receive coverage information, an external mobility conditional handover (CHO) configuration set, and/or a device mobility CHO configuration set. The WTRU may determine a mobility cause. The WTRU may determine a CHO candidate cell based on a non-radio measurement, the mobility cause, and/or the coverage information. The WTRU may determine that an execution condition is satisfied for the CHO candidate cell. The WTRU may send a RACH transmission to the CHO candidate cell.

The device may determine, based on the non-radio measurement, a location associated with the WTRU and an orientation associated with the WTRU. The determination of the CHO candidate cell may be further based on the location and/or the orientation of the WTRU.

The WTRU may determine a RACH configuration based on the CHO candidate. The RACH transmission may be sent in accordance with the RACH configuration.

The CHO candidate cell may be associated with one or more beams, and the WTRU may determine a RACH configuration based on a strongest beam of the one or more beams associated with the CHO candidate cell. The RACH transmission may be sent in accordance with the RACH configuration.

The WTRU may determine that a radio link condition indicating the degradation of a serving link is satisfied. The mobility cause may be associated with the radio link condition.

The mobility cause may be external mobility, and the CHO candidate may be indicated in the external mobility CHO configuration set.

The mobility cause may be device mobility, and the CHO candidate may be indicated in the device mobility CHO configuration set.

The determination that the execution condition is satisfied may be based on a radio measurement and the non-radio measurement.

The WTRU may switch an active antenna panel based on the coverage information and a CHO configuration.

The coverage information may indicate a network deployment of cells and beams. The coverage information may be received via one or more of: a WTRU dedicated signal or a broadcast system information.

Communication to and/or from a network may be to/from a network entity. Such a network entity may be referred to herein as a node (e.g., a base station, a gNB, etc.).

A conditional handover (CHO) candidate as used herein may refer to a candidate cell and/or associated beam(s). In examples, a CHO candidate may be a (cell, beam) pair.

Beam based procedures may be provided for use in a network (e.g., 5G NR). A network (e.g., 5G-NR) may operate in multiple (e.g., two) different frequency ranges, which may include, for example, sub-6 GHz (e.g., referred to as frequency range 1 (FR1)) and/or millimeter wave (mmWave) (e.g., referred to as frequency range 2 (FR2). The availability of sub-6 GHz range may become more limited. The mmWave frequency bands with wider bandwidths may be used (e.g., more predominantly than sub-6 GHz bands). The FR2 range may extend to 71 GHz. The range between 51.4 GHz to 71 GHz may be referred to as FR2-2.

A network (e.g., 3GPP 5G NR) may have Physical Layer (PHY) and Medium Access Control (MAC) layer features to support directional communications. Features may include beam management, which may be used to acquire and/or maintain beams. Initial access procedures may support (e.g., ensure successful) directional transmission. Transmission and reception may happen through narrow beams. One or more procedures may detect beam failure and/or recover from beam failure.

Beam management may be implemented. Beam management may include a set of Layer 1 (PHY) and Layer 2 (MAC) procedures, for example, to establish and/or retain an optimal beam pair for (e.g., good) connectivity. A beam pair may include a transmit beam and/or a corresponding receive beam in a (e.g., one) link direction.

A WTRU may (e.g., must) perform cell search and selection procedures. A WTRU may obtain initial cell synchronization and system information, for example, before the WTRU may communicate with the network. A WTRU may (e.g., to begin communication with a network) acquire frame synchronization, determine (e.g., find out) cell identity, and/or decode the master information block (MIB) and/or a system information block (e.g., SIB1).

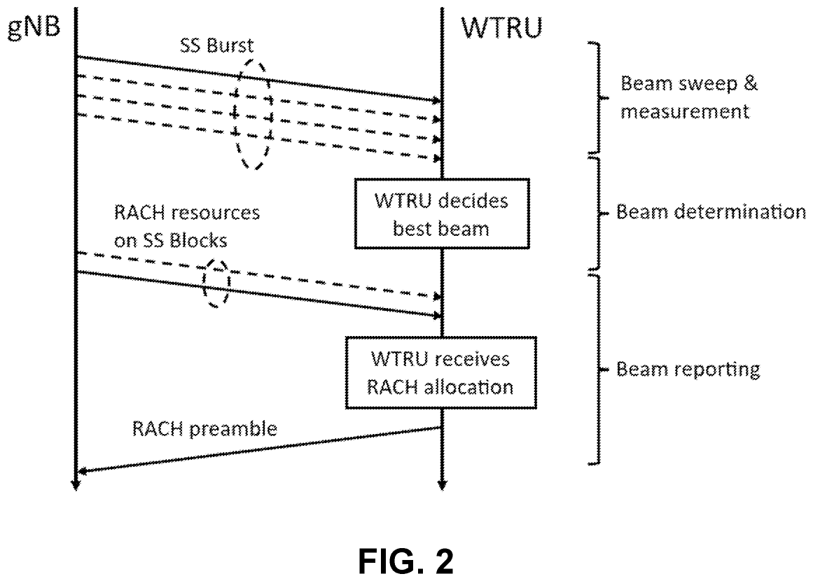

FIG. 2 illustrates an example timing diagram for performing a WTRU attach.

A multi-antenna system may transmit multiple beams. A WTRU may detect the beams from the network (e.g., a node, such as a gNB, of the network), for example, as part of an initial access procedure, where the WTRU (e.g., normally) detects (e.g., all) the beams in the search space. FIG. 2 shows an example of a timing diagram for the WTRU attach procedure, which may include one or more (e.g., various) aspects of beam management. A WTRU may, for example, find (e.g., select) a beam, decode (e.g., necessary) system information through the beam, and/or initiate an uplink (UL) connection, e.g., using received parameters.

Beam sweeping and initial access may be performed. A node of a network (e.g., a gNB) may transmit beams in multiple (e.g., all) directions in a burst, for example, at an interval (e.g., regular defined intervals). A WTRU may (e.g., if/when the WTRU is synchronizing with the network) read the synchronization signal block (SSB) and/or extract one or more of the following: a primary synchronization signal (PSS), a secondary synchronization signal (SSS), a physical broadcast channel (PBCH), and/or a demodulation reference signal (DMRS).

A PSS may include one or more (e.g., one of three) possible sequences. A PSS may provide a timing estimate. An SSS may include one or more (e.g., one of 336) possible sequences. An SSS may provide a cell ID (e.g., one of 3*336=1008 cell IDs). A PBCH and/or a DMRS may include a master information block (MIB). A PBCH and/or a DMRS may include information (e.g., basic information) to proceed (e.g., take the next step), which may include decoding a system information block (e.g., SIB-1).

Beam measurement and determination may be performed. A WTRU may measure beam strength, for example, by measuring received signal power through a beam. Beam strength in an idle mode may be based on the synchronization signals. Beam strength in connected mode may be based on the channel state information reference signal (CSI-RS) in downlink and/or sounding reference signal (SRS) in uplink. A WTRU may search for a (e.g., the best) beam (e.g., periodically), for example, using a threshold criteria (e.g., (pre) defined by the network, for example a node of the network). A WTRU may identify the beam that has highest reference signal received power (RSRP).

Beam reporting may be performed. A WTRU may report the best beam identified by the WTRU to the network, which may be referred to as beam reporting.

A random access channel (RACH) is an uplink channel that may be used during initial access and/or if/when a WTRU is out of sync with the network (e.g., to establish synchronization). A WTRU may (e.g., in idle mode, after the WTRU selected the beam) use one or more RACH intervals for the WTRU (e.g., with a certain time and/or frequency offset) to transmit the RACH preamble. The WTRU may transmit the physical RACH (PRACH) preamble corresponding to the SS block for which the best beam was identified. There may be a one-to-one mapping between the received SS block and the transmitted RACH preamble. The WTRU may report the best beam to the gNB. The gNB (e.g., upon receiving RACH in a given interval) may determine (e.g., back-calculate) the best beam through which a WTRU might have received the best synchronization signal(s).

The network may configure the WTRU to perform one or more (e.g., certain) measurements and/or report one or more measurements (e.g., on a preconfigured interval), which may be referred to as measurement reporting. A WTRU may (e.g., in connected mode, if/when the WTRU is already connected with the network and active data transfer is taking place) report the beam through a measurement report to the network (e.g., a node of the network, such as a gNB).

Beam switching may be performed. Switching from one beam to another may be referred to as intra-cell mobility or beam-level mobility. Beam switching may be based on a trigger condition for a beam and/or a configured beam switching algorithm. Beam switching may be applicable, for example, if/when a WTRU is in connected mode. Beam switching may be performed through L1/L2 procedures. Handover (e.g., on the other hand) may be used (e.g., typically) for inter-cell mobility. Handover may be an L3 procedure.

Beam and/or link failures may occur. Network procedures may detect beam failure (e.g., and/or recovery) and/or radio link failure.

Beam failure detection and recovery (BFDR) may be performed. WTRU mobility and/or changes in the wireless environment may lead to deterioration of a beam pair, for example, if/when a WTRU and the network are communicating through narrow beams. Beam level measurements and/or continuous evaluation procedures may help maintain and/or switch to the best beam pair between a WTRU and the network. The procedures may be jointly called beam failure detection and recovery (BFDR).

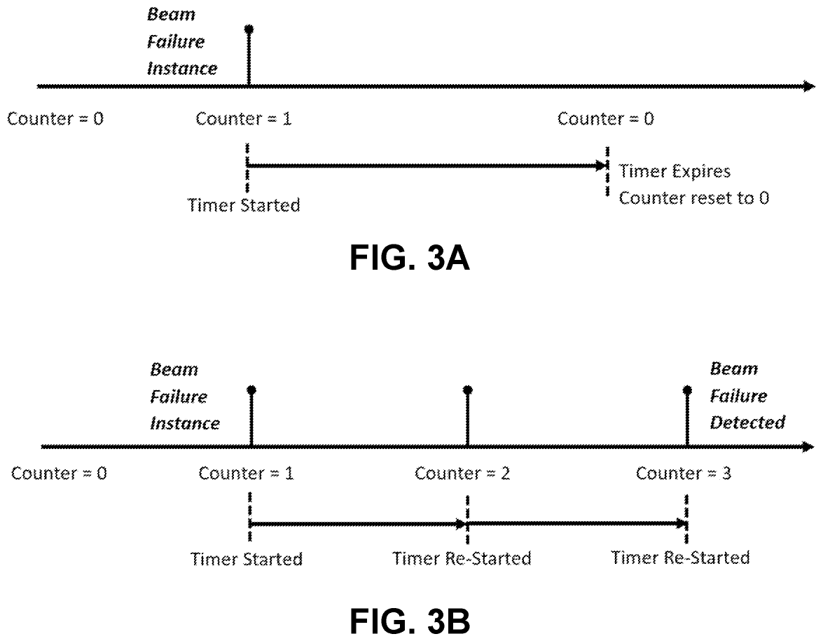

FIGS. 3A and 3B illustrate examples of beam failure detection at the MAC Layer. The PHY layer of a WTRU may generate a “Beam Failure Instance (BFI),” for example, if/when the quality of a beam deteriorates (e.g., if/when the measurements from the configured reference signals for the beam fall below a configured threshold). The MAC layer may maintain a “BeamFailureInstance Counter.” The MAC layer may increment the BFI counter and reset the “Beam Failure Detection Timer” for an (e.g., each) instance of the PHY layer reporting BFI. Beam failure may be detected, for example, if a BFI counter exceeds a configured value. Beam failure detection (BFD) may occur within the beam failure detection timer.

FIGS. 3A and 3B show example situations for beam failure. FIG. 3A shows an example where the MAC layer receives a BFI from the PHY layer, but the beam failure detection timer expires, and no beam failure is generated. FIG. 3B shows an example where the PHY Layer is reporting BFI at a rate that is not letting the timer expire, the BFI counter reaches the BFD threshold, and the MAC layer generates a BFD.

A WTRU may (e.g., after detection of the beam failure event) initiate a beam failure recovery (BFR) procedure. A WTRU may (e.g., once beam failure has been detected) try to recover from the beam failure, for example, if the candidate recovery beams are configured. A WTRU may try to validate the (e.g., configured) candidates for a given serving cell, for example, according to the configured/defined measurement quality condition(s) and thresholds. A WTRU may prepare a BFR MAC-CE or a truncated BFR MAC-CE, for example, according to the defined conditions (e.g., where the cells and/or recovery beams may be indicated for network knowledge).

A beam recovery procedure may vary/differ, for example, based on whether the beam failure is detected on an SpCell or on an SCell. In some examples (e.g., for beam recovery procedure on an SpCell), a WTRU may (e.g., after validating the configured candidate beams) choose a validated candidate beam for RACH transmission. A normal or truncated BFR MAC-CE may be sent as part of a RACH procedure. A RACH transmission may follow the parameters configured as part of a candidate beam configuration. A (e.g., successful) RACH transmission may let the network know that a WTRU has recovered through a candidate beam. In some examples (e.g., for a beam recovery procedure on an Scell), a WTRU may (e.g., after having validated the candidate beams) transmit the BFR MAC-CE or truncated BFR MAC-CE to the network. A RACH procedure may not be initiated for beam failure recovery on an SCell.

Radio link failure (RLF) may occur. A WTRU may perform radio link monitoring (RLM), for example, based on a synchronization signal block (SSB) and/or channel state information reference signals (CSI-RS), and/or signal quality thresholds (e.g., configured by the network). The PHY layer at a WTRU may make the measurements and/or pass the measurements on to the MAC and/or RRC layers. The MAC layer may be responsible for detecting beam failures. The RRC layer may be responsible for detecting radio link failure (RLF). The network may use RRC signaling to configure a WTRU with RLM reference signals (RLM-RS) and/or associated thresholds. RLM-RS may be an SSB and/or a CSI-RS (e.g., a combination of the two). The network may configure timers to be used for RLF detection/determination, for example, as part of the primary cell configuration. The PHY layer may generate an “Out-of-sync (OOS)” indication, for example, if/when the radio link quality belonging to (e.g., all of) the monitored RS(s) is worse than the configured threshold. The PHY layer may generate an “In-Sync” indication, for example, if/when the radio link quality belonging to at least one of the monitored RS is better than a configured threshold. The In-Sync and OOS indications may be passed to the RRC layer.

The criteria to declare RLF may include one or more of the following: a T310-based RLF, a T312-based RLF, a random access procedure failure, a failure in a beam failure recovery procedure, and/or an reaching the maximum number of re-transmissions from radio link control (RLC) layer.

An RLF may be a T310 based RLF, which may be based on one or more link quality measurements (e.g., using SSBs and/or CSI-RSs). For example, an RLF timer T310 may be started if consecutive out-of-sync indications (e.g., measurement below a threshold) are received a preset number of times (e.g., N310 times). The T310 timer may be reset, for example, if the channel quality recovers before the T310 timer expires. An RLF may be declared (e.g., upon expiration of the T310 timer), for example, if the channel quality does not recover before the T310 timer expires.

An RLF may be a T312 based RLF. A WTRU may start a T312 timer based on (e.g., upon) triggering a measurement report, for which the T310 timer may already be running. A T312 timer may allow a WTRU to differentiate between an RLF caused by a handover failure from an RLF caused by coverage hole. A T312 timer may (e.g., typically) be shorter than the T310 timer. A shorter T312 timer may expire earlier than a T310 timer. An RLF may be timely declared, for example, if the channel quality of the source gNB is worse than a threshold.

An RLF may be declared based on a random access procedure failure. An RLF may be declared, for example, if multiple RACH attempts to connect to a gNB fail, e.g., consecutively.

An RLF may be declared based on a failure in a beam failure recovery procedure. A failure in recovering to a beam after detecting beam failure may lead to an indication of link failure.

An RLF may be declared based on (e.g., due to) reaching the maximum number of re-transmissions from a radio link control (RLC) layer.

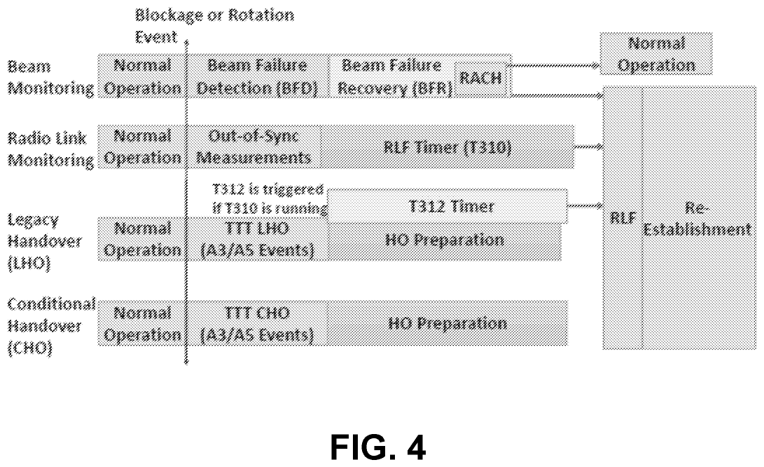

BFDR, RLM, and/or handover procedures may run concurrently, for example, if/when the beams and/or links deteriorate (e.g., are deteriorating). FIG. 4 illustrates examples of BFDR, RLM, and/or handover procedures running concurrently. An (e.g., each) individual procedure may lead to an RLF. A link outage may interrupt measurement reporting and/or an HO initiation, for example, if/when the WTRU is configured to use a (e.g., legacy) handover (HO). An HO operation may (e.g., thus) fail. A BFDR procedure may attempt (e.g., in parallel) to recover through BFR. An RLF may be declared by the BFDR procedure, for example, if the recovery attempt(s) fail. A WTRU (e.g., configured to use a conditional handover (CHO)) may (e.g., based on/once the serving link starts to degrade) evaluate the execution condition for the conditional handover and/or may handover to the target cell (e.g., if the execution condition is satisfied).

In examples, a WTRU may proactively detect an RLF. The WTRU may be configured to monitor for one or more radio link conditions. The one or more radio link conditions may indicate degradation of a serving link (e.g., that is likely to lead to an RLF). The degradation of the serving link may be associated with a mobility cause of the WTRU (e.g., device mobility of the WTRU and/or external mobility of an object). Each of the one or more radio link conditions may be a threshold of a service quality measurement (e.g., signal strength).

FIG. 4 illustrates an example of parallel running procedures for beam/cell level mobility.

Cell level mobility procedures may be implemented.

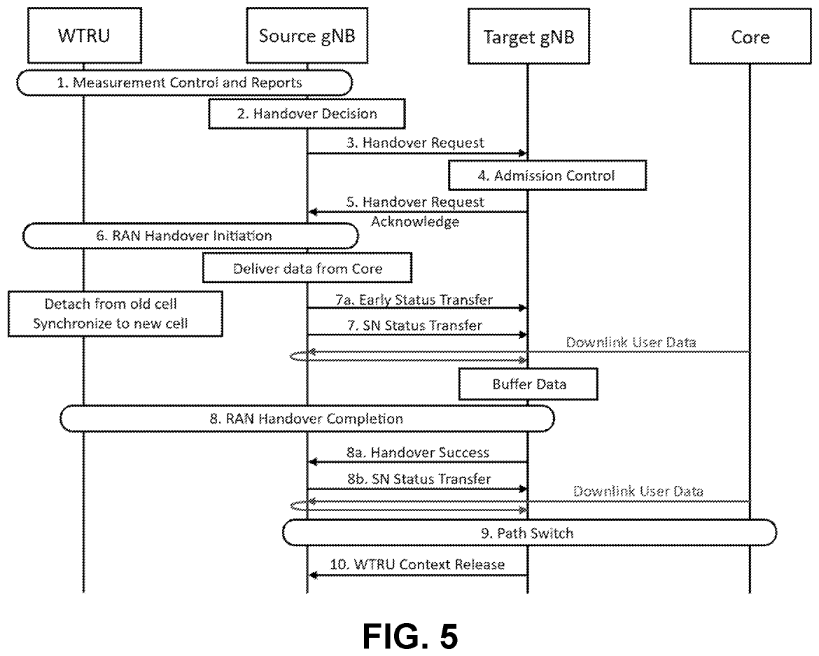

An inter-node (e.g., inter-gNB) handover procedure may be referred to as a legacy handover. A WTRU (e.g., in RRC connected mode) may utilize cell/node level mobility, which may trigger (e.g., explicit) RRC signaling. A WTRU may report a cell quality measurement to a serving (source) cell, for example, if/when a neighboring cell quality is offset better for a preset duration of time-to-trigger (TTT). Different events (e.g., called A1, A2, A3, A4, A5, etc.) may be defined for WTRU measurement report triggering. A TTT and/or cell specific offsets may be specified, for example, during a measurement configuration step. A source node may issue a handover request to a target node, for example, if a handover (HO) decision is made based on a measurement report. A target node may send a handover request acknowledgement to a source node, for example, if the WTRU is admitted by the target node. A handover request acknowledgement may include an RRC message to be sent to the WTRU. The source node may (e.g., next) initiate a handover. The source node may send an RRC reconfiguration message to the WTRU. The source node may (e.g., also) include a set of dedicated RACH resources. The WTRU may synchronize to the target cell. The WTRU may complete the RRC handover procedure. FIG. 5 shows an example of an HO procedure.

FIG. 5 illustrates an example of an intra-NR inter-node (e.g., inter-gNB) handover.

An HO process may fail, for example, due to poor channel qualities of a target node and/or the source node. In some examples (e.g., a scenario with directional links), handover problems may be exacerbated because the link qualities of the target and source nodes may deteriorate quickly due to mobile blockers and/or WTRU rotations. The blockage of a target node during a handover procedure may result in a handover failure (HOF). A handover failure timer T304 may be started, for example, if/when the WTRU receives an RRC reconfiguration message. A HOF may be declared, for example, if the T304 timer expires before the handover is completed. The WTRU may (e.g., must) perform connection re-establishment (e.g., if the T304 timer expires before the handover is completed). A source node may not be able to initiate a handover procedure in time based on the most recent measurement reports, for example, after a sudden WTRU rotation or a blockage. Even the measurement reports from the WTRU may be lost due to poor link quality. A WTRU (e.g., without handover assistance from the source node) may wait for the source node to recover from outage or declare an RLF, for example, even when there are potential target nodes with good channel qualities.

A dual-active protocol stack (DAPS) handover may be implemented, for example, based on the target node being blocked. In some examples (e.g., involving a DAPS handover), a WTRU may not release the source cell connection until random access to the target node is completed. A WTRU may fall back to the source node, for example, if the target node link deteriorates before random access is completed.

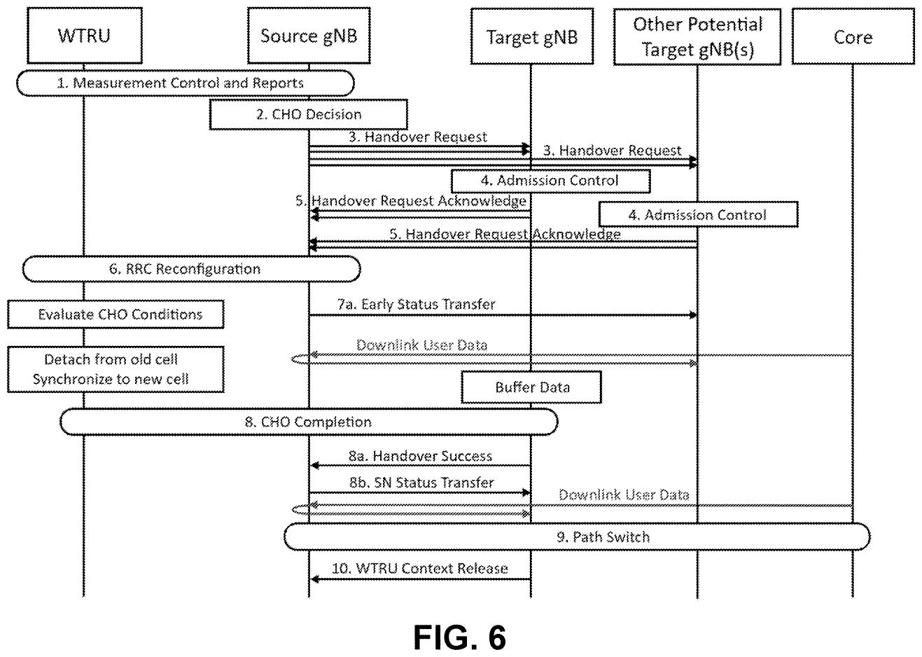

A conditional handover (CHO) may be implemented, for example, to address the blockage of the source node. In some examples (e.g., involving a CHO), a WTRU may be configured to execute a handover, e.g., if/when one or more handover execution conditions are met. A source node may proactively configure a WTRU to evaluate CHO execution conditions defined for candidate nodes. A WTRU may initiate handover to a target node (e.g., without the signaling from the source node), for example, if/when the conditions are met, e.g., if/when the target node is an offset better than the source node. The WTRU may (e.g., successfully) complete a handover with the target node if a CHO execution condition is satisfied, for example, even if/when the source node is in an outage state (e.g., due to a sudden blockage or a rotation). FIG. 6 shows an example of a CHO procedure.

FIG. 6 illustrates an example of an intra-NR RAN conditional handover.

A CHO may be resilient to mobile blockers. A CHO may (e.g., significantly) reduce the number of RLFs originating from fast deteriorating links. The success of a CHO may depend on the availability of candidate nodes before the failure of the source link, the link quality of the target links, and/or the conditional thresholds for the target gNBs. A WTRU may (e.g., be able to) maintain the link quality with the selected candidate node until the handover completion, for example, even if there are candidate nodes. Conditional thresholds (e.g., radio link conditions) for a handover execution may be (e.g., carefully) configured. Higher threshold values (e.g., threshold values that may be set too high) may lead to/cause a WTRU to fail to timely execute a handover to a target node, which may result in a failed handover. Lower threshold values (e.g., threshold values that may be set too low) may lead to/cause a sub-optimal choice of a new serving node and/or potentially useless/unnecessary handovers (e.g., in certain cases).

Directional systems may be implemented to support mobility. Large(r) antenna arrays (e.g., large number of antenna elements, ranging from tens to hundreds) may be used to form high gain, highly directional, narrow beams, for example, to provide coverage (e.g., desirable coverage) levels at high frequencies, such as sub-THz and THz frequency range for 6G systems, which may have high attenuation and/or path loss. Beams may become narrower with higher frequencies. Highly directional links resulting from narrow beams at a WTRU and/or a node may be (e.g., much) more sensitive to dynamic changes in the environment (e.g., compared to conventional links). High frequency systems may be implemented in a denser network, e.g., with shorter coverage areas for each transmission reception point (TRP).

There may be frequent mobility events (e.g., translational, rotational) or blockage events in a highly densified system with highly directional narrow beams. These mobility events and blockage events may be referred to as a mobility cause. Beam quality may degrade faster (e.g., much quicker) and/or more frequently, e.g., as a result of a beam being highly directional. The time budget to perform measurements, report measurement results (e.g., for network control mobility), process the measurements, make mobility decisions, and execute the mobility decision may be small (e.g., extremely tight), e.g., compared to a traditional radio measurement-based approach to mobility/beam management, which may be impractical for highly densified systems. The time budget may be (e.g., further) decreased, for example, for applications with high (e.g., even higher) quality of service requirements. Mobility events may be the result of translational motion, rotational motion, and/or a change in a wireless medium (e.g., device mobility). WTRU rotations may come from rotational movements of handset/wearable devices, such as smartphones, game controllers, VR/XR headsets, etc. Movements may originate from hand gestures, head movements, etc. WTRU rotations may lead to channel variations between the serving node and the WTRU, which may cause beam misalignment and/or link/connection failures. Other types of dynamic changes may originate from translational mobility. Another type of (e.g., dynamic) change may occur if/when a serving link/beam may get blocked by a moving object or a mobile blocker in the surrounding environment (e.g., external mobility). Changes may happen in any combination, which may result in degradation/failure of multiple beams/links. Applications with stringent QoS targets may require faster recovery from degradation situations (e.g., no matter the cause(s)), for example, to meet QoS targets for user experience. Mobility procedures that (e.g., heavily) rely on radio signal measurements may be used in highly directional systems, which may challenge the robustness and/or reliability of radio-signal based mobility procedures. Accordingly, mobility methods that rely less on radio signal measurements may (e.g., alternatively) be used in highly directional systems.

Mobility may result in sudden link degradation for a serving/source node. A WTRU may not have discovered the neighboring cells/beams available in the vicinity from neighboring TRPs or from neighboring nodes. A reason for non-detection may be insufficient time for the network to configure the measurements and/or gaps, and/or insufficient time for the WTRU (e.g., if configured) to make the measurements. Missing configuration(s) to recover from degrading link quality through configured CHO candidates may result in loss of connections, which may cause larger delays (e.g., despite cell coverage available in the vicinity from the same network). Mobility methods may need to be provided to provide such configurations at WTRUs.

Operation in dense networks with a large number of narrow beams may consume significant power, e.g., for transmission/reception and/or making measurements on (e.g., all) narrow beams from different TRPs/nodes. Devices may make measurements on neighboring beams/cells. The measurements may be made through suitable receive beams, for example, due to directionality and pathloss. A device may consume a lot of power, for example, in terms of reception and/or computation for making measurements over neighboring cells and the beams. Beam steering for measurement purposes may (e.g., further) add “outage,” e.g., from the perspective of the serving beam/link. Lean procedures may be implemented, e.g., to reduce WTRU power consumption for beam/cell measurements over neighboring beams/cells.

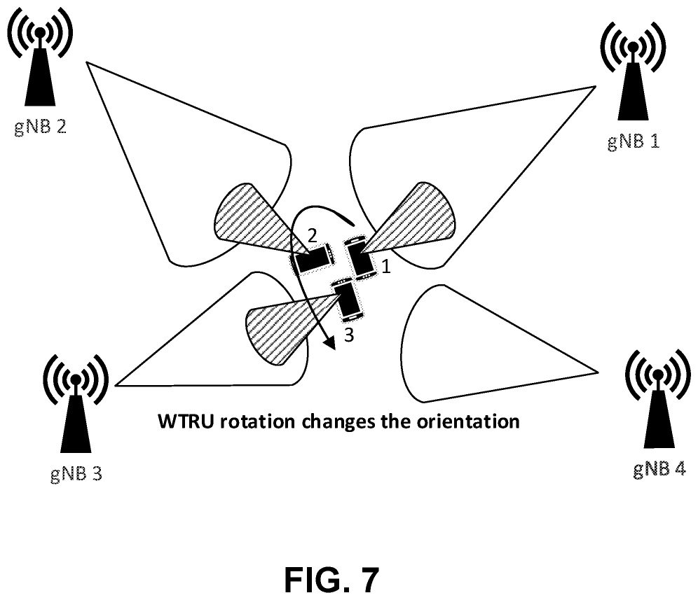

FIG. 7 shows an example situation where a WTRU is (e.g., initially) communicating with node 1.

FIG. 7 illustrates an example of mobility resulting from WTRU rotation/orientation. As shown in FIG. 7, an initial position/orientation of the WTRU is indicated by ‘1’. The next two orientations are indicated as ‘2’ and ‘3’. The beams from the nodes and WTRU beams are indicated in FIG. 7 as blank and line-pattern, respectively, for each node and for each WTRU position/orientation. The WTRU in position 1 may be unable to discover the beam(s) from node 2 (e.g., and/or node 3) with coverage in a non-overlapping angular space, e.g., compared to the WTRU's beam. The non-detection may (e.g., also) be the result of the network not having the time to configure the WTRU for measurements and/or proper measurements gaps configuration, etc. At a time instant (e.g., due to mobility), the WTRU's position/orientation may become as shown in position ‘2’, where the WTRU may lose the angular coverage space of the node 1 beam. The WTRU may undergo link failure for the serving beam from node 1. At position/orientation ‘2’, the WTRU may be in the coverage space of a suitable beam from node 2. The network may not have configured the cell/beam(s) from node 2 to the WTRU, for example, if the WTRU had not discovered the cell/beam, e.g., and no measurements were reported. Missing configuration for suitable conditional handover candidates may result in large delays before the WTRU may establish a suitable connection with the new cell. The resulting outage may be unacceptable for a service/application running with higher QoS requirements (e.g., resulting in user dissatisfaction).

A conditional handover (CHO) may avoid scenarios where a former serving cell may have link quality degrading rapidly. A serving cell may provide network coverage information, the configuration of a conditional handover, and/or a set of conditional handover candidates to a WTRU. One or more conditions to execute the HO may be specified (e.g., for each CHO candidate), for example, along with the configuration of the candidate cell. A WTRU may report the measurements of (e.g., good quality) non-serving cells to a serving cell that the WTRU may detect. The serving cell may choose candidate cells to be configured as CHO targets. Very high mobility may result in a WTRU inability to detect, measure, and/or report the neighboring cells in a suitable manner, which may limit a network ability to configure the suitable candidate cells for CHO. A missing CHO configuration and/or non-execution of CHO may result in (e.g., very high) outage for services/applications running on a target WTRU device.

Mobility interruptions/outages may be reduced/minimized, for example, if/when a device may perform a conditional handover in a seamless predictive manner and/or by reducing/minimizing interruptions and/or outages during the transition events. Mobility procedure feature(s) (e.g., such as feature(s) disclosed herein) may use (e.g., with or without using radio measurements) non-radio-based measurement information, such as one or more of network deployment data, positioning, future device movements data, and/or other sensing information.

Conditional configurations may be volatile. A conditional handover (CHO) procedure may include providing a WTRU with a configuration of candidate cells for CHO, for example, with execution conditions. A WTRU may (e.g., based on/upon configuration) evaluate the execution conditions. A WTRU may handover (e.g., start a handover procedure) with a candidate cell, for example, if/when an execution condition for the candidate CHO cell is satisfied. In a legacy handover, a WTRU may not be able to complete handover signaling exchanges with the source cell (e.g., resulting in handover failure), for example, if the current serving cell undergoes a fast failure. A WTRU may (e.g., based on a handover failure) perform an RRC connection re-establishment and/or (e.g., eventually) cell (re) selection (e.g., resulting in latencies and/or outages that may (far) exceed QoS requirements for many applications).

A conditional handover may have one or more limitations. For example, a device may be roaming around in a given neighborhood. The network may configure the device with a conditional reconfiguration, e.g., a conditional handover (CHO) configuration with a set of candidate CHO cells. The device may release (e.g., all) conditional (re)configurations and/or CHO candidates, for example, after successful execution to one of the CHO candidates. Legacy conditional configurations and CHO candidates may be referred to herein, respectively, as volatile conditional configurations and volatile CHO candidates. A network may configure a WTRU (e.g., staying in a vicinity with mobility requirements) with a new CHO configuration after each execution, which may be onerous from a signaling perspective and/or may introduce a latency in link change resulting in QoS degradation. In some examples, devices may be configured with conditional (re)configurations to a small subset of target cells, which may be known a-priori or target cells may be configured (e.g., in a repetitive fashion), which may lead to signaling overhead, higher latency, and/or QoS degradation.

In some examples (e.g., referred to as example scenario A), a device may be installed on a vehicle or may be a WTRU in a vehicle. The device may require a series of CHOs as it travels through a highway. Each of the CHO configurations/candidates may be configured after each execution of a CHO.

In some examples (e.g., referred to as example scenario B), a device may be a head-mounted-display (HMD), a game controller, or a similar device, which may undergo fast rotations and/or may be performing frequent (e.g., conditional) handovers among a subset (e.g., small subset) of cells. The mobility transitions over the subset (e.g., small subset) of cells may occur for a long period of time (e.g., spanning the gaming activity).

The example scenarios and other example scenarios are addressed herein for conditional configurations for conditional handover.

Example scenarios and example conditional configurations for conditional handover described herein may be formulated (e.g., in general) for other conditional configurations.

Mobility interruptions may be reduced/minimized in wireless communication systems. Some applications may require low-latency, high-reliability, and/or high-availability. Mobility interruptions may be minimized, for example, through faster switching of beams, cells, and/or network nodes.

Proactive mobility may be achieved, for example, by using one or more of (e.g., combining) the following: (i) the knowledge of network deployment of nodes/cells/beams (e.g., coverage information) and/or (ii) the ability of a WTRU to track WTRU movements and/or to determine updated geographic location/position and/or orientation (e.g., the ability of a WTRU to determine a mobility cause).

WTRU ability to (e.g., fast) detect WTRU location/orientation may be used to choose a node/cell/beam to which the WTRU should be connected to. Mobility decisions may be moved to the WTRU side. A network may share information (e.g., coverage information, such as a finite portion of network deployment/coverage ensemble) with WTRUs, for example, to enable WTRUs to make mobility decisions with respect to the latest positions/orientation, which may cause a change in the network environment. Examples of ensemble contents, configuration, maintenance, signaling mechanisms, and WTRU post-processing are described herein.

A WTRU may (e.g., after acquiring the network ensemble) use the network shared information (e.g., in combination with the WTRU's latest movements, positions, orientation, and/or any change in the network environment) to minimize mobility interruptions. A framework may be implemented to make measurements on (e.g., legacy and/or novel) measurement quantities, which may relate to (e.g., have special interest on) position, location, and orientation detection. A WTRU may combine (e.g., legacy) radio measurement quantities with one or more non-radio measurement quantities, for example, to provide (e.g., special suitable) events and/or triggers that support/allow reduction/minimization of interruption, e.g., by triggering suitable mobility procedures for suitable target nodes, cells, and/or beams. Examples of a measurement framework, quantities, and combined events on radio and non-radio measurement quantities are described herein.

Examples are provided for system level design/implementation (e.g., architecture, configuration, operation) for proactive conditional handover procedures. A system level implementation may build upon frameworks for one or more of the following: (i) deployment/coverage zones that may be indicated by the network to a WTRU, for example, through signaling, and/or (ii) non-radio measurements and/or events that may be combined with radio measurements, which may be estimated and/or evaluated at the WTRU, and/or performing a proactive conditional handover procedure, e.g., as described herein.

Deployment and coverage zones may be provided/indicated.

Cellular networks may be planned networks, with operators deploying the network nodes at locations to provide sufficient coverage to subscribers. A network operator may have (e.g., very precise) knowledge of the deployment of cells, and the beams within the cells, for example, in terms of coverage zone attributes. Coverage zone attributes may include one or more of: the locations (e.g., reference location) of cells or transmission points (TRPs); potential spatial directions of transmission (e.g., defined, for example, by azimuth, elevation angles, and/or location coordinates of the TRPs); beam width information (e.g., 3-dimentional (3D) beam width information), for example, in horizontal and vertical directions; transmission range information; and/or coverage shape information, which may include, for example, location coordinates of points that may constitute the coverage border of a beam, cell, and/or TRP.

A deployment ensemble may include (e.g., comprise) information about the location of TRPs and/or coverage/orientation of beams. In some examples, the location of TRPs may be represented in terms of 2D coordinates (e.g., latitude and longitude coordinates). A location may be represented in 3D coordinates (e.g., addition of altitude or height to 2D coordinates). Location (e.g., 2D and/or 3D representations) may be in global and/or local coordinate systems.

Beams from a TRP may be represented, for example, using azimuthal and elevation angles. References (e.g., suitable references) may be used (e.g., cardinal directions and zenith) and/or reference directions may be provided (e.g., as part of a configuration). Angles may be provided with refinement and/or quantization, for example, to capture (e.g., meaningfully capture) mobility procedures and/or signal strengths within or outside of the coverage for a given beam. Beam widths in the directions may be (e.g., explicitly) provided (e.g., in addition to the angles) for the beams. A WTRU may (e.g., thus) have knowledge of TRP location parameters and/or beam angles (e.g., plus widths). A WTRU may (e.g., use the knowledge to) prepare a local ensemble, for example, where the WTRU may see the coverage of different beams from different TRPs. Additional attributes, such as range and/or power, may be added to a cell/beam to (e.g., further) refine a deployment ensemble.

A coverage ensemble may provide an indication of geographic coverage from different TRPs for different beams. A coverage ensemble may (e.g., through (suitable) representations) provide coverage boundaries of one or more different TRPs and/or one or more different beams. A coverage ensemble may incorporate the nature of the terrain, topographic aspects, buildings, and/or other geographic parameters on the deployment ensemble, which may be used to prepare zones and boundaries associated with the coverage of different beams from different TRPs.

Representation of a coverage ensemble may be in the form of geometric shapes. Different reference shapes may be defined, for example, to indicate the shapes delimiting the cells/beam level coverage. Reference shapes may be in the form of circles, ovals, ellipses, ellipsoids, etc., for example, with parameterization. A coverage ensemble may (e.g., then) be indicated using the shapes, for example, with attributes. Attributes may provide links to cell/beam identities that may be associated with a given shape/area.

The term deployment ensemble and coverage ensemble may be used synonymously (e.g., for example, unless a distinction is mentioned).

A coverage ensemble may be associated with an area denoted as a coverage ensemble area. A coverage ensemble area may correspond to one or more of the following: one or more cells, a RAN Notification Area (RNA), a tracking area (TA), a PLMN, etc.

A coverage ensemble may be defined at different granularities. The granularity of a coverage ensemble may be part of a coverage ensemble configuration. In some examples, a coverage ensemble may be defined at cell level and/or the information of geographic coverage from different nodes/TRPs may be indicated to WTRUs with signaling. Cell level coverage may be used/useful for different hand-over and/or cell change procedures.

Coverage ensemble granularity may be reflected in the form of coverage zones. In some examples (e.g., for cell level procedures), coverage ensemble zones may have cell level granularity. In some examples (e.g., for beam level procedures), such as where a WTRU may (e.g., need to) track, maintain, and/or switch beams, coverage ensemble granularity may be defined at a beam level, and/or the zones in a coverage ensemble may be attributed to different beams.

Zones may be attributed to (e.g., given) beams from (e.g., given) TRPs. A (e.g., further) refined granularity may be achieved, for example, by defining and/or associating zones to different directions from a (e.g., each) node and/or TRP. Zones in a coverage ensemble may be indicative of a geographic area, which may correspond to a set of reference signals. In some examples (e.g., for beam level zones), a (e.g., each) zone may indicate the coverage area for an SSB beam. In some examples (e.g., for beam level zones), a (e.g., each) zone may indicate a coverage area for an SSB beam and/or a CSI-RS beam. An SSB/CSI-RS beam may be the coverage for the corresponding SSB/CSI-RS signals.

A (e.g., each) zone may be identified with an identity, which may be provided as part of a configuration. In some examples, a (e.g., each) zone identity may be a deterministic combination of identities of cells, TRP, and/or SSB/CSI-RS beam that the zone identity is attributed to. The formulae to compute zone identity may be known (e.g., apriori) to a network and/or a WTRU. A network and/or a WTRU may use additional modulating parameters, such as one or more of the following: lengths, widths, number of SSB beams, etc., which may be part of system information and/or a configuration.

A different granularity for the zones may be, for example, at node, TRP, or cell level. In some examples (e.g., for cell level zones), the zone may indicate the area where a cell has sufficient coverage. A cell level zone may group (e.g., all) SSB/CSI-RS zones associated with a given cell. A cell level zone may represent the area where (e.g., any of) the SSB/CSI-RS signals for the cell may be received with a known/configured quality. A zone representation may be extended to larger granularities for RNA, TA, and/or PLMN based coverage zones. A cell level zone identity may be a cell identity and/or a deterministic modification of a cell identity, e.g., by combining with one or more other parameters. A similar or the same design/implementation may be used for zones to represent the coverage for one or more of the following: RNA, TA, PLMN, etc.

In some (e.g., alternative) examples, zones may be defined for a (e.g., each) location, e.g., using longitude and latitude values for the location. Zone length information may be provided as part of a configuration. The formulae to compute zones may be (pre) defined and/or signaled (e.g., as part of a configuration), for example, from a (pre) defined set, which may facilitate zone identities computation. Longitude and latitude values may be geodesic distances from geographical coordinates (0,0). Suitable parameters may be provided, for example, as part of a configuration to choose a zone modularity along the longitude and latitude directions. A parameter (e.g., only one single parameter) may be used to choose a (e.g., the same) modularity along longitude and latitude directions. A parameter may be a fixed value, for example, to ease a configuration. Devices (e.g., all devices/WTRUs) may compute zones and/or the zones for a (e.g., any) location against the longitude and latitude coordinates of the location.

A network deployment configuration may be provided.

A deployment ensemble may include (e.g., comprise) information about the location of TRPs and/or the coverage and/or/orientation of beams. In some examples, the location of TRPs may be represented in terms of 2D coordinates (e.g., latitude and longitude coordinates). Location may be represented in 3D coordinates (e.g., with the addition of altitude or height to 2D coordinates). Location (e.g., in 2D or 3D representations) may be in global and/or local coordinate systems. In some examples, TRP locations may be provided against the zones (e.g., instead of longitude and latitude coordinates).

Beams from a given TRP may be represented, for example, using azimuthal and/or elevation angles. References (e.g., suitable references) may be used (e.g., cardinal directions and/or zenith) and/or reference directions may be provided, e.g., as part of a configuration. Angles may be provided with refinement and/or quantization to (e.g., meaningfully) capture the mobility procedures and/or signal strengths within or outside of the coverage for a given beam. Beam widths in the directions may be provided (e.g., explicitly) for the beams (e.g., in addition to the angles).

A network coverage configuration may be provided.

A network may (e.g., directly) provide a configuration, for example, in the form of (e.g., rich) shapes, which may capture (e.g., all) the (e.g., specific) aspects of the local terrain, shadowing from buildings and/or other objects, which may provide one or more advantages. For example, a network may know (e.g., precisely know) the deployment of network cells/TRPs and beams and/or may have access to topographical data using, for example, a navigation system, cameras, and/or ongoing measurements on cells/beams from the devices which let the network know a (e.g., very precise) coverage ensemble. For example, the use of (e.g., all) historic data, e.g., in the form of network measurements, cells/beam transitions, may be used to update and/or refine (e.g., detailed) coverage ensembles.

Exchanging/gathering large amounts of information may incur large signaling overhead. Precise coverage for even a single beam may involve a set of objects and object attributes being communicated to a WTRU. Large signaling overhead may involve multiple (e.g., several) message exchanges (e.g., at RRC level), which may lead to an increased configuration latency.

In some examples, a network may provide different cells and beams coverage indications for a zones configuration, which may provide an association of the cells and beams to zones.

A hybrid configuration may be provided. An ensemble configuration may be a hybrid of approaches (e.g., as described herein), where some part of an ensemble configuration may be indicated in the form of a network deployment based configuration and some part of the ensemble configuration may be indicated using the coverage ensemble based configuration.

An initial configuration of a deployment/coverage ensemble may be provided.

In some examples, an initial configuration for a coverage ensemble may be communicated to a WTRU in the form of dedicated RRC signaling. A WTRU in an RRC active state with mobility may be provided with an initial coverage ensemble configuration. Signaling (e.g., from a WTRU perspective) may be dedicated, but the network may provide the same information to a set of WTRUs. The WTRUs may be in the vicinity of each other, e.g., such that the same coverage ensemble may be relevant for each of the WTRUs.

In some examples, a network (e.g., a base station) may broadcast coverage ensemble information. A coverage ensemble system information block (SIB) may be specified. Coverage ensemble information broadcasted by a cell and/or a TRP may be configured to reflect a local deployment environment of a cell and/or TRP broadcasting the coverage ensemble.

In some examples, an initial configuration may provide a coarse coverage ensemble, which may be refined to granularities and/or coverage extension (e.g., to be fully useful). A coverage ensemble may be refined (e.g., suitably) through dedicated signaling. A refinement may be network initiated, for example, if/when the refinement configures certain applications/flows with QoS constraints that may involve (e.g., necessitate) proactive mobility. In some examples, a WTRU may request a refinement of the WTRU's coverage ensemble.

WTRU processing may achieve an effective coverage ensemble. A network deployment ensemble may be shared with one or more WTRUs, for example, following a configuration (e.g., as described herein), e.g., by adding attributes to a cell configuration and/or by one or more configurations having geographic attributes. Links of the TRP/beam level configurations may be provided to the (e.g., legacy) cell configurations. A WTRU may have a detailed effective coverage ensemble (e.g., also referred to as on-the-ground coverage ensemble), for example, to use in mobility events and/or effective selection of beams, cells, and/or TRPs. A deployment ensemble may be made rich enough so that it captures (e.g., all) topographical and/or shadowing aspects. A coverage ensemble may take into account TRP locations and/or beam attributes. A coverage ensemble may incorporate the physical nature of the environment around, which may include (e.g., the specifics of), for example, terrain and/or buildings (e.g., with all their physical attributes, which may shadow, block, and/or reflect the beams). Examples are provided to support/enable a WTRU acquiring/fabricating an on-the-ground coverage ensemble.

A WTRU may process a network provided coverage ensemble. A network provided deployment configuration may be made (e.g., very) rich and/or refined. A network provided deployment configuration may be provided in the form of rich shapes, which may capture (e.g., all) the (e.g., specific) aspects of the local terrain, shadowing from buildings, and/or other objects. Different reference shapes may be defined, e.g., to indicate the shapes delimiting the cells/beam level coverage. For example, reference shapes may be in the form of circles, ovals, ellipses, ellipsoids with parameterization, etc. The network may indicate the shapes with attributes and/or may provide links to the cell/beam identity, which may provide one or more advantages, for example, because the network knows (e.g., precisely) the deployment of network cells, TRPs, and/or beams. A network may have access to topographical data, for example, using a navigation system, cameras, and/or ongoing measurements on cells/beams from the devices that let the network know a (e.g., very precise) coverage ensemble. An (e.g., additional) advantage may be the use of (e.g., all) historic data, for example, in the form of network measurements, cells/beam transitions, which may be used to update and/or refine (e.g., detailed) coverage ensembles. Transmission of large amounts of information may have a large signaling overhead. The amount of information exchanged may be significant, for example, given that precise coverage for even a single beam may involve a set of objects and object attributes communicated to a WTRU. Large signaling overhead may involve a number of message exchanges (e.g., at RRC level), which may lead to increased configuration latency.

A WTRU may process a network provided deployment ensemble.

A network may provide to one or more WTRUs a snapshot of network nodes deployment and/or limited information about the beams the network transmits. A (e.g., snapshot of a) deployment ensemble may be used, for example, if/when a network provides (e.g., is providing) a network deployment configuration. A network may provide information about TRP locations, beam angles, and/or beam-specific parameters, for example, without modulating the coverage with the features of the local terrain. Providing a (e.g., snapshot of a) deployment ensemble may have lower signaling overhead and/or latency performance (e.g., by providing less information), for example, compared to providing a (e.g., detailed) coverage ensemble.

Devices may receive deployment features/parameters for TRPs/beams. Devices may use the local knowledge (e.g., through other technologies), such as local stored topography, positioning systems, and/or cameras, to prepare a refined coverage ensemble, which may add topographical aspects to the deployment configuration (e.g., received from the network). WTRUs may (e.g., after local processing and fabrication) get/determine an effective ensemble, which may delimit different coverage zones associated with different beams and/or cells. A refined coverage ensemble may (e.g., then) be used in beam and/or cell level mobility procedures at the WTRU. A local physical coverage ensemble may be refined, for example, with the mobility and/or additional information obtained from other sensors. Devices may prepare an effective ensemble, for example, using the network provided deployment parameters combined with information from local sensors. Devices may use local sensors, additional storage, and/or compute capability to prepare effective ensembles, e.g., by combing network deployment with information from local sensors.

Hybrid information may be provided/received (e.g., hybrid solutions/techniques may be standardized) to get (e.g., determine) a refined coverage ensemble at the devices. A network may send a refined ensemble to devices, for example, if one or more devices are not equipped with (e.g., necessary) local sensors, and/or don't have (e.g., necessary) compute power to process and/or fabricate an ensemble. Devices having (e.g., necessary) local sensors, compute power, and/or storage may receive (e.g., only) limited deployment features from the network, and may prepare the effective ensemble locally. Hybrid information may (e.g., also) be used, for example, depending upon one or more of the following: WTRU power consumption requirements, battery quality, remaining battery, and/or as a function of active applications and/or application attributes.

A deployment/coverage ensemble may be maintained. A WTRU may (e.g., based on/upon detection of change in coverage ensemble area) re-acquire a coverage ensemble for the WTRU's current location. A re-acquisition may be in the form of dedicated RRC signaling. In some examples, ensemble maintenance may be implemented by re-acquiring the coverage ensemble SIB. A WTRU may detect a change in a coverage ensemble area, for example, by one or more of the following: a change in serving cell or (re) selection to a cell that doesn't belong to the current coverage ensemble area; a (re) selection to an RNA that doesn't belong or doesn't correspond to the current coverage ensemble area; execution of an RNA update procedure, and/or transmission of an RNA update message to the network (base station); a (re) selection to a TA that doesn't belong, and/or an ensemble that doesn't correspond to the current coverage ensemble area; execution of a TA update procedure, and/or transmission of a TA update message to the network (core network); and/or a (re) selection to a PLMN that doesn't belong, and/or an ensemble doesn't correspond to the current coverage ensemble area.

A deployment/coverage ensemble configuration may be released. A WTRU may discard coverage ensemble configuration information, for example, if the ensemble configuration information becomes/gets outdated. An outdated indication may be derived/determined, for example, if a WTRU changes coverage area and/or is not able to acquire the updated coverage ensemble. In some examples, a configuration may include/comprise one or more (e.g., explicit) timers, which may result in a WTRU releasing the configuration (e.g., if the one or more timers are expired). Timers may be refreshed, for example, if the WTRU stays (e.g., is staying) in an area associated with the WTRU's current coverage ensemble. A coverage ensemble area may be defined, for example, in terms of RNA, TA, PLMN, and/or other condition(s).

A network may send an (e.g., explicit) indication to a WTRU to release a coverage ensemble configuration.

A WTRU may release a coverage ensemble configuration, for example, if the WTRU goes out of an RRC active state.

A network may provide an indication of a deployment/coverage ensemble. Deployment ensembles may be provided to a WTRU. Cells/beam configurations and mobility configurations with the deployment configuration may be related.

An ensemble indication may be provided as part of a cell/beam configuration. In some examples, a deployment ensemble may be part of a cell configuration. A cell configuration may be part of a conditional (re)configuration associated with candidate cells, which may be part of a conditional handover or conditional PSCell change/addition procedure. A deployment ensemble may be associated with one or more serving cell configurations. A deployment ensemble may be used for one or more (e.g., any of) the beam management procedures, such as one or more of beam switching, beam failure recovery, etc. Attributes (e.g., new attributes) added to a cell configuration may define, for example, one or more of the following: the TRPs where the cell is being transmitted, the locations of the TRPs in global and/or local coordinate systems, and/or the beam coverage attributes for the beams being transmitted through the TRPs. A configuration may provide the information on SSB beams and/or CSI-RS beams. Attributes for beams may be in the form of azimuthal and/or elevation angle, e.g., with reference directions. Reference directions may be taken from cardinal directions and/or may be indicated as part of the configuration. The range for the beams may be indicated, for example, as per beam attribute and/or a (e.g., single) value, which may indicate the unobstructed range in view of the transmit power. Beam attributes may define the beam width in horizontal and/or vertical directions. A (e.g., simpler) deployment may specify a (e.g., one single) beam width attribute for horizontal and/or a (e.g., one) for vertical directions, which may be (e.g., assumed to be) the same for (e.g., all) the configured beams. A network may provide a (e.g., one) value for a TRP with delta values (e.g., as appropriate) for each beam, for example, for deployments with varying beam width sizes. In some (e.g., alternative) examples, a network may provide beam width as part of a beam configuration without a TRP and/or cell level indication. In some (e.g., alternative) examples, the coverage for a (e.g., each) beam may be specified as an ellipsoid, e.g., with parametrization.

An ensemble indication may be provided as an independent (e.g., dedicated) configuration.

In some examples, an ensemble may be provided as an individual configuration to WTRUs. A coverage ensemble configuration may not be part of a cell configuration and/or a conditional (re)configuration. A coverage ensemble may depend on a geographic deployment and/or coverage, for example, while coverage ensemble configuration and/or signaling may be provided by the network independent of the cell configuration and/or other conditional (re)configurations.

A coverage ensemble configuration may be in the form of network nodes deployment and/or beam attributes and/or in the form of on the ground detailed coverage, which may incorporate topographic and/or terrain-specific features. A coverage/deployment ensemble configuration may provide the linkage of indicated TRP locations and/or beam attributes to cell identities and/or cell configurations.

An ensemble indication may be provided as broadcast signaling.

A deployment/coverage ensemble indication may be transmitted by a network, for example, in the form of broadcast signaling. Information may be broadcast by a network. Devices (e.g., relevant devices/WTRUs) may be (pre) informed and/or may have (e.g., prior) knowledge how to get and decode the information. In some examples, control information to locate ensemble related broadcast information may be broadcast, e.g., through paging (e.g., special paging) and/or downlink control information (e.g., special downlink control information) informing (e.g., all) the devices about the broadcast based ensemble information.

In some examples, an ensemble indication may be treated as part of system information. A system information block (SIB) may carry and/or convey a deployment/coverage ensemble indication. The network may use (e.g., periodic) transmission of an ensemble SIB to keep the WTRUs aware of the ensemble information. WTRUs, which may be starting (e.g., relevant) services where outage may be minimized, may send a (e.g., an explicit) request to the network requesting the transmission of the ensemble SIB.

Radio measurements and/or non-radio measurements may be used (e.g., in an intelligent manner) to trigger one or more (e.g., certain) events, which may be combined with the provisioning of (e.g., additional) information from the network.

Devices/WTRUs may be equipped with interfaces from non-3GPP RATs, local sensors, and/or may obtain/receive (e.g., be getting) environmental information and/or quantities from one or more (e.g., certain) accumulation points. Usage of the quantities and/or integration with the measurements over RATs (e.g., 3GPP standardized RATs) may be a harmonized framework. For example, WTRUs may use data from non-3GPP RATs alone or in combination with the data/measurements over 3GPP RATs. A framework may be provided through which measurements and/or data quantities from non-3GPP RATs/sensors may be used for beam change and/or cell change procedures.

Measurement procedures and/or a framework may be based on measurement identities. A measurement identity may link a measurement object with a reporting configuration. A measurement object may constitute an object over which a WTRU may perform measurements. A measurement object may indicate one or more (e.g., a combination) of time, frequency, bandwidth, and/or sub-carrier spacing parameters, which may be relevant for the reference signal over which the WTRU may perform measurements. A reporting configuration may provide one or more of the reporting condition(s), the nature of the reporting whether periodic, an event trigger, and/or cell global identity reporting. In some examples (e.g., for event triggered reporting), a reporting configuration may provide a triggering event and/or parameters that may be relevant for the event.

Measurement objects may provide a pointer to a quantity configuration. A quantity configuration may provide a measurement filtering configuration, which may be applied to measurements prior to event evaluation and/or reporting.

In an example of a measurements framework, a measurement identity may (e.g., always) link a measurement object and a reporting configuration. Measurement objects (e.g., current measurement objects) may belong to the same RAT through which measurements are being configured and/or inter-RAT measurements, which may be defined over other 3GPP technologies. Examples are provided for non-radio-measurements from non-3GPP RATs, which may be generated by/received from local sensors and/or from other sources.

Measurement identities with a measurement object may have limited attributes. A measurement framework (e.g., an extended 3GPP measurement framework) may include a measurement identity that provides a link of a reporting configuration to a dummy measurement object, which may have (e.g., very) limited attributes. In some examples (e.g., for non-radio-measurements), a reporting configuration may provide information about the quantities with the events that need to be evaluated, reported, and/or used for decision making to perform the beam switching, cell switching, and/or for use in (e.g., all) conditional reconfiguration. A dummy measurement object may provide one or more (e.g., some) parameters, which may be used to choose one or more (e.g., some) aspects of non-measurement data. A dummy measurement object may provide a selection of parameters that may be used, for example, if/when a non-3GPP interface and/or local sensor provides information in multiple forms and/or formats. Measurement objects may (e.g., also) indicate special filtering, which may be applied to one or more non-radio-measurement quantities, e.g., through an updated quantity configuration.

Measurement identities may be provided without a measurement object. In some examples, a measurement framework (e.g., an extended 3GPP measurement framework) may span the data coming from non-3GPP RATs, local sensors, and/or other sources, for example, to define the measurement identities that (e.g., only) provide a pointer to a reporting configuration without a measurement object. A reporting configuration may include (e.g., may be extended with new) events and (e.g., relevant) parameters, which may provide information to handle non-radio measurements (e.g., in a suitable manner).

Measurements may be subject to post-processing and/or filtering. Measurement objects (e.g., for some of the non-radio measurements) may provide a selection of parameters that may be kept and/or used, e.g., as part of a non-radio measurement framework. A quantity configuration may provide (e.g., additional) post-processing and/or filtering coefficients, which may be applied to non-radio measurements. Filtering and/or post-processing may provide (e.g., additional) processing to make the measurements quantities useful for procedures (e.g., 3GPP procedures), such mobility, conditional reconfiguration, etc.

Measurement reporting, triggers, and/or conditional (re)configuration may be provided (e.g., implemented).

Reporting for non-radio measurements may be performed in the same or similar manner as reporting for radio measurements. Non-radio measurements may trigger events in the same or similar manner that radio measurements trigger events. Non-radio measurements and/or indicated events may be used for mobility procedures and/or conditional reconfigurations in the same or similar manner that radio measurements may be used for mobility procedures and/or conditional reconfigurations.

A network may share (e.g., with WTRUs) a piece/portion of a deployment ensemble. WTRUs may (e.g., use the shared information to) make intelligent decisions, trigger change of beams and cells, use local radio and/or non-radio measurements in mobility procedures, such as one or more of beam recovery, conditional handover, conditional PSCell addition/change, etc.

A reporting configuration may include (e.g., may be expanded to include the new) non-meas-data based events, e.g., where WTRUs may use data from local sensors. The events may use the deployment attributes of cells and/or beams, which may be serving cells/beams (e.g., from primary cell group and/or secondary cell group) and/or neighboring cells/beams, e.g., obtained from the deployment configuration. Events may be created based on the sensor non-meas-data. Events may (e.g., then) be combined with the measurement data events, for example, to validate the suitability of cells/beams for (e.g., certain) signal strength, etc. In some examples, composite events may be used, e.g., where conditions may be specified for non-meas-data-quantities (e.g., location/angle) and measurement quantities (e.g., SSB/CSI-RS RSRP/RSRQ/SINR). Composite events may be triggered, for example, if/when the conditions from non-measurement data quantities and measurement quantities groups are specified. Triggering of composite events may lead to the execution of a conditional (re)configuration.

Some conditional reconfigurations may be limited to at most two measurement identities. With the non-meas-data based events that may be needed in combination with meas-data based events, the number of events may be increased. Joint meas and non-meas events may be created (e.g., in a compatible design).

WTRU(s) may evaluate events configured over a combination (e.g., suitable combination) of radio and non-radio measurements. Details on how these events are used in association with specific techniques may be illustrated in one or more examples herein. Some exemplary events on non-radio measurements are described herein.

Example event V1 may be associated with a velocity meeting or exceeding a threshold. A WTRU may consider the entering condition for this event to be satisfied if condition V1-1, e.g., as specified herein, is fulfilled. The WTRU may consider the leaving condition for the event to be satisfied if condition V1-2, e.g., as specified herein, is fulfilled. For example:

Inequality V1-1 (Entering condition 1)

Mv−Hys>Thresh1

Inequality V1-2 (Leaving condition 1)

Mv+Hys<Thresh2

The variables in the formula may be as follows. Mv may be the WTRU velocity estimated by the WTRU, for example, through its local sensors, e.g., not taking into account any offsets. Hys may be the hysteresis parameter for this event (e.g., hysteresis as defined within configuration for this event). Thresh1 may be the threshold for this event, for example defined as a reference velocity within configuration for this event and/or used as velocity threshold to enter this event. Thresh2 may be the threshold for this event, for example defined as a reference velocity within configuration for this event and/or used as velocity threshold to exit this event. Mv may be expressed in Km/hour. Hys may be expressed in the same unit as Mv. Thresh1 and Thresh2 may be expressed in the same unit as Mv. The definition of Event V1 may apply to CondEvent V1.

Example event R1 may be associated with a device rotation occurring for an amount meeting or exceeding a threshold. A WTRU may consider the entering condition for this event to be satisfied if condition R1-1, e.g., as specified herein, is fulfilled. A WTRU may consider the leaving condition for this event to be satisfied if condition R1-2, e.g., as specified herein, is fulfilled. For example:

Inequality R1-1 (Entering condition 1)

Mr−Hys>Thresh1

Inequality R1-2 (Leaving condition 1)

Mr+Hys<Thresh2

The variables in the formula may be as follows. Mr may be the WTRU rotation estimated by the WTRU, for example, through its local sensors, e.g., not taking into account any offsets. Rotation estimation may be over a duration not exceeding a duration Td, which may be configured as part of the configuration. Hys may be the hysteresis parameter for this event (e.g., hysteresis as defined within configuration for this event). Thresh1 may be the threshold for this event, for example, defined as an amount of reference rotation within configuration for this event, e.g., and used as rotation threshold to enter this event. Thresh2 may be the threshold for this event, for example, defined as an amount of reference rotation within configuration for this event, e.g., and used as rotation threshold to exit this event. Mr may be expressed in degrees. In some examples, Mr may be expressed in radians. In some examples, the unit for Mr may be configured as part of the configuration. Hys may be expressed in the same unit as Mr. Thresh1 and Thresh2 may be expressed in the same unit as Mr. The definition of Event R1 may apply to CondEvent R1.

Event O1 may be associated with a device orientation changing from a serving orientation meeting or exceeding a threshold. The WTRU may consider the entering condition for this event to be satisfied if condition O1-1, e.g., as specified herein, is fulfilled. A WTRU may consider the leaving condition for this event to be satisfied if condition O1-2, e.g., as specified herein, is fulfilled. For example:

Inequality O1-1 (Entering condition 1)

Mo−Hys>Thresh1

Inequality O1-2 (Leaving condition 1)

Mo+Hys<Thresh2

The variables in the formula may be as follows. Mr may be the WTRU rotation estimated by the WTRU, for example, through its local sensors, e.g., not taking into account any offsets. The rotation estimation may be over a duration not exceeding a duration Td, which may be configured as part of the configuration. Hys may be the hysteresis parameter for this event (e.g., hysteresis as defined within configuration for this event). Thresh1 may be the threshold for this event, e.g., defined as an amount of reference rotation within configuration for this event and/or used as rotation threshold to enter this event. Thresh2 may be the threshold for this event, e.g., defined as an amount of reference rotation within configuration for this event and/or used as rotation threshold to exit this event. Mr may be expressed in degrees. In some examples, Mr may be expressed in radians. In some examples, the unit for Mr may be configured as part of the configuration. Hys may be expressed in the same unit as Mr. Thresh1 and Thresh2 may be expressed in the same unit as Mr. The definition of Event R1 may apply to CondEvent R1.

Event OD1 may be associated with device orientation and/or distance matching the location of a given TRP, e.g., within one or more thresholds. The WTRU may consider the entering condition for this event to be satisfied if both condition OD1-1 and condition OD1-2, e.g., as specified herein, are fulfilled. The WTRU may consider the leaving condition for this event to be satisfied if condition OD1-3 or condition OD1-4, e.g., as specified herein, is fulfilled. For example:

Inequality OD1-1 (Entering condition 1)

[Device has absolute orientation matching for the target cell beam] abs(Ou−Thresh1)<Hys1

Inequality OD1-2 (Entering condition 2)

[Device is within a distance from the target TRP] Ml+Hys2<Thresh2

Inequality OD1-3 (Leaving condition 1)

abs(Ou−Thresh1)>Hys1

Inequality OD1-4 (Leaving condition 2)

Ml−Hys2>Thresh2

The variables in the formula may be as follows. MI may be the WTRU location, which may be represented by the distance between WTRU and a reference location parameter for this event (e.g., reference location of candidate TRP for this event), e.g., not taking into account any offsets. Ou may be the WTRU absolute orientation estimated by WTRU, for example, through its local sensors, e.g., not taking into account any offsets. Hys1 may be the hysteresis parameter for orientation condition used for this event. Thresh1 may be the threshold for this event, for example, defined as an amount of reference orientation within configuration for this event and/or used as rotation threshold to enter this event. Thresh2 may be the threshold for this event, for example, defined as a distance from a reference location configured in configuration for this event. Ou may be expressed in degrees, e.g., with respect to a configured measurement reference. In some examples, Ou may be expressed in radians. In some examples, the unit for Ou may be configured as part of the configuration. Hys1 may be expressed in the same unit as Ou. Thresh1 may be expressed in the same unit as Ou. MI may be expressed in meters. Hys2 may be expressed in the same unit as MI. Thresh2 may be expressed in the same unit as MI. The definition of Event OD1 may apply to CondEvent OD1.

Event OD2 may be associated with device orientation and/or distance matching being better for a location of a given TRP than the serving TRP, e.g., according to the configured thresholds. The WTRU may consider the entering condition for this event to be satisfied if both condition OD2-1 and condition OD2-2, e.g., as specified herein, are fulfilled. The WTRU may consider the leaving condition for this event to be satisfied if condition OD2-3 or condition OD2-4, e.g., as specified herein, is fulfilled. For example:

Inequality OD2-1 (Entering condition 1)

[Device has Absolute orientation aligning better with the Target Cell TRP than the serving cell orientation] abs(Ou−On)−Hys1<abs(Ou−Op)

Inequality OD2-2 (Entering condition 2)

[Device is within a distance from the target TRP] Dn−Hys2<Dp

Inequality OD2-3 (Leaving condition 1)

abs(Ou−On)+Hys1>abs(Ou−Op)

Inequality OD2-4 (Leaving condition 2)

Dn+Hys2>Dp

The variables in the formula may be as follows. Ou may be the WTRU reference orientation in absolute units estimated by WTRU, for example, through its local sensors, e.g., not taking into account any offsets. Op may be the orientation of the serving TRP in absolute units from the WTRU, for example, as estimated by WTRU, e.g., using the location of the serving TRP received in configuration. On may be the orientation of the neighbor TRP in absolute units from the WTRU, for example, as estimated by WTRU, e.g., using the location of the neighbor TRP received in configuration. Hys1 may be the hysteresis parameter for orientation condition used for this event. Dp may be the distance between WTRU location and the location of the serving TRP. The location of the serving TRP may be part of the configuration. Dn may be the distance between WTRU location and the location of the neighbor TRP. The location of the neighbor TRP may be part of the configuration. Hys2 may be the hysteresis parameter for the distance condition used for this event. Ou may be expressed in degrees, e.g., with respect to a configured measurement reference. In some examples, Ou may be expressed in radians. In some examples, the unit for Ou may be configured as part of the configuration. Op, On and Hys1 are expressed in the same unit as Ou. Dn may be expressed in meters. Dp and/or Hys2 may be expressed in the same unit as Dn. The definition of Event OD2 may apply to CondEvent OD2.

Event CM1 may be associated with a device crossing out the boundary of a specific zone in the coverage ensemble. The WTRU may consider the entering condition for this event to be satisfied if condition CM1-1, e.g., as specified herein, is fulfilled. The WTRU may consider the leaving condition for this event to be satisfied if condition CM1-2, e.g., as specified herein, is fulfilled. For example:

Inequality CM1-1 (Entering condition)

[Device crosses a boundary in the coverage ensemble] Ml1−Hys>Thresh1

Inequality CM1-2 (Leaving condition)

Ml1+Hys<Thresh1

The variables in the formula may be as follows. Ml1 may be the WTRU location, which may be represented by the distance between the WTRU and a reference location parameter for this event, e.g., not taking into account any offsets. A reference location parameter may be configured as the center of the zone or a suitable reference point of the zone. It may be configured as the location of a TRP serving this zone. Hys may be the hysteresis parameter for this event (e.g., hysteresis as defined within reportConfigNR for this event). Thresh1 may be the threshold for this event, for example, defined as a distance from a reference location (e.g., serving TRP) to a boundary of the coverage ensemble. The WTRU may derive Thresh1 from the coverage ensemble, for example, using the information of the WTRU's current location, the serving TRP location, and/or the boundary definition, e.g., according to the configuration. The boundary definition may correspond to the coverage of RNA, TA, PLMN, and/or TRP coverage. A configuration may provide information indicating whether Thresh1 may be an LOS distance (e.g., in which case, Thresh1 may be the distance of the coverage boundary on the line joining the serving TRP and WTRU) and/or a different calculation may be used. MI1 may be expressed in meters. Hys may be expressed in the same unit as MI1. Thresh1 may be expressed in the same unit as MI1. The definition of Event CM1 may apply to CondEvent CM1.

Event CM2 may be associated with a device entering a specific zone in the coverage ensemble. The WTRU may consider the entering condition for this event to be satisfied if condition CM2-1, e.g., as specified herein, is fulfilled. The WTRU may consider the leaving condition for this event to be satisfied if condition CM2-2, e.g., as specified herein, is fulfilled. For example:

Inequality CM2-1 (Entering condition)

[Device crosses into a specific zone in the coverage ensemble] Ml1−Hys<Thresh1

Inequality CM1-2 (Leaving condition)

Ml1+Hys>Thresh1

The variables in the formula may be as follows. MI1 may be the WTRU location, which may be represented by the distance between the WTRU and a reference location parameter for this event, e.g., not taking into account any offsets. The reference location may be attributed to center or a suitable reference point of the specific zone to which this event may be associated. Hys may be the hysteresis parameter for this event (e.g., hysteresis as defined within reportConfigNR for this event). Thresh1 may be the threshold for this event, for example, defined as a distance from a reference location (e.g., reference location of the reference zone) to a boundary of the coverage ensemble. The WTRU may derive Thresh1 from the coverage ensemble, for example, using the information of its current location, the reference node/TRP location, and/or the boundary definition, e.g., according to the configuration. The boundary definition may correspond to the coverage of RNA, TA, PLMN, and/or node/TRP coverage. The configuration may provide information indicating whether Thresh1 may be an LOS distance (e.g., Thresh1 may be the distance of the coverage boundary on the line joining the reference TRP and WTRU) and/or a different calculation may be used. MI1 may be expressed in meters. Hys may be expressed in the same unit as MI1. Thresh1 may be expressed in the same unit as MI1. The definition of Event CM2 may apply to CondEvent CM2.

Joint Event J1 [CM2 && A4] may be associated with a device entering a specific zone in the coverage ensemble, where the reference cell in this zone becomes better than a threshold. The WTRU may consider the entering condition for this event to be satisfied if condition J1-1 and condition J1-2, e.g., as specified herein, are fulfilled. The WTRU may consider the leaving condition for this event to be satisfied if condition J1-3 or J1-4, e.g., as specified herein, is fulfilled. For example:

Inequality J1-1 (Entering condition)

[Device crosses into a specific zone in the coverage ensemble] Ml−Hys1<Thresh1

Inequality J1-2 (Entering condition)

Mn+Ofn+Ocn−Hys2>Thresh2

Inequality J1-3 (Leaving condition)

Ml+Hys1>Thresh1

Inequality J1-4 (Leaving condition)

Mn+Ofn+Ocn+Hys2<Thresh2

The variables in the formula may be as follows. MI may be the WTRU location, which may be represented by the distance between WTRU and a reference location parameter for this event, e.g., not taking into account any offsets. The reference location may be attributed to the specific zone to which this event may be associated. Hys1 may be the hysteresis parameter for this event (e.g., hysteresis as defined within reportConfigNR for this event), which may be used in location conditions. Thresh1 may be the threshold for this event, for example, defined as a distance from a reference location (e.g., reference location of the reference zone) to a boundary of the coverage ensemble. The WTRU may derive Thresh1 from the coverage ensemble, for example, using the information of its current location, the reference node/TRP location, and/or the boundary definition, e.g., according to the configuration. The boundary definition may correspond to the coverage of RNA, TA, PLMN, and/or node/TRP coverage. The configuration may provide the information whether Thresh1 may be an LOS distance (e.g., Thresh1 may be the distance of the coverage boundary on the line joining the reference TRP and WTRU) and/or a different calculation may be used. Mn may be the measurement result of the neighboring cell, e.g., not taking into account any offsets. Ofn may be the measurement object specific offset of the neighbor cell (e.g., offsetMO as defined within measObjectNR corresponding to the neighbor cell). Ocn may be the measurement object specific offset of the neighbor cell (e.g., cellIndividualOffset as defined within measObjectNR corresponding to the neighbor cell), which may be set to zero, e.g., if not configured for the neighbor cell. Hys2 may be the hysteresis parameter for this event (e.g., hysteresis as defined within reportConfigNR for this event), which may be used in cell measurement conditions. Thresh2 may be the threshold parameter for this event (e.g., a4-Threshold as defined within reportConfigNR for this event). Ml may be expressed in meters. Hys1 may be expressed in the same unit as MI1. Thresh1 may be expressed in the same unit as MI1. Mn may be expressed in dBm (e.g., for RSRP) or in dB (e.g., for RSRQ and/or RS-SINR). Ofn, Ocn, Hys2 may be expressed in dB. Thresh2 may be expressed in the same unit as Mn. The definition of Event J1 may apply to CondEvent J1.

Joint Event J2 [OD2 && A4] may be associated with device orientation and distance matching being better for a location of a given TRP than the serving TRP, e.g., according to the configured threshold(s). The WTRU may consider the entering condition for this event to be satisfied if conditions J2-1, J2-2 and J2-3, e.g., as specified herein, are fulfilled. The WTRU may consider the leaving condition for this event to be satisfied if any of the conditions J2-4, or J2-5 or J2-6, as specified herein, is fulfilled. For example:

Inequality J2-1 (Entering condition 1)

[Device has Absolute orientation aligning better with the Target Cell TRP than the serving cell orientation] abs(Ou−On)−Hys1<abs(Ou−Op)

Inequality J2-2 (Entering condition 2)

[Device is within a distance from the target TRP] Dn−Hys2<Dp

Inequality J2-3 (Entering condition)

Mn+Ofn+Ocn−Hys3>Thresh3

Inequality J2-4 (Leaving condition 1)

abs(Ou−On)+Hys1>abs(Ou−Op)

Inequality J2-5 (Leaving condition 2)

Dn+Hys2>Dp

Inequality J2-6 (Leaving condition 3)

Mn+Ofn+Ocn+Hys3<Thresh3

The variables in the formula may be as follows. Ou may be the WTRU reference orientation (e.g., in absolute units), which may be estimated by the WTRU, for example, through its local sensors, e.g., not taking into account any offsets. Op may be the orientation of the serving TRP (e.g., in absolute units) from the WTRU, which may be estimated by WTRU, for example, using the location of the serving TRP, e.g., received in a configuration. On may be the orientation of the neighbor TRP (e.g., in absolute units) from the WTRU, which may be estimated by WTRU, for example, using the location of the neighbor TRP, e.g., received in a configuration. Hys1 may be the hysteresis parameter for orientation condition used for this event. Dp may be the distance between WTRU location and the location of the serving TRP. The location of the serving TRP may be part of the configuration. Dn may be the distance between WTRU location and the location of the neighbor TRP. The location of the neighbor TRP may be part of the configuration. Hys2 may be the hysteresis parameter for distance condition used for this event. Mn may be the measurement result of the neighboring cell, e.g., not taking into account any offsets. Ofn may be the measurement object specific offset of the neighbor cell (e.g., offsetMO, which may be defined within measObjectNR corresponding to the neighbor cell). Ocn may be the measurement object specific offset of the neighbor cell (e.g., cellIndividualOffset, which may be defined within measObjectNR corresponding to the neighbor cell). Ocn may be set to zero, for example, if not configured for the neighbor cell. Hys3 may be the hysteresis parameter for this event (e.g., hysteresis as defined within reportConfigNR for this event), which may be used in cell measurement conditions. Thresh3 may be the threshold parameter for this event (e.g., a4-Threshold, which may be defined within reportConfigNR for this event). Ou may be expressed in degrees, e.g., with respect to a configured measurement reference. In some examples, Ou may be expressed in radians. In some examples, the unit for Ou may be configured as part of the configuration. Op, On and Hys1 may be expressed in the same unit as Ou. Dn may be expressed in meters. Dp and Hys2 may be expressed in the same unit as Dn. Mn may be expressed in dBm (e.g., for RSRP) and/or in dB (e.g., for RSRQ and/or RS-SINR). Ofn, Ocn, Hys3 may be expressed in dB. Thresh3 may be expressed in the same unit as Mn. The definition of Event J2 may apply to CondEvent J2.

Joint Event J3 [CM2 && A3] may be associated with a device entering a specific zone in the coverage ensemble, e.g., where the reference cell in this zone becomes better than SpCell. The WTRU may consider the entering condition for this event to be satisfied if condition J3-1 and condition J3-2, e.g., as specified herein, are fulfilled. The WTRU may consider the leaving condition for this event to be satisfied if condition J3-3 or J3-4, e.g., as specified below, is fulfilled. For example:

Inequality J3-1 (Entering condition)

[Device crosses into a specific zone in the coverage ensemble] Ml−Hys1<Thresh1

Inequality J3-2 (Entering condition)

Mn+Ofn+Ocn−Hys2>Mp+Ofp+Ocp+Off

Inequality J3-3 (Leaving condition)

Ml+Hys1>Thresh1

Inequality J3-4 (Leaving condition)

Mn+Ofn+Ocn+Hys2<Mp+Ofp+Ocp+Off

The variables in the formula may be as follows. MI may be the WTRU location, which may be represented by the distance between WTRU and a reference location parameter for this event, e.g., not taking into account any offsets. The reference location may be attributed to the specific zone to which this event may be associated. Hys1 may be the hysteresis parameter for this event (e.g., hysteresis as defined within reportConfigNR for this event), e.g., to be used in location conditions. Thresh1 may be the threshold for this event, for example, defined as a distance from a reference location (e.g., reference node/TRP location of the reference zone) to a boundary of the coverage ensemble. The WTRU may derive Thresh1 from the coverage ensemble, for example, using the information of its current location, the reference node/TRP location, and/or the boundary definition, e.g., according to the configuration. The boundary definition may correspond to the coverage of RNA, TA, PLMN, and/or node/TRP coverage. A configuration may provide information indicating whether Thresh1 may be a LOS distance (e.g., Thresh1 may be the distance of the coverage boundary on the line joining the reference TRP and WTRU) and/or a different calculation may be used. Mn may be the measurement result of the neighboring cell, e.g., not taking into account any offsets. Ofn may be the measurement object specific offset of the neighbor cell (e.g., offsetMO as defined within measObjectNR corresponding to the neighbor cell). Ocn may be the measurement object specific offset of the neighbor cell (e.g., cellIndividualOffset as defined within measObjectNR corresponding to the neighbor cell). Ocn may be set to zero, for example, if not configured for the neighbor cell. Mp may be the measurement result of the SpCell, e.g., not taking into account any offsets. Ofp may be the measurement object specific offset of the SpCell (e.g., offsetMO as defined within measObjectNR corresponding to the SpCell). Ocp may be the cell specific offset of the SpCell (e.g., cellIndividualOffset as defined within measObjectNR corresponding to the SpCell). Ocp may be set to zero, for example, if not configured for the SpCell. Off may be the offset parameter for this event (e.g., a3-Offset as defined within reportConfigNR for this event). Hys2 may be the hysteresis parameter for this event (e.g., hysteresis as defined within reportConfigNR for this event), which may be used in cell measurement conditions. MI may be expressed in meters. Hys1 may be expressed in the same unit as MI1. Thresh1 may be expressed in the same unit as MI1. Mn, Mp may be expressed in dBm (e.g., for RSRP) and/or in dB (e.g., for RSRQ and/or RS-SINR). Ofn, Ocn, Ofp, Ocp, Hys2, Off may be expressed in dB. The definition of Event J3 may apply to CondEvent J3.

Joint Event J4 [OD2 && A3] may be associated with device orientation and distance matching being better for a location of a given TRP than the serving TRP, e.g., according to the configured threshold(s), where the reference cell in this zone becomes better than SpCell. The WTRU may consider the entering condition for this event to be satisfied if conditions J4-1, J4-2 and J4-3, e.g., as specified herein, are fulfilled. The WTRU may consider the leaving condition for this event to be satisfied if any of the conditions J4-4, or J4-5 or J4-6, e.g., as specified herein, is fulfilled. For example:

Inequality J4-1 (Entering condition 1)

[Device has Absolute orientation aligning better the Target Cell TRP than the serving cell orientation] abs(Ou−On)−Hys1<abs(Ou−Op)

Inequality J4-2 (Entering condition 2)

[Device is within a distance from the target TRP] Dn−Hys2<Dp

Inequality J4-3 (Entering condition)

Mn+Ofn+Ocn−Hys3>Mp+Ofp+Ocp+Off

Inequality J4-4 (Leaving condition 1)

abs(Ou−On)+Hys1>abs(Ou−Op)

Inequality J4-5 (Leaving condition 2)

Dn+Hys2>Dp

Inequality J4-6 (Leaving condition 3)

Mn+Ofn+Ocn+Hys3<Mp+Ofp+Ocp+Off

The variables in the formula may be as follows. Ou may be the WTRU reference orientation (e.g., in absolute units) estimated by the WTRU, for example, through its local sensors, e.g., not taking into account any offsets. Op may be the orientation of the serving TRP (e.g., in absolute units) from the WTRU, for example, as estimated by WTRU, e.g., using the location of the serving TRP received in configuration. On may be the orientation of the neighbor TRP (e.g., in absolute units) from the WTRU, for example, as estimated by WTRU, e.g., using the location of the neighbor TRP received in configuration. Hys1 may be the hysteresis parameter for an orientation condition used for this event. Dp may be the distance between the WTRU location and the location of the serving TRP. The location of the serving TRP may be part of the configuration. Dn may be the distance between WTRU location and the location of the neighbor TRP. The location of the neighbor TRP may be part of the configuration. Hys2 may be the hysteresis parameter for the distance condition used for this event. Mn may be the measurement result of the neighboring cell, e.g., not taking into account any offsets. Ofn may be the measurement object specific offset of the neighbor cell (e.g., offsetMO as defined within measObjectNR corresponding to the neighbor cell). Ocn may be the measurement object specific offset of the neighbor cell (e.g., cellIndividualOffset as defined within measObjectNR corresponding to the neighbor cell). Ocn may be set to zero, for example, if not configured for the neighbor cell. Mp may be the measurement result of the SpCell, e.g., not taking into account any offsets. Ofp may be the measurement object specific offset of the SpCell (e.g., offsetMO as defined within measObjectNR corresponding to the SpCell). Ocp may be the cell specific offset of the SpCell (e.g., cellIndividualOffset as defined within measObjectNR corresponding to the SpCell). Ocp may be set to zero, for example, if not configured for the SpCell. Off may be the offset parameter for this event (e.g., a3-Offset as defined within reportConfigNR for this event). Thresh3 may be the threshold parameter for this event (e.g., a4-Threshold as defined within reportConfigNR for this event). Ou may be expressed in degrees, e.g., with respect to a configured measurement reference. In some examples, Ou may be expressed in radians. In some examples, the unit for Ou may be configured as part of the configuration. Op, On and Hys1 may be expressed in the same unit as Ou. Dn may be expressed in meters. Dp and Hys2 may be expressed in the same unit as Dn. Mn, Mp may be expressed in dBm in case of RSRP, or in dB in case of RSRQ and RS-SINR. Ofn, Ocn, Ofp, Ocp, Hys3, Off may be expressed in dB. The definition of Event J4 may apply to CondEvent J4.

Additional examples of joint events are provided herein.

Numerous examples (e.g., as described herein) provide example events that combine measurement quantities over radio measurements and non-radio measurements to events, which may be used to achieve zero interruption in mobility, for example, by triggering conditional (re)configurations, such as one or more of the following: beam failure recovery, conditional handover, conditional PSCell change/addition, etc. Examples (e.g., described herein) may be used to create/implement additional events jointly (e.g., over radio measurement and non-radio measurement quantities), which may identify a target scenario (e.g., in a very precise manner) and/or choose a (e.g., most suitable) beam/cell/TRP/node (e.g., in a fast manner), for example, based on the combinations.

In examples of joint events, events A3 and A4 may be combined with non-radio measurement quantities, e.g., combining orientation, distance, and/or zone entrance. In some examples, event A5 may be combined with non-radio measurement quantities.

The examples of joint events J1, J2, J3, and/or J4 may be (e.g., further) combined with a speed/velocity condition (e.g., as used in event V1), for example, to segregate high speed and low speed scenarios, e.g., and use suitable beams/cells/TRPs accordingly.

In some examples (e.g., for devices with rotation only concerns), event R1 and/or event O1 may be combined with (e.g., classic) measurement quantity events (e.g., A3, A4, and/or A5), etc. to create/implement rotation focused conditional events, which may (e.g., then) trigger (re)configurations.

Reporting associated with non-radio measurements may be used, implemented, etc.

A reporting framework may be (e.g., fully) applicable to non-radio measurements, for example, if measurement objects are defined for non-radio measurements. A WTRU may provide non-radio measurements (e.g., according to reporting configuration attributes, whether periodic or event triggered). Non-radio measurements may be (e.g., suitably) filtered, e.g., according to the quantity configuration. The WTRU may provide a report to the network, for example, with an indication of measurement identity, which may serve as a reference for the reporting.

In some (e.g., alternative) examples (e.g., where measurement identities may be configured by the network without a measurement object), reporting for non-radio measurements may be based on a reporting configuration. Post-processing and/or filtering over non-radio measurements may not be applied or may be defined, e.g., a-priori without a quantity configuration.

Proactive conditional handover feature(s), such as those described herein, may be based on non-radio measurements.

A conditional handover (CHO) procedure may be defined as if/when a WTRU is provided with the configuration of candidate cells for a CHO with execution conditions. A WTRU may start a handover procedure with a candidate cell, for example, if/when an execution condition for a candidate CHO cell is satisfied, which may avoid a WTRU being unable to complete handover signaling exchanges with the source cell, resulting in handover failure, for example, if the current serving cell undergoes a fast failure. If this happens, WTRU may need to perform an RRC connection re-establishment and/or, e.g., eventually, cell selection, which may result in latencies and/or outages (e.g., far) exceeding the QoS requirements for some applications.

A proactive conditional handover may be implemented with predictive mobility. Cellular networks are planned networks. A network may have precise knowledge of its deployment of cells, e.g., and the beams within those cells. A network may not know how a WTRU may move from one cell/beam to another cell/beam. This information may (e.g., also) be unknown to the WTRU. A WTRU may not have information of network deployment (e.g., in terms of cells, beams, and/or geographic areas where the cells/beams are active). A WTRU may be equipped with one or more (e.g., many) local sensors. A WTRU may have additional interfaces and/or connections to other RATs/devices around the WTRU, with which the WTRU may track its movements and/or may determine its new geographic coordinates and orientation, e.g., quickly/in a very fast manner.

Knowledge of network deployment of cells/beams may be combined with the ability of a WTRU to track its movements and determine updated geographic location/position and orientation. The network may share a portion (e.g., suitable finite piece) of its deployment relevant to a WTRU, for example, based on assistance information received from the WTRU. The shared piece of network deployment may include/comprise, for example, neighboring cells, (e.g., relevant) beams, and/or a mapping of the (cell, beam) pairs to geographic coordinates. A configuration may include the execution conditions to perform a conditional handover to the configured (cell, beam) pairs. A WTRU may (e.g., in case of degradation over the link quality) use information from one or more local sensors and/or interfaces to extract the WTRU's current geographic coordinates and orientation. The WTRU may use the parameters to determine a conditional handover candidate (cell, beam) pair, e.g., from the network provided configuration. The configuration parameters may provide the quality condition(s) and/or execution conditions for the candidate (cell, beam) pairs, e.g., along with their RACH configuration. The WTRU may initiate a conditional handover to the candidate (cell, beam) pair, for example, if the execution condition(s) is (are) fulfilled. The deterministic derivation of candidate (cell, beam) pairs based on the updated geographic coordinates may lead to WTRU mobility management, e.g., with seamless handovers and/or minimal interruptions.

Assistance information from (e.g., provided by) a WTRU may be (e.g., broadly) categorized, for example, in two groups, which may be referred to as radio signal measurement-based data and non-radio signal measurement-based data. Radio signal measurement based data may be used synonymously with measurement based data. Non-radio-signal measurement based data may be used synonymously with non-measurement-based data.

Measurement-based (e.g., radio measurement-based) data may include/comprise (e.g., all) information that may be estimated, measured, determined, etc., e.g., with or without post-processing over the signals received from the radio interface where mobility is being considered. Measurement-based (e.g., radio measurement-based) data may include/comprise receiving, measuring, and/or processing reference signals on the physical layer, MAC information elements, RRC messages received from the network, and/or the information received at higher layers. The corresponding measurements quantities may be in the form of, for example, RSRP, RSSI, RSRQ, SNR, and/or SINR.

Non-measurement-based data may include/comprise (e.g., all) information that is not extracted from the network signaling. A first sub-group in non-measurement-based data may include/comprise WTRU capability and/or implementation details, which may cover one or more of the following: the WTRU's antenna panels, respective field-of-views for those panels, transceivers and/or power characteristics, switching delays, simultaneous operation for the panels, etc.

A second sub-group in non-measurement-based data may include/encompass (e.g., all), for example, one or more of the following: information extracted or measured through local sensors and interfaces (e.g., other than the radio interface where mobility is being considered), such as the WTRU geographic parameters, the WTRU location information, such as absolute position, relative positions to objects and/or other geographical markers, and/or a reference location of serving or neighboring cell/TRP(s). Examples of local sensors may include one or more of the following: positioning sensors, gyroscopes, accelerometers, speed monitoring sensors, etc. Examples of interfaces (e.g., other than the considered radio interface) may include one or more of the following: wired interfaces (e.g., Ethernet), wireless interfaces (e.g., Bluetooth, WiFi), and/or any other (e.g., proprietary) wired or wireless interfaces.

A third sub-group in non-measurement-based data may include/comprise mobility metrics and/or configurational triggers. Examples of mobility metrics may include one or more of the following: speed (e.g., translational and/or rotational), direction (translational and/or rotational), velocity, trajectory, history of mobility, etc. Examples of configurational triggers helpful for mobility management and/or providing configuration may include situational and/or contextual information, such as a vehicular device (e.g., and/or the devices inside) starting its trajectory to a destination where both the start and the trajectory may be (e.g., very) important from a configuration perspective. Another example of situational and/or contextual information may be the start of a network game from an AR/VR device, e.g., based on a user profile, which may incorporate and/or provide the user behavior, e.g., in terms of rotations during the game. Parameters may (e.g., also) be updated by a WTRU, for example, while having received a BFR configuration from the node. The node may (e.g., also) update the BFR configuration, for example, based on (e.g., upon) receiving updated assistance information from a WTRU, and/or based on other factors.

In some examples, overlapping information may occur, e.g., similar information may be available in measurement-based and non-measurement-based information. In some examples (e.g., positioning), the network may provide positioning information (e.g., measurement-based) while the WTRU may be equipped with a local positioning sensor, which may extract the positioning information from any of the satellite systems. In some examples of overlapping information, one or the other may be used, or both information sets may be combined, e.g., to achieve better accuracy, granularity, and/or information quality.

A proactive conditional handover may be implemented that includes or is based on one or more of the following.

A WTRU may provide assistance information to a node. The assistance information may include, for example, one or more of the WTRU's position, location, panels, FoV, and/or application-QoS. Assistance information may incorporate and/or streamline (e.g., potential) information originating from (e.g., advanced) sensors, which information may be used by the WTRU and/or provided to the node. Examples of information may include information generated through positioning sensors, gyroscopes, and/or accelerometers. A WTRU may update its assistance information for one or more parameters, e.g., under one or more conditions.

The node may provide a proactive conditional handover configuration to the WTRU, for example, in response to the WTRU assistance information. The configuration may be based on, for example, the network deployment of cells, TRPs, beams, and/or WTRU provided assistance information. Configuration preparation may take into account, for example, one or more of the following: historical data about WTRU parameters, applications usage, WTRU subscription status, etc. Configuration preparation may use artificial intelligence and machine learning algorithms, for example, to prepare the configuration for the WTRU in a predictive manner using (e.g., all) the network and/or WTRU data.

The proactive conditional handover configuration may include/comprise a set of candidate cells. Beam indices (e.g., relevant beam indices) may be provided for a (e.g., each) cell. A mapping of the pair to active zones (e.g., position/location, angular span, and/or WTRU Panel) may be provided for a (e.g., each) (beam, cell) pair. A cell/beam pair may be used for conditional handover. Execution conditions may (e.g., also) be provided as part of the configuration for a (e.g., each) (cell, beam) pair. A priority for a (cell, beam) pair may be provided as part of the configuration, for example, if/when multiple pairs are indicated for a given location and/or angular span. The configuration may provide RACH preambles and/or other RACH configuration parameters, for example, for a (e.g., each) candidate (cell, beam) pair.

The WTRU may extract the information from its local sensors, for example, after a mobility event (e.g., resulting from device mobility or mobility in the environment) leading to compromised link quality. The WTRU may combine information elements from measurement-based-data and non-measurement-based-data. The WTRU may determine (e.g., estimate) its geographic coordinates and orientation. The WTRU may derive a (cell, beam) pair (e.g., the highest priority (cell, beam) pair) from the network configured mapping, for example, based on (e.g., mapped to) the WTRU's estimated geographical coordinates.

The WTRU may evaluate the execution condition(s) for the determined (cell, beam) pair (e.g., as per the network provided configuration). The WTRU may perform a conditional handover to the determined (cell, beam) using the configured RACH parameters, for example, if the execution condition(s) is (are) fulfilled.

WTRU provided assistance information may help the network customize a proactive CHO configuration. The assistance information may not be mandatory. The network may prepare and provide a proactive CHO configuration to WTRUs, for example, (e.g., primarily) based on the network's deployment knowledge. A configuration may be refined, for example, using one or more of the following: the terrain knowledge, the network statistics on WTRU mobility, WTRU profiling patterns, etc.

The association of CHO candidates to geographic coordinates (e.g., including position/location/orientation) may be provided as part of the CHO configuration. In some examples, a deployment or coverage ensemble may be provided by the network as a separate configuration. In some examples, the deployment/coverage ensemble may be broadcast by the network as part of system information. Example definitions of deployment and coverage ensembles, WTRU processing and different signaling mechanisms are described herein.

A coverage ensemble may be defined at different granularities. The granularity of a coverage ensemble may be part of a coverage ensemble configuration. In some examples, a coverage ensemble may be defined at a cell level. Information about geographic coverage from different nodes/TRPs may be indicated to WTRUs, for example, with signaling. Cell level coverage may be useful for different hand-over and/or cell change procedures. Coverage ensemble granularity may be reflected in the form of zones, which may represent the level of granularity. A zone may be attributed to an (e.g., each) RNA, TA, and/or PLMN. Coverage ensemble zones (e.g., for cell level procedures) may have cell level granularity. Coverage ensemble granularity (e.g., for beam level procedures, where for example a WTRU may track, maintain, and/or switch beams) may be at beam level (e.g., with the zones in such a coverage ensemble being attributed to different beams). Knowledge of beam level zones may be helpful (e.g., even for cell level procedures), for example, if the WTRU needs to receive and transmit through the beam of the target cell to be able to communicate effectively, which may occur if the transmission/reception is happening through beams within a given cell (e.g., the default mode of operation for high frequency systems).

The zones in a coverage ensemble may be indicative of a geographic area that corresponds to a set of reference signals. In some examples (e.g., for beam level zones) a (e.g., each) zone may indicate the coverage area for an SSB beam. In some examples (e.g., for beam level zones), a (e.g., each) zone may indicate the coverage area for an SSB beam and/or a CSI-RS beam, e.g., where the SSB/CSI-RS beam may be the coverage for the corresponding SSB/CSI-RS signals. In some examples (e.g., for cell level zones), the zone may indicate the area where the cell has sufficient coverage. A cell level zone may group (e.g., all) the SSB/CSI-RS zones associated with a cell. A cell level zone may (e.g., thus) represent the area where (e.g., any of) the SSB/CSI-RS signals for the cell may be received, e.g., with a known/configured quality. A zone representation may have (e.g., be extended in the same way to) larger granularities for RNA, TA, and/or PLMN based coverage zones.

A (e.g., each) zone may have an identity, which may be indicated (e.g., explicitly) as part of a zone configuration. In some examples, a zone identity may be a deterministic combination of one or more (e.g., certain) parameters, e.g., as a function of zone granularity. The identities may be modulated with one or more configuration parameters. For example, a beam level zone identity may be a combination of cell identity and beam identity (SSB and/or CSI-RS). A cell level zone identity may be the cell identity and/or a deterministic modification of the cell identity, for example, by combining with one or more other parameters. Beam level and/or cell level identities may be used for zones mapped to represent coverage for RNA, TA, PLMN, etc.

A WTRU may derive information from radio measurements and/or non-radio measurements to aid in mobility procedures. Information derived from non-radio measurements comprising geographic coordinates and/or orientation may allow the WTRU to derive its current zone. For example, a WTRU may be configured by a network with a measurement configuration, where conditional events, such as event CM1 and/or event CM2 (e.g., as described herein), may be configured. The WTRU may determine a change of its current zone, for example, if/when the relevant conditions for the event(s) is (are) fulfilled. The WTRU may perform one or more of the following: determine its new zone, which may allow the WTRU to derive the configuration and candidate from the coverage ensemble corresponding to the updated zone, validate the candidate configuration from radio signal measurements, and/or execute the CHO to the successful candidate. The same (e.g., one or more of the foregoing) may be achieved, for example, by the network configuring the WTRU with events, which may have conditions composite over radio and non-radio measurement quantities. The events may be, for example, J1, J2, J3, and/or J4, e.g., as described herein.

A proactive conditional handover (e.g., based on a coverage ensemble indication and events jointly on radio and non-radio measurement quantities) may include or be implemented based on one or more of the following.

A node may prepare and/or transmit a deployment/coverage ensemble to a target WTRU. The configuration may be based on the network deployment of cells, TRPs, and/or beams. The ensemble configuration may use, for example, one or more of the characteristics of the terrain, topographical features, the shadowing/blocking from different physical objects and buildings, etc., to prepare a more refined coverage ensemble from the deployment configuration. The configuration preparation may (e.g., in addition) use artificial intelligence and machine learning algorithms to prepare the configuration, for example, using the network statistics on mobility events of the devices in the neighborhood and/or the QoS statistics received from the devices (e.g., in the past). The deployment/coverage ensemble configuration, transmission, and/or signaling mechanisms may follow different design principles (e.g., as described herein). The configuration provides indication of zones (e.g., including zones boundaries) in the ensemble or suitable parameters to compute the zones and their boundaries.

The node may provide the proactive conditional handover configuration to the target WTRU. The configuration may use the WTRU assistance information, which may be provided to the node. The configuration preparation may take into account historical data about one or more of WTRU parameters, applications usage, WTRU subscription status, etc. The proactive conditional handover configuration may include/comprise a set of candidate cells. Beam indices (e.g., relevant beam indices) may be provided (e.g., for each cell), for example, to make the conditional handover simpler and/or faster at the WTRU side. The handover execution conditions may be provided, for example, as part of the configuration for a (e.g., each) (cell, beam) pair. The execution conditions may be set jointly on radio and non-radio measurement quantities, which may combine radio conditions with geographic conditions. Measurements, triggers, and/or events may be, for example, as described herein. A priority for a (cell, beam) pair may be provided as part of the configuration. The configuration may provide RACH preambles and/or other RACH configuration parameters, for example, for a (e.g., each) candidate (cell, beam) pair.

A mobility event may lead to compromised link quality of the PCell, for example, according to one or more configuration thresholds. The WTRU may (e.g., based on the mobility event) extract information from the WTRU's local sensors. The WTRU may combine information elements from measurement-based-data and non-measurement-based-data. The geographic coordinates may include, for example, location/position/orientation information, for example, to help the WTRU determine its zone according to the deployment/coverage ensemble received from the network.

The WTRU may determine the (cell, beam) pairs providing coverage in the WTRU's determined zone, for example, using the WTRU's local copy of the deployment/coverage ensemble. The WTRU may short list the candidates for which it has received the CHO configuration from the network from among the determines (cell, beam) pairs.

The WTRU may evaluate (e.g., start evaluating) the execution conditions for (e.g., each of) the proactive CHO candidates. The conditions may be set jointly over radio and non-radio measurement quantities.

The WTRU may extract the RACH configuration corresponding to the successful candidate, for example, if the execution conditions are fulfilled for at least one of the proactive CHO candidates. The WTRU may select the highest priority candidate, for example, if execution conditions are fulfilled for multiple candidates. The WTRU may choose the candidate with the strongest radio measurement, for example, if no priority is assigned by the network and/or if the candidates have the same priority. In some examples, the selection may be left up to the WTRU implementation (e.g., WTRU-specific selection).

The WTRU may perform a conditional handover to the selected (cell, beam) pair, for example, using the determined RACH parameters.

Example features are provided for a proactive conditional handover.

A WTRU may have limited discovery of neighboring cells/nodes around it, for example, due to ultra-massive MIMO beam deployments, higher mobility, special conditions in terms of nature of the objects placements and blocking on the ground, limited number of antennas, antenna panels, transceivers, and/or stringent requirements on power consumption. Limited discovery of neighboring cells/nodes around a WTRU may result in limited discovery or no discovery of neighboring cells by a WTRU (e.g., and reporting by the WTRU to the network). Limited/zero discovery/reporting of neighboring cells/nodes around a WTRU may (e.g., based on legacy handover and conditional handover procedures) limit the configurations from the network. Mobility aggravated by rotation may land a WTRU in the angular coverage of a beam of a new node that the WTRU was not able to discover and report to the network. The most suitable (cell, beam) pair may change much faster for some deployments of ultra-massive MIMO beams. Overhead may be significant, for example, if each (e.g., fast) change requires network configuration and exchanges with the network. A proactive conditional handover may provide a mechanism to avoid frequent and/or large interruptions for such scenarios.

A WTRU may provide assistance information to a node. The assistance information may include/comprise measurement-based data and non-measurement-based data (e.g., as described herein). The base station may indicate to the WTRU a set of nodes near the WTRU's actual position, for example, along with their coverage areas. The coverage area may include an indication in terms of position and/or orientation. The position may cover the translational mobility that a WTRU may have. The translation mobility may be associated with a (e.g., each) configured beam belonging to a neighboring cell/node. A translation mobility indication may be indicated/provided with reference to the actual position of a WTRU. In some examples, a translation mobility indication may be provided in terms of absolute position. An absolute position may be GPS coordinates associated with a (e.g., each) beam of a (e.g., each) configured cell/node.

The orientation indication may cover the rotational movement of a WTRU, which may happen with or without a translational movement. The orientation indication may be provided for one or multiple beams from a (e.g., each) configured node. The orientation indication may be in the form of angular coverage, for example, with respect to a reference direction. A reference beam indication may be part of the configuration. The reference beam may be defined as an SSB beam and/or a CSI-RS beam. The reference beam may be the actual beam through which the network is serving a WTRU. A reference direction may be specified, for example, instead of a reference beam. A reference direction may be specified, for example, using other approaches, e.g., geographical North and/or another reference that may be understandable to a network and a WTRU. In some examples, orientation information may be given with respect to one or more configured Transmission Configuration Indication (TCI) states. A TCI state may include quasi co location (QCL) reference information, e.g., with a DL or UL beam/RS of a cell.

The network may provide (e.g., relevant) parameters to trigger conditional handover, for example, for a (e.g., each) (cell, beam) pair in a configured conditional handover set, e.g., in addition to the angular span around a WTRU. The parameters may include/comprise one or more contention free RACH preambles within the beam. Parameters may include the RACH parameters, e.g., one or more of RACH preamble sequence identity, RACH duration, power ramping parameters, parameters related to RACH occasions associated with the indicated beam, etc.

In some examples, a configuration may include the conditions under which the configuration stays valid. The configuration may have a timer. The validity of the configuration may expire upon the expiry of the timer. A configuration release condition may be associated with the mobility. A configuration may be released, for example, if the configured device moves away from its last known position/location by more than a configured threshold. For example, a configuration may be released if a WTRU moves out of its current zone. In some examples, a configuration may be valid in a current zone where direct neighbors have overlapping boundaries. A WTRU may (e.g., in this case) release a configuration, for example, if the WTRU moves out of direct neighbor zones. In some examples a configuration release condition may be associated with the device's timing advance value (e.g., with the serving node). The device may be configured to release the current active configuration, for example, if the device moves and the change in the timing advance is above a configured threshold. One or more (e.g., any suitable combination of) parameters from the assistance information may be used to define validity conditions and/or release conditions.

In some examples, one or more configurations may be given to the device. The mapping/association of a configuration with a zone, a location, and/or a timing advance value/range may be given to the device. The device may select the configuration, for example, based on the tracking of the associated metric (e.g., one or more of zone, location, and/or timing advance, etc.).

Some systems may use ultra-massive MIMO with a capability of deploying thousands of beams per TRP. Network deployment of beams may follow one or more rules to contain (e.g., reduce, minimize) signaling overhead. The rule(s) may be provided to a WTRU, for example, in a compact form. In some examples, beam deployment for from a TRP may follow a pattern in azimuthal and/or elevation dimensions. A set of patterns may be known, for example, in tabular forms and/or through formulae. The network may choose a pattern for its deployment, for example, according to network requirements in a given geographic area. A network may (e.g., for such cells and/or beam deployments) provide a compact form of a deployment pattern to a WTRU, for example, as part of a proactive conditional handover configuration. The configuration may include the positions of TRPs in coordinates for candidate (cell, beam) pairs. A WTRU receiving a configuration may determine the nearest TRPs (e.g., for any location relevant) for each candidate (cell, beam) pair and (e.g., then) determine the candidate (cell, beam) matching its updated geographic coordinates.

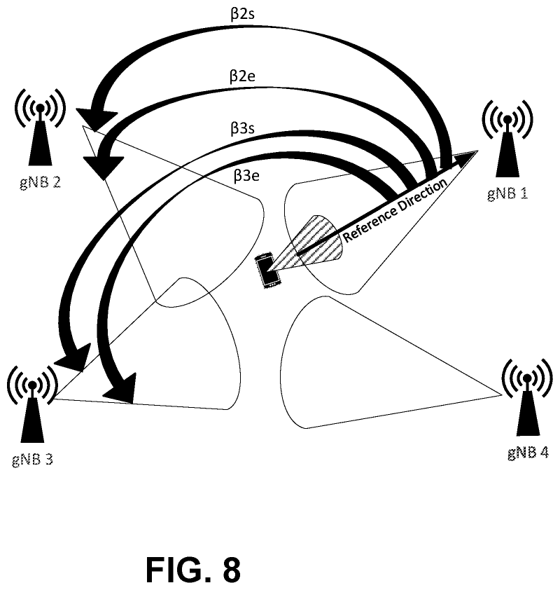

FIG. 8 illustrates an example of a proactive configuration for a conditional handover (e.g., with rotational motion). An example configuration for a WTRU rotation scenario is shown in FIG. 8 for a WTRU communicating with node 1. FIG. 8 shows an example configuration including/comprising an indication of a reference direction with the current beam, and the neighboring cells/beams with their spans. As shown in FIG. 8, a beam from node 2 may be configured with its span marked with respect to the reference (e.g., beam) direction as a start angle (e.g., β2s) and an end angle (e.g., β2e). Similarly, FIG. 8 shows the start and end angles for an exemplary beam from node 3 as β3s and β3e. The node may (e.g., for each configured candidate (cell, beam) pair) provide the RACH related details, for example, to allow contention free RACH access (CFRA) within that (cell, beam) pair. In case of a WTRU rotation, the WTRU may determine the amount of rotation from its local sensors and determine the candidate node/beam which may provide coverage, e.g., post-rotation. The configuration may include the events on rotation/orientation (e.g., event R1, O1 etc.) or joint events (e.g., events J2, J4 etc.) that the WTRU starts evaluating. In case of event trigger, the WTRU may extract the RACH parameters for the candidate and send a RACH transmission.

The network (e.g., a base station of the network) may provide coverage information to a WTRU. The coverage information may indicate cells in the vicinity of the WTRU (e.g., as described herein). The WTRU may extract the candidate cells (e.g., on condition(s) of a mobility event, link degradation, and/or link failure), for example using sensors data and the coverage information (e.g., as described herein). The WTRU may validate the CHO candidate using radio and non-radio execution conditions (e.g., as described herein). The WTRU may perform CHO to the validated candidate (e.g., as described herein).

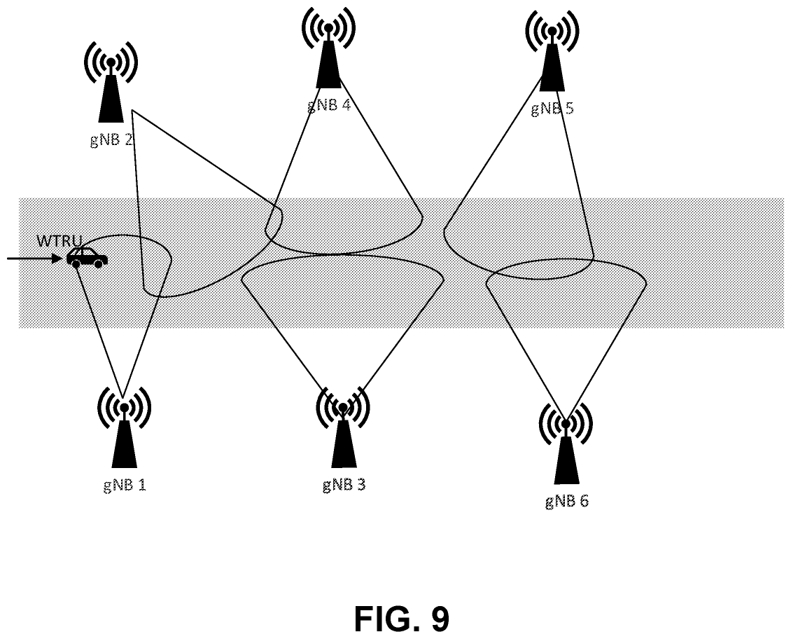

FIG. 9 illustrates an example of a proactive configuration of a conditional handover (e.g., with translational and rotational motion). FIG. 9 shows an example scenario where a WTRU is configured by the network with multiple CHO candidates to counter/combat both translational and rotational motion. A WTRU may (e.g., in this case) be configured with a CHO configuration from different nodes, for example, with a location/position of the WTRU, orientation, and a mapping to the candidate CHO cells, such that the WTRU may determine the beam/node to attach using the mobility information from its local sensors. The location/position and/or angular span may be provided with reference to the WTRU position and orientation.

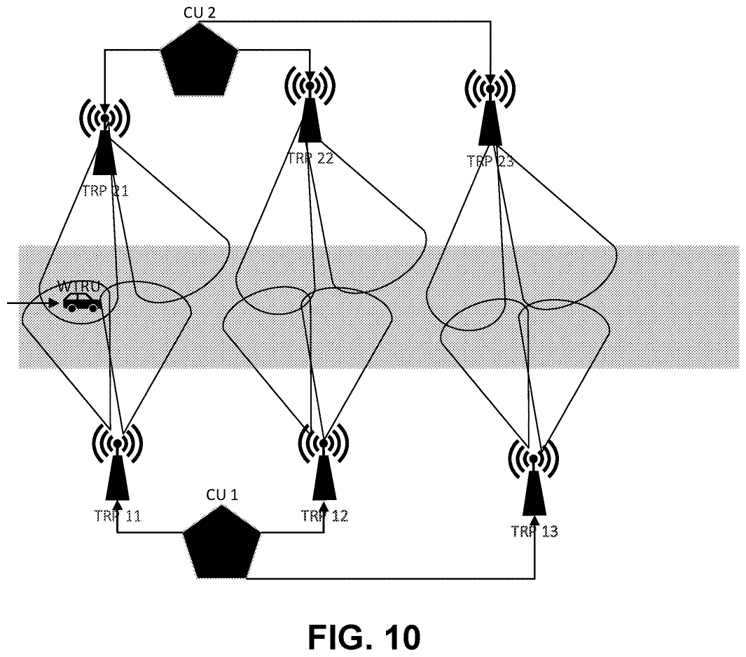

FIG. 10 shows an exemplary scenario where a WTRU is moving on a road in a car. The WTRU may face situations where it crosses beams from a single TRP, beams from one TRP to a neighboring TRP controlled by the same control unit (CU), and/or moving from one beam of a given TRP to a beam from a different TRP under a different CU. FIG. 10 shows an example scenario where beams/cells switching may take place as a result of translational motion and/or rotational motion. The WTRU may be provided with a proactive beam failure recovery configuration (e.g., as described herein) and a proactive conditional handover configuration (e.g., as described herein). These configurations may let the target WTRU monitor its mobility status through the information obtained from its local sensors, which may be confirmed through the over-the-air measurements. The WTRU may perform a proactive beam recovery and/or a proactive CHO, avoiding (e.g., any) outages while the WTRU may be moving (e.g., very) fast and/or traversing the beams and cells.

FIG. 10 illustrates an example of a proactive beam recovery and conditional handover configuration.

A WTRU may implement one or more features (e.g., associated with a procedure), for example as described herein.

A WTRU may extract information from one or more local sensors, for example, if the WTRU undergoes compromised link quality. The WTRU may combine the extracted information with other radio measurements. Translational movement information may, for example, come from the local GPS receiver. Rotational movement may, for example, come from gyroscope and/or other components. The WTRU may compute its new geographic coordinates and/or orientation. The WTRU may use the geographic coordinates and/or orientation information to find a candidate (cell, beam) pair, e.g., from the network provided mapping of (cell, beam) pairs to geographic coordinates and/or orientation. The mapping may let a WTRU know (e.g., precisely) which beam of a cell from a node that may have line-of-sight connection with the WTRU, e.g., respect to its updated coordinates. The WTRU (e.g., therefore) may not need to perform blind cell searches to find which beams of which cells may be active (e.g., and suitable) after undergoing a mobility event.

The WTRU may derive the (cell, beam) pair from the network provided configuration. The WTRU may evaluate the CHO condition with the (e.g., derived) target candidate pair. The WTRU may send a contention free RACH with the configured RACH parameters over the configured RACH resources (e.g., provided as part of the determined candidate (cell, beam) pair), for example, if the CHO trigger condition is satisfied.

A WTRU may implement a proactive conditional handover procedure, e.g., in whole or in part.

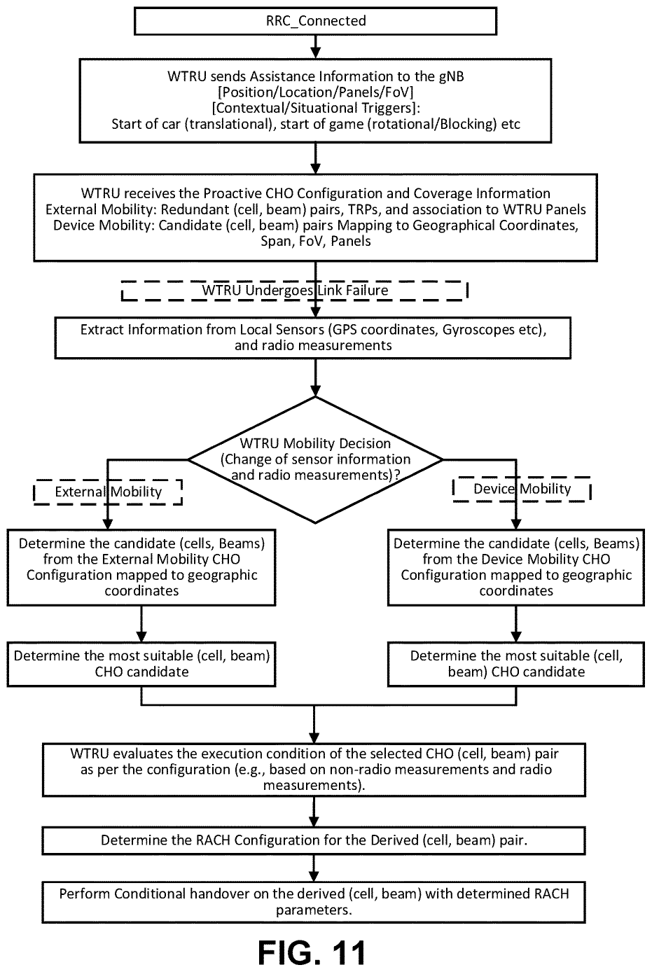

FIG. 11 shows an example of a proactive conditional handover, where the proactive conditional handover may include one or more of the features illustrated in FIG. 11.

As shown in FIG. 11, a WTRU (e.g., in RRC_CONNECTED state) may send the (e.g., advanced) assistance information to the network/network node. The assistance information from the WTRU may include information from local sensors (e.g., position sensors, gyroscope, accelerometer, etc.), panels, and/or field of view (FoV). Additional groups and constituent elements for WTRU assistance information (e.g., as described herein) may be provided.

The network may provide a proactive CHO configuration to the WTRU, for example, based on one or more of the following: the WTRU assistance information; network deployment of TRPs, cells, and/or beams; a WTRU profile for services and/or mobility; and/or QoS requirements for the services/applications a WTRU is using. As shown in FIG. 11, the WTRU may receive the proactive CHO configuration and/or coverage information. The configuration may include/comprise the candidate cells and beams and/or a mapping (e.g., mapping table) of the candidate (cell, beam) pairs to geographic coordinates and orientations of the WTRU. A CHO candidate (e.g., each CHO candidate) in a CHO configuration set may include one or more cells (e.g., and associated beams). A cell (e.g., each cell) may be associated with (e.g., include) one or more beams. A CHO candidate may be associated with and/or included in multiple CHO candidate sets. Coverage information (e.g., received by the WTRU) may indicate a network deployment of cells and beams. The proactive CHO configuration and coverage information may be received via one of: a WTRU dedicated signal or a broadcast system information.

The proactive CHO configuration may comprise the parameters and/or thresholds for a WTRU to derive its zone/location/position and/or span, for example, to determine the CHO candidate (e.g., (cell, beam) pair) from the mapping table. As shown in FIG. 11, the configuration may provide one or more (e.g., two) sets of sub-configurations. For example, a first sub-configuration may support/handle device mobility where the device may be undergoing translational and/or rotational movements. For example, a second sub-configuration may support/focus on external mobility, e.g., where the interruptions may be originated from the environment rather than a result of direct device mobility. In some examples, a configuration for external mobility resulting from mobile blockers may provide the CHO candidates (e.g., (cell, beam) pairs) that are able to provide the coverage to the target device with its known location/position at the network when the serving cell degrades or undergoes failure. The WTRU/device may switch and activate to a different panel, which the node may provide in an indication as part of a configuration. The indication may (e.g., in turn) be based on the WTRU providing the implementation and capabilities of the WTRU's antenna panels and/or a detailed feature set, e.g., as part of WTRU assistance information.

FIG. 11 illustrates an example of a proactive conditional handover, e.g., with device and external mobility configurations.

In some examples, the network may provide a set of CHO configurations to a WTRU. The network may provide an association of the configurations to one or more (e.g., different, suitable) criteria, which may include, for example, one or more of WTRU active applications, QoS (e.g., different reliability requirements), different power consumption targets at a WTRU, WTRU active service subscription level, etc. A WTRU may use the configuration according to the current situation (e.g., as per the configured condition(s)), for example, if/when the WTRU is undergoing a link failure or compromised link quality. The WTRU may determine compromised link quality based on a radio link condition (e.g., threshold) associated with link degradation being satisfied. Satisfaction of the radio link condition may indicate a RLF will occur should degradation of the serving link continue.

The multiple configurations may be associated with different physical parameters (e.g., external and/or device mobility), different service reliability targets (e.g., a configuration while higher reliability is required and a configuration for lower reliability), different subscription levels (e.g., a configuration if/when WTRU is using paid content versus a configuration for the non-paid-content), etc.

A WTRU may extract information from its local sensors, for example, if/when the WTRU is facing a compromised link quality, e.g., according to the configured quality threshold(s). Sensor information may be combined with measurements performed using one or more reference signals received from the network. Sensor information may be combined with measurements performed using downlink positioning reference signals. As shown in FIG. 11, WTRU may use this (e.g., combined) information to determine a mobility decision (e.g., mobility cause) and select the CHO candidate, for example, from the device mobility configuration set or external mobility configuration set. A WTRU may ensemble the information from local sensors to the format of location/zone/orientation (e.g., as per the selected configuration). The WTRU may (e.g., then) derive its location/orientation. The WTRU may use the location/orientation to determine the CHO candidate (e.g., (cell, beam) pair) (e.g., from the configured mapping).

The entries in the mapping table may provide multiple CHO candidates (e.g., (cell, beam) pairs) for a given location/orientation. The network configuration may provide a priority order for the candidate (cell, beam) pairs. In some examples, the priority for the multiple pairs for a given location and angular span may be left to WTRU implementation. As shown in FIG. 11, the WTRU may determine the most suitable CHO candidate.

The WTRU may evaluate the configured CHO execution condition, e.g., as per the configuration. The execution conditions may be specified, for example, through configuration of conditional event A3 and/or conditional event A5. Conditional event A3 may be (e.g., defined as) a case if/when a candidate CHO cell (with a suitable beam) becomes offset better than a current SpCell, primary cell of the master cell group, and/or the primary cell of the secondary cell group. Conditional event A5 may have (e.g., be defined with) multiple (e.g., two) conditions. A first condition may be if/when the SpCell becomes worse than a first configured threshold. A second condition may be if/when the CHO candidate becomes better than a second configured threshold. In some examples, the execution conditions may be specified in terms of joint radio and non-radio measurement quantities and joint events (e.g., as specified in Events J1, J2, J3 and J4 etc.). In some examples, ultra-massive MIMO beams may have a variety of deployment possibilities, e.g., including layered and/or hierarchical architectures. Reference signals may (e.g., suitably and/or rapidly) identify, detect, and/or measure ultra-massive MIMO beams. The reference signals may be used to identify (cell, beam) pairs. The reference signals may be provided as part of a network configuration. Quality condition(s) and/or CHO execution conditions) (e.g., conditional A3/A5 and/or other condition(s)) may be specified, e.g., in terms of the reference signals.

In some examples, a configuration for CHO candidates (e.g., (cell, beam) pairs) may be provided as a unified configuration, e.g., to enable proactive conditional handover. In some examples (e.g., for a unified configuration), the candidates and/or their priorities (e.g., all the candidates and/or their priorities) may be provided with their mapping to geographic coordinates, orientations, and/or association with other parameters that a WTRU may extract and/or use to determine a CHO candidate.

As shown in FIG. 11, the WTRU may determine the RACH configuration for the determined CHO candidate, and perform CHO (e.g., perform handover based on condition(s) described herein begin satisfied) to the determined CHO candidate with the determined RACH parameters.

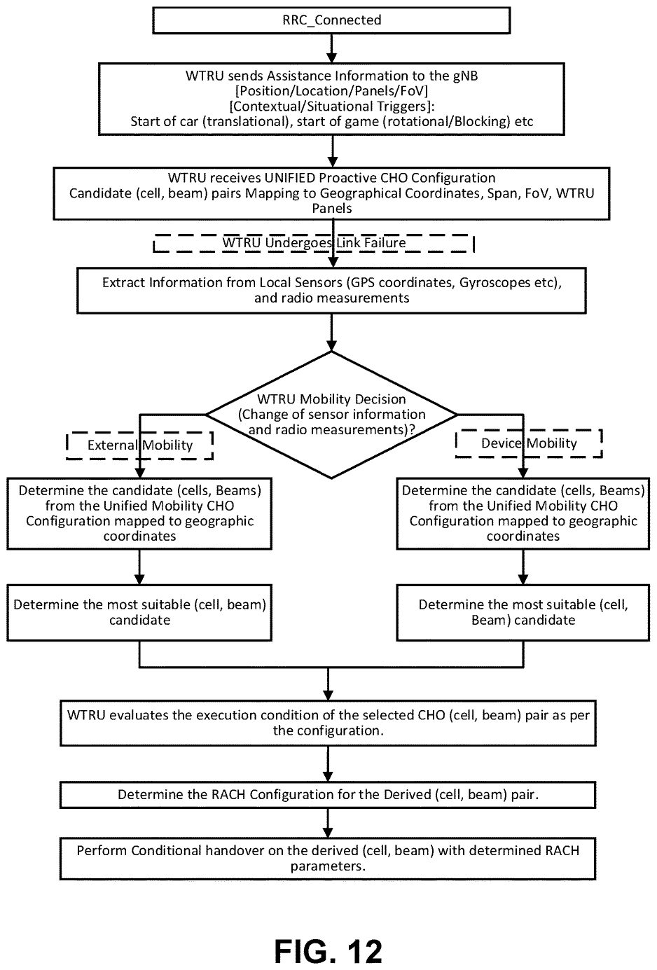

FIG. 12 shows a flowchart for a proactive conditional handover. FIG. 12 (e.g., compared to FIG. 11) shows that the network configuration for CHO candidates is provided in a unified manner, e.g., encompassing candidates for (e.g., targeting) external mobility and device mobility.

FIG. 12 illustrates an example associated with a proactive conditional handover, e.g., with a unified mobility configuration.

As shown in FIG. 12, the WTRU may send assistance information to a base station of the network (e.g., a gNB). The assistance information from the WTRU may include information from local sensors (e.g., position sensors, gyroscope, accelerometer, etc.), panels, and/or field of view (FoV). Additional groups and constituent elements for WTRU assistance information (e.g., as described herein) may be provided.

As shown in FIG. 12, a WTRU may receive a unified proactive CHO configuration set (e.g., of CHO candidates). The unified proactive CHO configuration set may include a mapping of CHO candidates to geographical coordinates, span, FoV, and/or WTRU panels.

A WTRU may get (e.g., obtain, collect, determine) information from its local sensors, for example, to decide whether a link failure is happening due to device mobility or external mobility, for example, if/when the WTRU is undergoing a link failure situation and/or the quality of the serving link falls (e.g., is falling) below a configured threshold. The WTRU may use this information (e.g., from local sensors) combined with other sensor's information to pick a (e.g., the most suitable) CHO configuration (e.g., a CHO candidate). The WTRU may activate a different antenna panel (e.g., as per the selected configuration), for example, to attach the most suitable CHO candidate. The WTRU may activate the antenna. The WTRU may evaluate the execution condition for the selected CHO candidate. The CHO execution condition may be configured, for example, in terms of RSRP, RSRQ, and/or SINR using indicated measurement objects. The CHO configurations may provide the same or different execution conditions for different CHO candidates. The WTRU may (e.g., if the selected CHO candidate satisfies the execution condition) select the RACH configuration associated with the selected (cell, beam) candidate and/or transmit RACH as part of the CHO initiation, which may trigger the fast attach procedure to the CHO candidate. As shown in FIG. 11, the WTRU may perform CHO to the determined CHO candidate with the determined RACH parameters.

A configuration may be provided for a proactive conditional handover.

An indication of a coverage ensemble from the network may include cell/beam level granularity and/or a zones configuration, which may provide a WTRU with knowledge about different cells/beams serving neighboring zones. The network may provide (e.g., independently) a set of candidate CHO cells. The CHO candidates may be indicated with associated beams and/or other relevant parameters to initiate CHO. Location/orientation information from local sensors may lead a WTRU to determine the target cell/beam serving the zone of its latest position, for example, if/when the WTRU moves from a zone served by one cell to another zone served by another cell. The WTRU may (e.g., then) extract the cells and/or their relevant beams serving the zone from the network provided deployment/coverage ensemble configuration. This may allow the WTRU to evaluate execution conditions for the CHO candidates, determine RACH parameters, and/or initiate CHO to the successful candidate.

Additional configuration examples for a proactive CHO may provide alternatives to the use of deployment/coverage ensembles. In some examples, (e.g., relevant) coverage information for a CHO candidate (cell, beam) may be provided as part of a cell configuration for a (e.g., each) candidate.

A proactive CHO may be enabled, for example, by a network configuration that includes CHO candidate (cell, beam) pairs. A mapping may be provided of the CHO candidates to geographic coordinates and/or orientations.

In some examples, the geographic coordinates (e.g., location/position) and/or orientation/angular-span coordinates for the (cell, beam) pairs may be provided with respect to a WTRU position and/or a reference direction. The reference direction may be specified with respect to one or more of the cardinal directions and/or may be specified with respect to the current serving beam and/or another reference. The CHO candidates (e.g., the neighboring cells) may (e.g., thus) be provided with distance and/or orientation parameters, which may allow a WTRU to determine the active area if/when the WTRU may (e.g., suitably) attach to one or more of the candidates.

In some examples for proactive CHO, a configuration of candidate CHO (cell, beam) pairs may provide the location of a network node (e.g., DU, TRP, node) transmitting the candidates. The configuration may (e.g., additionally) include the orientation/angular-span of the beams associated with the nodes, for example, using coordinates and/or references. A WTRU (e.g., knowing the location/position of a set of nodes transmitting candidate CHO cells) may determine the strongest (e.g., nearest) node, for example, based on (e.g., knowing) the WTRU's own location/position, which may be obtained through local sensors. The network may cover special geographic settings or known shadowing (e.g., if any). The network may provide priorities to be used, for example, in addition to the nearest node selection and/or offsets that may be employed in computing the nearest node. The orientation for a (cell, beam) pair may be indicated, for example, with respect to a reference, which may be understandable at the WTRU. In some examples (e.g., to provide an orientation indication), the reference direction for the orientation may itself be part of the configuration. For example, the network may indicate that the reference direction is cardinal North (e.g., or a different cardinal direction). The (e.g., all the) angular spans for the beams may be provided, e.g., with respect to the reference direction. In some (e.g., different) examples, the reference direction may be provided with respect to a serving beam of the serving node through which the network provides the configuration of a proactive CHO. The reference direction may be updated by the network (e.g., if necessary).

A proactive conditional reconfiguration may be provided.

In some examples (e.g., for CHO), an IE (e.g., CondReconfigToAddModList) may provide a list of conditional reconfigurations that may be used to add and/or modify an (e.g., each) entry in the condReconfigId and/or the associated condition(s) (e.g., condExecutionCond and/or condRRCReconfig), which may allow the network to add a cell as a CHO candidate. A proactive CHO may use/specify a more feature rich IE (e.g., ProactiveCondReconfigToAddModList), which may provide the proactive configuration for the candidate (cell, beam) pairs to a WTRU, for example, by providing additional mapping of candidate (cell, beam) pairs to geographic coordinates and/or orientation, e.g., in a suitable format. For example:

Example of a Proactive Conditional Handover Configuration

-- ASN1START
-- TAG-CONDRECONFIGTOADDMODLIST-START
ProactiveCondReconfigToAddModList ::= SEQUENCE (SIZE (1.. maxNrofProactiveCondCells-r16)) OF
ProactiveCondReconfigToAddMod

| | |
|---|---|
| ProactiveCondReconfigToAddMod ::= | SEQUENCE { |
| ProactiveCondReconfigId | ProactiveCondReconfigId, |
| ProactiveCondExecutionCond | SEQUENCE (SIZE (1..2)) OF MeasId OPTIONAL, -- Cond |

condReconfigAdd

| | |
|---|---|
| ProactiveCondRRCReconfig | OCTET STRING (CONTAINING RRCReconfiguration) OPTIONAL, -- |

Cond condReconfigAdd
...
}
-- TAG-CONDRECONFIGTOADDMODLIST-STOP
-- ASN1STOP

In some examples (e.g., to realize a proactive CHO), the beams associated with a (e.g., each) CHO candidate cell and/or their mappings to geographic coordinates and/or orientations may be added in an RRCReconfiguration. This may be achieved by adding information elements as part of RRCConfiguration, which may provide the mapping of cell beams to geographic coordinates. Similar information elements may be added as part of a proactive beam failure recovery (e.g., as described herein, such as ProactivePRACH-ResourceDedicatedBFR, Proactive-BFR-SSB-Resource, Proactive-BFR-CSIRS-Resource, Proactive-BFR-Mapping, etc.). The network may choose which beams (e.g., SSB, CSI-RS based, and/or based upon new reference symbols used to identify such beams) to configure as part of a (e.g., each) candidate CHO cell.

In some examples, an RRCReconfiguration may be kept unchanged. The relevant beams associated with a given CHO candidate cell and/or mappings for a (e.g., each) proactive CHO candidate (cell, beam) pair may be added in an IE (e.g., ProactiveCondReconfigToAddMod IE), for example, using structures providing the beams for a (e.g., each) candidate cell and/or the active zone associated with a (e.g., each) (cell, beam) pair. In some examples (e.g., as shown in the example configuration below), a struct ProactiveCHOBeamList may be added to a proactive CHO configuration. This may provide a mechanism to the network to pre-configure (e.g., all) the beams (SSB and/or CSI-RS beams) for a candidate CHO cell to a WTRU. A CHO configuration may include Proactive-CHO-BeamMapping, which may be configured for a (e.g., each) configured beam for a candidate CHO cell. This may provide the mapping of a configured beam of a configured CHO candidate to geographic coordinates and/or orientation. Beams (e.g., as shown in the example configuration below) may be specified for a (e.g., each) CHO candidate and/or RACH occasion. PRACH preamble indices may (e.g., also) be specified per beam. A configuration may be simplified, for example, by associating a RACH configuration with a cell level configuration. A beam level configuration may allow a quick determination (e.g., at the network) which WTRU is using a given CHO (cell, beam) pair for CHO.

Example of a configuration with a ProactiveCondReconfigToAddModList information element

ProactiveCondReconfigToAddModList ::= SEQUENCE (SIZE (1.. maxNrofProactiveCondCells-r16) OF
ProactiveCondReconfigToAddMod

| ProactiveCondReconfigToAddMod ::= | SEQUENCE { | |
|---|---|---|
| ProactiveCondReconfigId | ProactiveCondReconfigId, | |
| ProactiveCondExecutionCond | SEQUENCE (SIZE (1..2)) OF MeasId | OPTIONAL, -- Cond |

condReconfigAdd

| | | |
|---|---|---|
| ProactiveCondRRCReconfig | OCTET STRING (CONTAINING RRCReconfiguration) | OPTIONAL, - |

- Cond condReconfigAdd

| | |
|---|---|
| ProactiveCHOBeamList | SEQUENCE (SIZE(1..maxNrofProactiveCHOBeams) OF |
| ProactiveCHO-BeamResource | OPTIONAL, -- Need M |

...
}

| | |
|---|---|
| ProactiveCHO-BeamResource ::= | CHOICE { |
| ssb | Proactive-CHO-SSB-Resource, |
| csi-RS | Proactive-CHO-CSIRS-Resource |

}

| | |
|---|---|
| Proactive-CHO-SSB-Resource ::= | SEQUENCE { |
| ssb | SSB-Index, |
| active-area | Proactive-CHO-BeamMapping, |
| priority | INTEGER (range from Lowest Priority to Highest Priority) |
| ra-PreambleIndex | INTEGER (0..63), |

...
}

| | |
|---|---|
| Proactive-CHO-CSIRS-Resource ::= | SEQUENCE { |
| csi-RS | NZP-CSI-RS-ResourceId, |
| active-area | Proactive-CHO-BeamMapping, |
| priority | INTEGER (range from Lowest Priority to Highest Priority) |
| ra-OccasionList | SEQUENCE (SIZE(1..maxRA-OccasionsPerCSIRS)) OF INTEGER (0..maxRA- |

Occasions-1) OPTIONAL, -- Need R

| | | |
|---|---|---|
| ra-PreambleIndex | INTEGER (0..63) | OPTIONAL, -- Need R |

...
}

| | |
|---|---|
| Proactive-CHO-BeamMapping ::= | SEQUENCE { |
| beam-reference-orientation | Reference-Orientation [in coordinates] |
| beam-start-angle | BEAM-Start-Angle |
| beam-end-angle | BEAM-End-Angle |
| beam-reference-position | Reference-Position [in coordinates or Zones] |
| beam-Active-SPAN | Active-Span [in geogrphaic coordinates or Zones] |

...
}

As shown in the example configuration, CHO candidate cells may be defined. Beams may be indicated for a (e.g., each) CHO cell, e.g., with mapping to geographic coordinates and/or orientations, which may (e.g., effectively) provide the mapping of a (e.g., each) (cell, beam) pair to geographic coordinates and/or orientation. Some example configurations may be provided (e.g., entirely) as (cell, beam) candidate pairs.

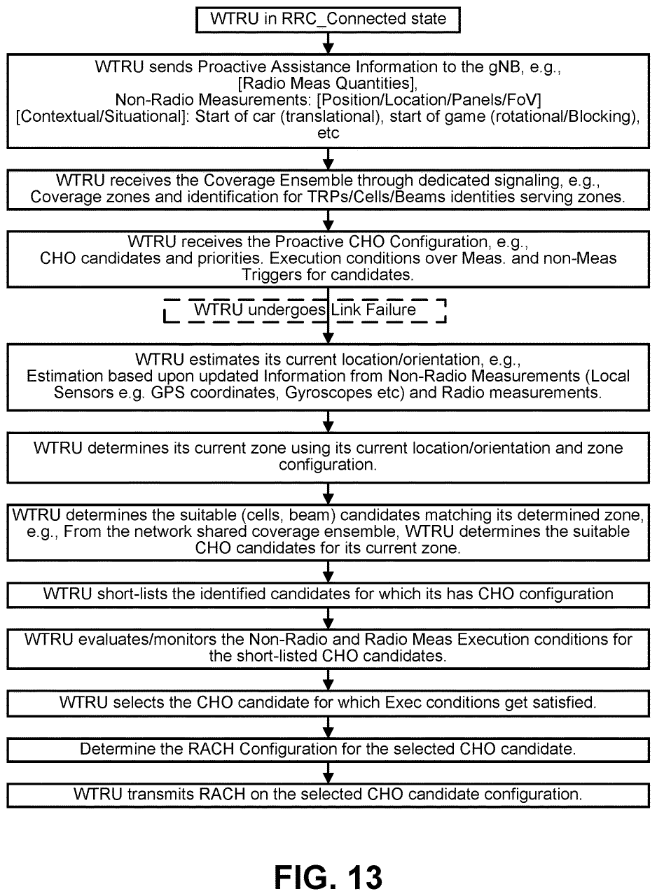

Features associated with proactive CHO with coverage ensemble indication, e.g., as WTRU dedicated signaling, may be described herein. FIG. 13 shows an example of a proactive CHO associated with a WTRU, e.g., a WTRU undergoing link failure.

FIG. 13 illustrates an example of a proactive CHO with a coverage ensemble, e.g., provided as dedicated signaling.

As shown in FIG. 13, one or more of the following may apply (e.g., may be implemented).

A WTRU may send assistance information to the network (e.g., base station, node, etc., where node may be used as an example herein). The assistance information may comprise one or more of the following groups of information: radio-measurement-quantity-based-data; non-radio-measurement-quantity-based-data; or WTRU-capability-and-Implementation-details. The node may transmit a coverage ensemble, e.g., through WTRU dedicated signaling, for example with cell/beam level granularity with zone indications (e.g., suitable cell/beam level granularity with zone indications). The WTRU may receive the local coverage ensemble transmitted by the network. The local coverage ensemble may comprise one or more of the following: a local snapshot of different zones at cell/beam level granularity, e.g., with identification of the coverage of different zones; or the cells/beams associated to each zone. The node may prepare a proactive CHO configuration (e.g., suitable proactive CHO configuration, which may include execution conditions/events defined over radio and non-radio measurement quantities) based on one or more of WTRU assistance information, WTRU profile, or the network deployment/configuration. The node may transmit this configuration to the WTRU. The WTRU may receive the proactive CHO configuration from the node. The proactive CHO configuration may comprise one or more of: a set of CHO candidates (e.g., (cell, beam) pairs); or a priority of (cell, beam) pairs if multiple (cell, beam) pairs may have overlap over geographic zones/orientations.

The WTRU may start the proactive conditional handover processing, e.g., on a condition, such as that the WTRU is undergoing compromised link quality (e.g., serving cell quality going below a configured threshold), where one or more of the following may be performed. The WTRU may receive information from local sensors (e.g., GPS, Accelerometer, Gyroscope, etc.), which may in examples be combined with radio measurements. The WTRU may determine the current values for its location/orientation parameters. The WTRU may determine its current zone in the coverage ensemble, e.g., using the determined/estimated values of its location/orientation. The WTRU may select the candidate (cell, beam) pairs corresponding to its determined zone in its coverage ensemble (e.g., its local copy of Coverage ensemble). The WTRU may determine a list (e.g., a short-list) of the selected candidates that are part of the proactive CHO configuration. The WTRU may evaluate the configured execution condition(s) for the target CHO candidates. The conditions may be a combination or composite over radio and non-radio measurements (e.g., events OD1/2 as described herein combined with legacy events A3/A4/A5, etc.). If execution condition(s) get fulfilled for a CHO candidate, the WTRU may determine the WTRU's associated RACH configuration, e.g., from the received CHO configuration. The WTRU may perform the conditional CHO on the target candidate (cell, beam) pair using RACH parameter(s), e.g., from the determined RACH configuration.

Features associated with the proactive CHO may include (e.g., additionally or alternately include) one or more of the following. The WTRU may be configured with multiple sets of CHO configurations. In one example, the sets of conditional handover configurations may be associated with the WTRU mobility (e.g., two sets for device mobility and external mobility). The WTRU may determine the configuration (e.g., suitable configuration) to use by determining the cause of mobility as device mobility or external mobility, e.g., from measurement(s) from sensor(s), for example from local sensors' measurements. For example, if the WTRU determines a cause of mobility as device mobility, the WTRU may use the conditional handover configuration set associated with device mobility, and, if the WTRU determines a cause of mobility as external mobility, the WTRU may use the conditional handover configuration set associated with external mobility. The sets of CHO configurations may be associated with (e.g., indicated to be associated with) different QoS requirements of specific applications/services running at the WTRU device. The sets of CHO configurations may be associated with (e.g., indicated to be associated with) different WTRU power consumption requirements (e.g., one set for one power consumption requirement and another set for a different power consumption requirement). The sets of CHO configurations may be associated with (e.g., indicated to be associated with) WTRU subscription. In examples, one (e.g., only one) unified configuration is provided to a WTRU. The network provided ensemble may comprise the deployment parameters of its cells, TRPs, and/or beam relevant parameters. The WTRU may perform post-processing on the deployment ensemble received from the network to fabricate an effective coverage ensemble. The WTRU post-processing on the deployment ensemble may use the information from its local sensors to fabricate the effective coverage ensemble. The WTRU post-processing on the deployment ensemble may use the locally stored information to fabricate the effective coverage ensemble. One example may be to use the topographical and terrain related ensembles which may be available in the local storage or through some other source. The WTRU may switch its active antenna panel (e.g., prior to evaluation of execution conditions for a CHO candidate), for example, based on (e.g., upon) a determination of the CHO candidate(s) for the WTRU's current position/orientation (e.g., from the coverage ensemble).

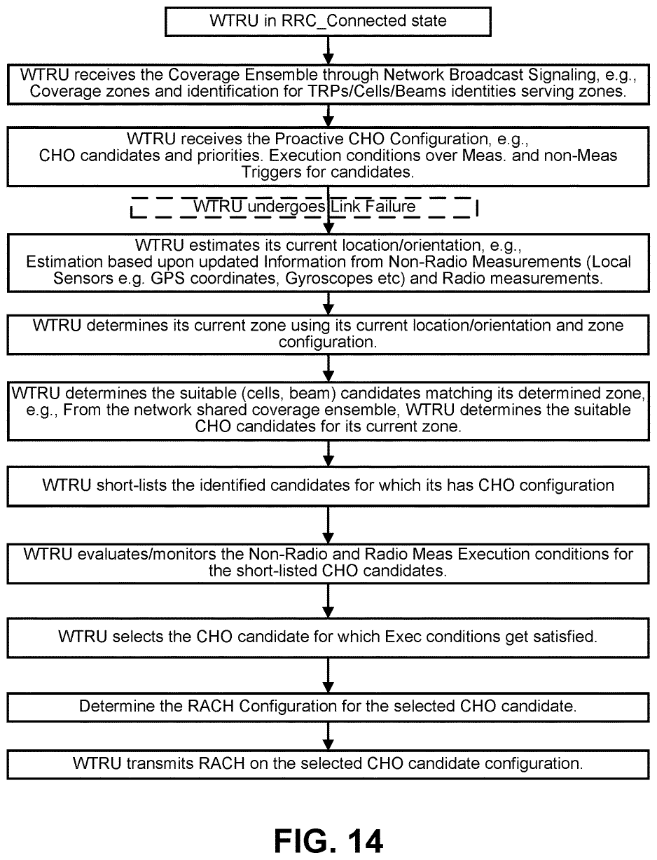

Features associated with a proactive CHO, e.g., with an SIB based coverage ensemble indication may be described herein. FIG. 14 shows an example of a procedure for a proactive CHO for a WTRU, e.g., a WTRU undergoing link failure.

FIG. 14 illustrates an example of a proactive CHO with an SIB based coverage ensemble. As shown in FIG. 14, one or more of the following may apply for a WTRU undergoing a conditional handover.

A WTRU may receive a coverage ensemble transmitted by the network (e.g., base station, node, etc., where node may be used as an example herein), for example, as part of a system information (SI) broadcast. The coverage ensemble may include/comprise, for example, one or more of the following: a local snapshot of different zones (e.g., at cell/beam level granularity), for example, with identification of the coverage of different zones; and/or (cell, beam) pairs associated with each zone.

The node may prepare a proactive CHO configuration. The configuration may be based on, for example, WTRU assistance information, a WTRU profile, and/or the network deployment/configuration. The configuration may be transmitted to the WTRU.

The WTRU may receive a proactive CHO configuration from the node. The configuration may comprise, for example, at least one of the following: a set of CHO candidates; execution conditions over radio and non-radio measurement quantities and joint events over such quantities; and/or the priority of (cell, beam) pairs, for example, for use if/when multiple CHO candidates may overlap over geographic zones/orientations.

The WTRU may undergo compromised link quality (e.g., serving cell quality going below a configured threshold). The WTRU (e.g., with compromised link quality) may start the proactive conditional handover processing, which may include, for example, one or more of the following. The WTRU may get information from local sensors (e.g., GPS, accelerometer, gyroscope, etc.), which may be combined with radio measurements; the WTRU may determine the current values for its location/orientation parameters. The WTRU may determine its current zone in the coverage ensemble, for example, using the estimated values of its geographic coordinates (e.g., location, position, and/or orientation) and the zone configuration. The WTRU may determine the candidate (cell, beam) pairs corresponding to its determined zone, for example, using the WTRU's local copy of Coverage ensemble. The WTRU may short-list the candidates that are part of the proactive CHO configuration. The WTRU may evaluate the configured execution conditions for the target CHO candidates, for example, where the conditions may be a combination or composite over radio and non-radio measurements (e.g., events OD1/2 combined with events A3/A4/A5, etc.). The WTRU may determine its associated RACH configuration from the received CHO configuration, for example, if execution conditions get fulfilled for a CHO candidate. The WTRU may perform the conditional CHO on the target candidate (cell, beam) pair, for example, using the determined RACH parameters.

Features associated with the proactive CHO may include (e.g., additionally or alternately include) one or more of the following. The WTRU may be configured with multiple sets of CHO configurations. The sets of conditional handover configurations may be associated with device mobility and external mobility (e.g., in examples two sets, for example for device mobility and external mobility). The WTRU may determine the configuration (e.g., suitable configuration) to use by determining the cause of mobility as device mobility or external mobility, e.g., from measurement(s) from sensor(s), for example from local sensors' measurements. For example, if the WTRU determines a cause of mobility as device mobility, the WTRU may use the conditional handover configuration set associated with device mobility, and, if the WTRU determines a cause of mobility as external mobility, the WTRU may use the conditional handover configuration set associated with external mobility. The sets of CHO configurations may be associated with (e.g., indicated to be associated with) QoS requirements of specific applications/services running at the WTRU device. The sets of CHO configurations may be associated with (e.g., indicated to be associated with) WTRU power consumption requirements. The sets of CHO configurations may be associated with (e.g., indicated to be associated with) WTRU subscription. In examples, one (e.g., only one) unified configuration is provided to a WTRU. The network provided ensemble may comprise the deployment parameters of its cells, TRPs, and/or beam relevant parameters. The WTRU may perform post-processing on the deployment ensemble received from the network to fabricate an effective coverage ensemble. The WTRU post-processing on the deployment ensemble may use the information from its local sensors to fabricate the effective coverage ensemble. The WTRU post-processing on the deployment ensemble may use the locally stored information to fabricate the effective coverage ensemble. One example may be to use the topographical and terrain related ensembles which may be available in the local storage or through some other source. The WTRU may switch its active antenna panel (e.g., prior to evaluation of execution conditions for a CHO candidate), for example, based on (e.g., upon) a determination of the CHO candidate(s) for the WTRU's current position/orientation (e.g., from the coverage ensemble).

Features associated with a proactive CHO with an ensemble (e.g., as part of a CHO configuration) are provided herein. Proactive features may be associated with a WTRU undergoing a conditional handover.

In examples, one or more of the following may be performed (e.g., by a WTRU) during a proactive CHO.

A WTRU may send assistance information (e.g., proactive assistance information) to a network (e.g., a base station, a node, etc. of the network). The assistance information may indicate characteristic(s) associated with the WTRU, e.g., as discussed herein. For example, a characteristic of the WTRU may be one or more of: a position of the WTRU; an orientation of the WTRU; a number of panels; an active antenna panel; a capability (e.g., of the WTRU) to determine its rotation, translation, and/or position (e.g., such as through sensors); or a field of view (FoV) of the WTRU. The assistance information may comprise, for example, one or more of the following groups of information: radio measurement quantity based data; non radio measurement quantity based data; and/or WTRU capability and implementation details. The transmission of assistance information may be in response to contextual and/or situational triggers (e.g., starting of a car or starting of game. Contextual and/or situation triggers may include translational or rotational triggers.

The network (e.g., a node, for example a node, of the network) may (e.g., proactively) prepare/determine CHO configuration sets. A CHO configuration set (e.g., each CHO configuration set) may be based on one or more of the following: received WTRU assistance information, a WTRU profile, and/or a network deployment/configuration. A CHO configuration set (e.g., each CHO configuration set) may comprise one or more of the following: one or more CHO candidates (e.g., groupings of cells and their associated beams); an execution condition of a CHO candidate (e.g., each CHO candidate) in the CHO configuration set; a mapping of a CHO candidate (e.g., each CHO candidate) in the CHO configuration set to geographic coordinates and/or orientation; and/or a priority of a CHO candidate (e.g., each CHO candidate) in the CHO configuration set.

A CHO candidate (e.g., each CHO candidate) in a CHO configuration set may include one or more cells (e.g., and associated beams). A cell (e.g., each cell) may be associated with (e.g., include) one or more beams. A CHO candidate may be associated with and/or included in multiple CHO candidate sets.

A CHO candidate (e.g., each CHO candidate) in a CHO configuration set may have an associated execution condition. The execution condition may specify signal and/or WTRU condition(s). A link may be established with the CHO candidate (e.g., a RACH transmission is sent to the CHO candidate) based on the condition(s) begin satisfied. The execution condition may be based on radio measurement(s) and/or non-radio measurement(s)/event(s). The execution condition of a (e.g., each) CHO candidate may be determined/selected by the WTRU or the network (e.g., a node, such as a node, of the network).

A CHO candidate (e.g., each CHO candidate) included in CHO configuration information (e.g., a CHO configuration set) may be mapped to geographic coordinates (e.g., geographic zones) and/or orientation. In examples, portions of CHO configuration information (e.g., CHO configuration sets) may be mapped to geographic coordinates (e.g., geographic zones) and/or orientation (e.g., rather than individual CHO candidates within the CHO configuration information being mapped to geographic coordinates and/or orientation). The mapping may be used to associate a CHO configuration set (e.g., the CHO candidates within the CHO configuration set) with a particular scenario/condition. For example, the mapping may indicate a CHO configuration set is an external mobility CHO configuration set or a device mobility CHO configuration set. An external mobility CHO configuration set may include CHO candidate(s) to be used for CHO when external movement is determined (e.g., by the WTRU). External movement may be associated with obstruction caused by movement of another object, e.g., that reduces the WTRU's link quality. A device mobility CHO configuration set may include one or more CHO candidate(s) to be used for CHO when a change in the WTRU's position and/or orientation reduces the WTRU's link quality.

A CHO candidate (e.g., each CHO candidate) in CHO configuration information (e.g., in a CHO configuration set) may have an associated priority. The priority of a CHO candidate may be used (e.g., by the WTRU) to determine/select a CHO candidate if/when multiple CHO candidates (e.g., (cell, beam) pairs) overlap for geographic coordinates and/or orientations.

The network (e.g., a node of the network) may transmit CHO configuration set(s) to the WTRU. The network may indicate a mapping of a CHO configuration set (e.g., each CHO configuration set) to a scenario/condition (e.g., such as external mobility or device mobility). The CHO configuration set may be transmitted over a WTRU dedicated signal and/or a system information broadcast.

A WTRU may receive CHO configuration information (e.g., CHO configuration set(s)) from the network (e.g., which may each comprise one or more CHO candidates). The CHO configuration information may be associated with (e.g., separately indicated) for a scenario/condition. For example, the configuration information may include external mobility CHO configuration information (e.g., a CHO configuration set that may be used when external movement, such as movement from another object, reduces the WTRU's link quality) and/or a device mobility CHO configuration information (e.g., a CHO configuration set that may be used when a change in the WTRU's position or orientation reduces the WTRU's link quality). The WTRU may use received CHO configuration information (e.g., proactively, for example before RLF) upon detecting and/or anticipating link deterioration (e.g., by determining a radio link condition is satisfied before RLF, for example, based on radio measurements and/or non-radio events, such as movement of the WTRU).

The network (e.g., a node of the network) may transmit coverage information to the WTRU (e.g., in addition to CHO configuration information). The coverage information may indicate a network deployment of cells and beams. For example, the coverage information may provide the WTRU with one or more cells in the WTRU's vicinity. The coverage information may be received by the WTRU over a WTRU dedicated signal and/or a system information broadcast. The coverage information may be transmitted by the network to a WTRU (e.g., over a WTRU dedicated signal) upon receipt of assistance information from the WTRU.

The WTRU may perform proactive CHO processing based on a determined mobility cause and/or a determined radio link condition being satisfied (e.g., where the radio link condition indicates a degradation of a serving link). For example, the WTRU may perform proactive CHO processing if/when the WTRU undergoes (e.g., is undergoing) compromised link quality (e.g., serving cell quality going below a configured threshold). Performing proactive CHO may be based on the WTRU obtaining data from local sensors (e.g., GPS, accelerometer, gyroscope, etc.), which may be combined with radio measurements. The WTRU may evaluate the change in local sensor data and/or configured conditions, for example, to determine a mobility cause or whether a radio link condition is satisfied.

A mobility cause may indicate external mobility (e.g., change in link quality resulting from a change in position and/or orientation by an external object) and/or device mobility (e.g., change in the position and/or orientation of the WTRU). The mobility cause may be based on non-radio measurements and/or events (e.g., data collected from local sensors). The WTRU may determine a location and/or orientation (e.g., updated location and/or orientation) based on the non-radio measurement and/or determined mobility cause. A mobility cause may be determined (e.g., by the WTRU) to be external mobility and/or device mobility.

A radio link condition may indicate a degradation of a serving link. The radio link condition may be selected such that the condition being satisfied indicates an anticipated radio link failure. The WTRU may perform CHO (e.g., proactively) based on a determination that the radio link condition is satisfied. In examples, the radio link condition is based on a mobility cause, radio measurements and/or non-radio measurements. A mobility cause may be associated with a radio link condition (e.g., movement of the WTRU may be associated with a determined degradation of a link serving the WTRU)

The WTRU may determine/select the CHO configuration information (e.g., the CHO configuration set), for example, based on a determined mobility cause and/or a determined radio link condition being satisfied. The WTRU may select a CHO candidate (e.g., from the CHO configuration information), for example, based on one or more of a non-radio measurement, a determined mobility cause, received coverage information, or a determination that a radio link condition is satisfied.

In examples, the WTRU may determine a CHO candidate based on one or more of: a mobility cause, coverage information, or CHO configuration information (e.g., CHO configuration sets). For example, if the WTRU determines a mobility cause is device mobility, the WTRU may determine/select a CHO candidate (e.g., a (cell, beam) pair) from (e.g., received) device mobility CHO configuration information. For example, if the WTRU determines a mobility cause is external mobility, the WTRU may determine/select a CHO candidate (e.g., a (cell, beam) pair) from (e.g., received) external mobility CHO configuration information.

A CHO candidate may be determined/selected (e.g., by the WTRU) from a mapping table (e.g., for device mobility CHO configuration information and/or for an external mobility CHO configuration information). The determination/selection of a CHO candidate (e.g., by a WTRU) may be based on the WTRU's determined geographic coordinates (e.g., position/location, orientation, etc.) and/or radio measurements.

The WTRU may select a highest priority CHO candidate (e.g., (cell, beam) pair) from the candidates of CHO configuration information (e.g., the CHO configuration information corresponding to a determined mobility cause). The WTRU may activate an antenna panel associated with the selected CHO candidate. For example, the WTRU may switch an active antenna panel according to coverage information and/or a selected CHO candidate.

The WTRU may evaluate (pre)configured execution conditions for a CHO candidate (e.g., before selecting/transmitting to the CHO candidate). The WTRU may perform the CHO to the CHO candidate (e.g., target cell on the target beam), for example, if the execution condition is satisfied.

The WTRU may send a RACH transmission to the determined/selected CHO candidate cell. The determined/selected CHO candidate cell may be associated with one or more beams. A RACH configuration may be determined (e.g., by the WTRU) based on the determined/selected CHO candidate (e.g., a strongest beam associated with the CHO candidate). The RACH transmission may be sent in accordance with the RACH configuration.

Features associated with the proactive CHO may include (e.g., additionally or alternately include) one or more of the following. The set(s) (e.g., two sets) of conditional handover configurations may be associated with device mobility and/or external mobility. The sets of CHO configurations may be (e.g., indicated to be) associated with one or more QoS requirements of one or more applications/services, which may be running at the WTRU device. The sets of CHO configurations may be (e.g., indicated to be) associated with one or more WTRU power consumption requirements. The sets of CHO configurations may be (e.g., indicated to be) associated with the WTRU subscription. A (e.g., only one) unified configuration may be provided to the WTRU.

Features associated with joint proactive beam recovery and conditional handover are described herein. In some examples, a WTRU may be configured by the network jointly for a proactive conditional handover. Features may (e.g., also) be applicable to proactive beam recovery. One or more of the following may apply.

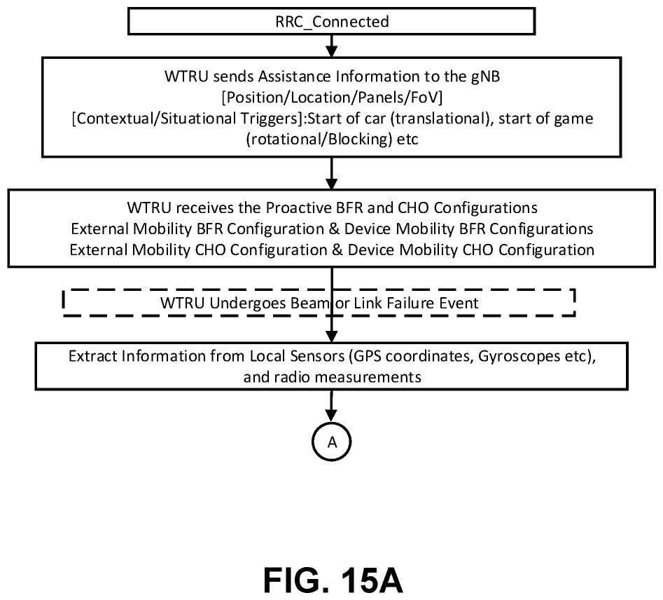

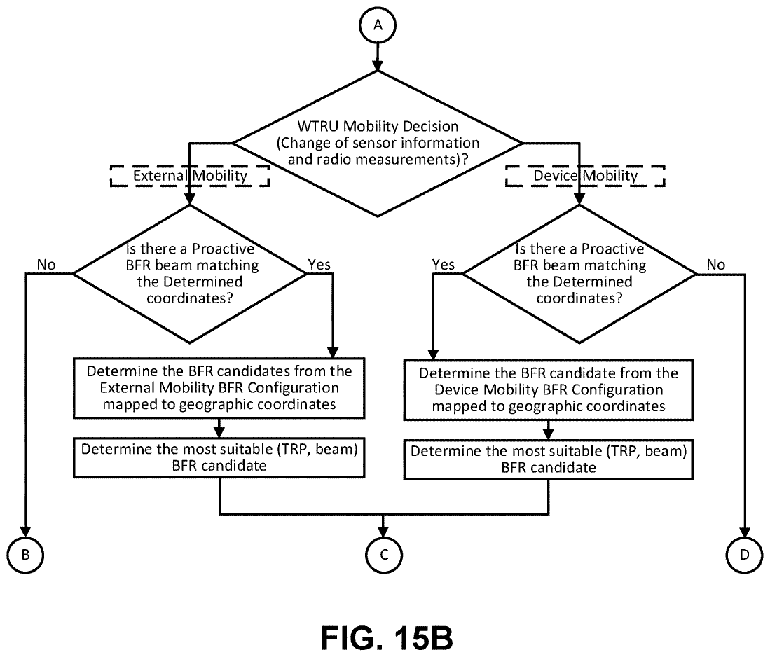

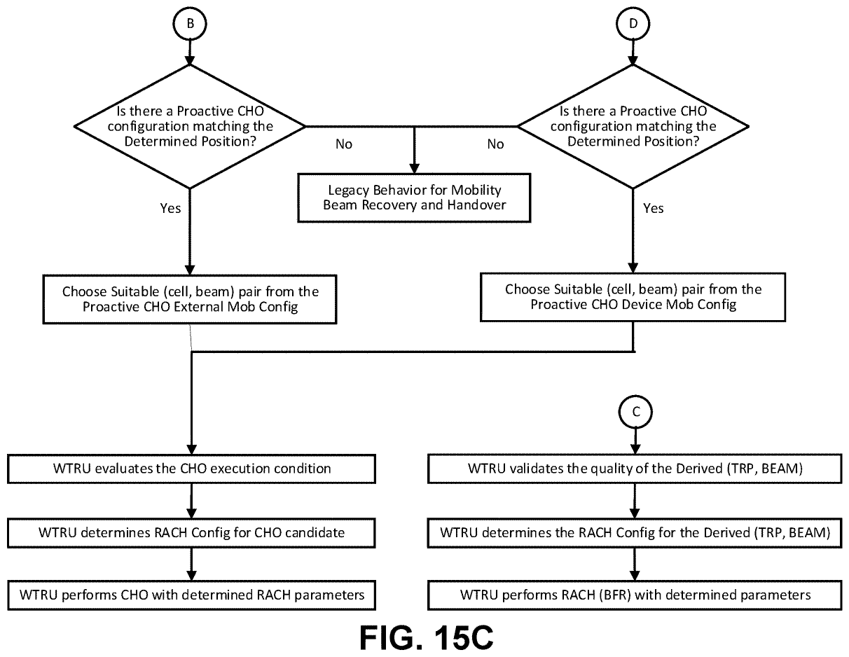

A WTRU may be configured with a proactive BFR and CHO. FIGS. 15A-15C show an example where a WTRU may be provided (e.g., by the network) with a proactive BFR configuration and a proactive CHO configuration. The WTRU may provide assistance information to the network. The network may determine (e.g., and create/generate) a proactive BFR configuration and a proactive CHO configuration, for example, using the assistance information and the network's known deployment of cells, beams, and/or location of TRPs. The network may configure the WTRU with the configurations for proactive BFR and CHO. The configurations may include, for example, one or more details as described herein.

FIGS. 15A-15C illustrate an example where a WTRU may be configured with a proactive BFR configuration and a proactive CHO configuration. As shown in FIGS. 15A-15C, one or more of the following features may be applied/implemented.

A WTRU may (e.g., if the link quality degrades for the WTRU) extract information from its measurements, interfaces, and/or local sensors, for example, to determine the WTRU's updated geographic coordinates and/or orientation. The determination of an updated geographic coordinates and/or orientation may (e.g., additionally) use radio measurements, e.g., to make the estimate more precise, robust, and/or granular. A WTRU may determine whether there is a proactive recovery beam. The WTRU may extract the (e.g., relevant) configured parameters and/or initiate beam recovery, for example, using a derived recovery beam (e.g., if the WTRU finds the recovery beam).

In some examples (e.g., as shown in FIGS. 15A-15C), a beam recovery (e.g., if configured and possible) may be prioritized over a conditional handover. A beam recovery may be prioritized, for example, because a CHO may involve an update of the cell configuration, which may involve configurational changes (e.g., with respect to the current active cell configuration) and/or may have a higher impact on the QoS (e.g., compared to beam recovery). Variations of the example shown in FIGS. 15A-15C may be implemented. For example, FIGS. 15A-15C show beam recovery prior to finding a CHO candidate. In some examples, a WTRU may simultaneously evaluate BFR and CHO configurations, e.g., with respect to the WTRU updated determined geographic coordinates. The WTRU may select the most appropriate candidate from BFR and/or CHO configurations.

As shown in FIGS. 15A-15C, the WTRU may not find a recovery beam. The WTRU may determine whether there is a CHO configuration for the updated position. The WTRU may (e.g., if the WTRU is configured with a CHO configuration matching its determined coordinates) choose/select the (cell, beam) pair from its selected CHO configuration. The WTRU may initiate the CHO execution, for example, if the execution conditions are fulfilled.

There may be multiple candidates specified with priority ordering. The WTRU may, for example, try a highest priority candidate first before trying the next highest priority candidate. Multiple candidates with a priority indication may be provided for a BFR and/or a CHO.

In some examples, a proactive BFR and/or CHO procedure may not be successful (e.g., succeed to completion), which may be the result of one or more of the following: the WTRU may not receive a positive response to its BFR recovery transmission, a CHO condition may not be fulfilled, CHO execution may fail, and/or a CHO/BFR configuration may be missing for the WTRU coordinates. The WTRU may (e.g., based on unsuccessful completion) resort to another (e.g., legacy) beam recovery and/or handover procedure. The WTRU may (e.g., eventually) fall back to RRC reestablishment and/or cell selection procedures.

A WTRU may be configured with a proactive BFR and CHO. An exemplary embodiment specifying a procedure to have Proactive features may be associated with a WTRU undergoing bad radio situations, which may result in beam/link failures. One or more of the following may apply.

A WTRU may send assistance information to the network (e.g., base station, node, etc., where node may be used as an example herein). The assistance information may comprise, for example, one or more of the following: radio-measurement-quantity-based-data; non-radio-measurement-quantity-based-data; and/or WTRU-capability-and-Implementation-details. The node may prepare multiple configurations for a proactive BFR and a proactive CHO, for example, based on one or more of the following: the WTRU assistance information, a WTRU profile, application/services that may be running at the WTRU, a WTRU subscription level, and/or the network knowledge of its deployment of cells, beams, and/or transmission nodes. The node may transmit the sets of configurations to the WTRU. The WTRU may receive the proactive BFR and CHO configurations from the node, which may comprise, for example, one or more of the following: a set of (e.g., two) proactive BFR configurations and a set of (e.g., two) proactive CHO configurations.

A set of (e.g., two) proactive BFR configurations may include, for example, a (e.g., one) configuration associated with device mobility and a configuration associated with external mobility. A (e.g., each) configuration may comprise one or more of the following: a set of candidate beams/TRPs; candidate beams associated with an SSB, CSI-RS, and/or other reference signal(s); RACH parameter(s) associated with each candidate beam; a mapping of candidate TRPs/beams to location/position, orientation for device mobility; a mapping of candidate TRPs/beams for external mobility; an indication of priority for candidate beams, for example, if/when multiple candidate beams may have at least partial overlap for geographic coordinates.

A set of (e.g., two) proactive CHO configurations may include, for example, a (e.g., one) configuration associated with device mobility and a configuration associated with external mobility. A (e.g., each) configuration may comprise one or more of the following: a set of CHO candidate (cell, beam) pairs; a mapping of each candidate (cell, beam) pair to geographic coordinates and/or orientation; and/or a priority of (cell, beam) pairs, for example, for use if/when multiple (cell, beam) pairs may have overlap over geographic zones/orientations.

The WTRU may start the composite proactive beam recovery and conditional handover procedure, for example, if/when WTRU experiences/undergoes (e.g., is undergoing) compromised link quality (e.g., beam and/or cell quality going below configured threshold(s). The WTRU may obtain information from local sensors (e.g., GPS, accelerometer, gyroscope, etc.), which may be combined with radio measurements. The WTRU may evaluate the change in local sensors data and/or configured conditions, for example, to determine device mobility and/or external mobility (e.g., as per the configuration to determine Device/External Mobility).

The WTRU may select the device/external mobility beam recovery configuration. The WTRU may determine the candidate beams as recovery candidates from the selected configuration mapping table, for example, using the WTRU's determined geographic coordinates (e.g., position/location, orientation, etc.) and/or radio measurements. The WTRU may select the highest priority beam among the determined candidates. The WTRU may activate the antenna panel associated with the selected BFR candidate. The WTRU may measure the quality of the selected BFR candidate beam, for example, using the configured measurement signal(s) and the configured threshold(s). The WTRU may extract its associated RACH configuration parameters, for example, if/when the selected candidate satisfies/passes the quality condition(s). The WTRU may transmit RACH for the BFR candidate, for example, using the derived RACH parameters. The WTRU may prepare and/or transmit BFR MAC-CE, which may provide the information of the candidate beam(s) to the network.

The WTRU may select an (e.g., appropriate) device/external mobility CHO configuration, for example, if the WTRU does not find a beam recovery candidate that corresponds to its geographic coordinates and/or orientation in beam recovery configurations. The WTRU may determine the candidate (cell, beam) pairs as selected candidates from the selected configuration mapping table, for example, using the WTRU's determined geographic coordinates (e.g., position/location, orientation, etc.) and/or radio measurements. The WTRU may select the highest priority CHO candidate (cell, beam) pair among the determined candidates. The WTRU may activate the antenna panel associated with the selected CHO candidate. The WTRU may evaluate the configured execution conditions for the target CHO candidate. The WTRU may perform the conditional CHO to the CHO target cell on the target beam, for example, if the execution condition(s) is (are) satisfied.

The WTRU may fall back to an alternative beam recovery (e.g., legacy behavior for beam recovery) and/or (e.g., conditional) handover, for example, if the WTRU does not find a CHO candidate that corresponds to the WTRU's geographic coordinates and/or orientation in proactive CHO configurations.

For the WTRU configuration jointly with a proactive BFR and CHO, the mapping of BFR and CHO candidates may be provided to the WTRU through deployment or coverage ensemble. The WTRU may (e.g., then) determine its zone after a mobility event and may determine the suitable BFR and/or CHO candidates to proceed with BFR and/or CHO procedure.

Features associated with non-volatile conditional (re)configuration and candidates are disclosed herein. The volatility of conditional (re)configurations may be reduced/minimized.

The terms “non-volatile conditional handover configurations” and “non-volatile CHO candidates” may be used to describe, respectively, conditional configurations and CHO candidates that are not volatile. Volatile configurations and volatile CHO candidates may be, for example, as described herein. Non-volatile configurations and non-volatile candidates may be maintained by a WTRU as active, for example, despite successful execution of a conditional configuration to a CHO candidate. Non-volatile configurations/candidates may have one or more (e.g., special) release conditions, which may be configured as part of the configuration itself.

A PCell may be configured as a non-volatile CHO candidate. A WTRU may have the configuration for the current PCell. A WTRU may save the cell configuration, for example, if the WTRU changes to another PCell (e.g., if this is indicated as part of the conditional configuration). The execution conditions may be provided while the PCell is indicated as a potential CHO candidate (e.g., for later use).

Features and principles described herein (e.g., in examples for conditional handover configuration and CHO candidates) may apply (e.g., verbatim) to a conditional PSCell change (CPC) and CPC candidates, which may become non-volatile CPC configurations and non-volatile CPC candidate cells.

Features associated with non-volatile conditional configurations/candidates are described herein. A non-volatile conditional reconfiguration may implement one or more of the following. A WTRU may provide (e.g., special) non-volatile assistance information to the network providing the knowledge of contextual/application information, nature of device, and/or mobility dynamics. The network may configure a conditional handover configuration (e.g., where a set of candidates may be marked as non-volatile), for example, using the received non-volatile assistance information from the device, the device profile, the device history at the network, and/or network data analytics. Non-volatile candidates may have a conditional configuration that is not released, for example, even if the WTRU successfully executes CHO to a configured candidate. Release conditions for non-volatile candidates may be pre-defined and/or may be specified (e.g., explicitly), e.g., as part of the configuration. The release conditions may be expressed in terms of one or more of a timer expiry, a change of WTRU mobility state, a number of transitions, and/or one or more non-measurement events/triggers. The WTRU may continue evaluating conditions configured for execution of a conditional configuration. The WTRU may execute the associated conditional configuration, for example, if the execution conditions are fulfilled to one of the CHO candidates (e.g., volatile or non-volatile). The WTRU may (e.g., after successful execution) release the volatile candidates (and configurations) while retaining non-volatile candidates (e.g., and configurations) as active. The WTRU may continue monitoring the trigger conditions for the retained candidates and configurations. The WTRU may continue performing the execution of the conditional configuration to the candidate fulfilling the conditions. The WTRU may (e.g., after each execution) release the volatile candidates/configurations and maintain the non-volatile candidates/configurations as active. The WTRU may release the concerned configurations/candidates, for example, if/when the release conditions for non-volatile configurations/candidates are fulfilled.

Non-volatile conditional configurations/candidates may be similar to conditional configurations/candidates, except (e.g., at least) for one or more (e.g., special) release conditions for non-volatile configurations. A WTRU may continue evaluating the configured release conditions in parallel to processing and evaluation of execution conditions for conditional configurations. The fulfillment of execution conditions may lead to the execution of a conditional configuration without release of non-volatile configurations/candidates. The fulfillment of release conditions may result in the release of non-volatile configuration/candidates.

Features associated with release conditions for non-volatile conditional configurations/candidates are disclosed herein.

Non-volatile conditional configurations/candidates may have one or more release conditions. Release conditions may be used individually or in one or more combinations to release the non-volatile conditional configurations/candidates.

A configuration release (e.g., for non-volatile configuration/candidates) may be a timer-based configuration release. A release condition for non-volatile CHO candidates may be (e.g., defined as) timer initialized with a configured value that starts to decrement, for example, if/when a WTRU receives a CHO configuration for a non-volatile CHO candidate. The value of the timer may be specified in terms of a time scale. A non-volatile configuration and/or the configured candidates may be released by a WTRU, for example, based on expiry of an associated timer.

A configuration release (e.g., for non-volatile configuration/candidates) may be conditioned upon a number of executions (e.g., a set number of executions). A release condition for non-volatile configuration/candidates may be specified in terms of a threshold on how many times a WTRU executes the conditional configuration. A threshold may be configured with value N. The WTRU may release the configuration/candidates, for example, after performing N conditional configurations (e.g., after being configured with the non-volatile configuration). The network may re-set or re-configure the value of a threshold, for example, by sending a message to the device. An example message may be in the form of RRC signaling providing an updated value for the threshold. A (e.g., more) dynamic update/refresh may use, for example, MAC and/or PHY signaling.

A configuration release (e.g., for non-volatile configuration/candidates) may be an RRC state change based configuration release. The release conditions for non-volatile configurations may be defined in terms of a change in a WTRU RRC state. A device of interest may release non-volatile conditional configurations/candidates, for example, if the device of interest moves out of an RRC active state (e.g., moving to RRC inactive state or RRC idle state).

Release conditions may be defined as a combination of timers, number of executions, and/or change of WTRU RRC state. A release condition may be defined different from a timer, a number of transition conditions, an RRC state, etc. A release condition may replace one or more conditions and/or add a (e.g., customized complementary) condition. A network configuration may provide a customized condition under which the configuration of non-volatile CHO candidates may be released.

A release condition may be a configured (group-) sequence based configuration release.

In some examples (e.g., a highway travel scenario), a network may know (e.g., very precisely) the sequence of cells that a WTRU (e.g, a moving vehicle, installed on a moving vehicle, etc.) may come under coverage of. The network configuration may provide a set of cells as non-volatile CHO candidates, which may be the set of cells deployed along a highway. A release/exit condition for a non-volatile CHO configuration may be a successful CHO to the next cell on the highway. The WTRU may keep performing CHO to the configured CHO candidates. The WTRU may (e.g., once it performs CHO to a given cell) remove the previous cell from the set of CHO candidates. The set of CHO candidates may continue shrinking. The network may configure additional CHO candidates (e.g., in a suitable manner) to avoid outages. The additional candidates may comprise volatile and/or non-volatile CHO candidates.

In some examples (e.g., for the highway scenario) there may be a sequence number. For example, a subset of cells may be assigned a sequence number #1, #2, and #3. The subset of cells assigned to #1 may a set of cells that serve an overlapping area using narrow beams. The subset of cells assigned to #2 and #3 may serve subsequent overlapping areas. A WTRU may keep (e.g., all) the configurations (e.g., initially), for example, as long as the WTRU is performing a CHO among the candidates in subset #1. The WTRU may release the configuration of (e.g., all) non-volatile CHO candidates in subset #1, for example, if/when the WTRU performs CHO to any of the cells in area #2. The WTRU may keep (e.g., all) the cells in subset #2 and #3 while it performs CHO to the cells in #2. The WTRU may release the configuration of (e.g., all) the CHO cells in subset #2, for example, if/when the WTRU performs CHO to any of the cells in subset #3.

A release condition may be a RAN tracking area based configuration release. In some examples the release conditions for non-volatile conditional configurations (e.g., and candidate cells) may be specified in terms of a tracking area identity (e.g., instead of assigning the set of cells, and their conditional configurations, an artificial group identity). A WTRU may release (e.g., all) the configurations (e.g., and candidates) having the same RAN tracking area of the previous PCell, for example, if the WTRU moves to a conditional configuration candidate with a new RAN tracking area. Release based on a tracking area may provide a grouping mechanism, where a network may (e.g., implicitly) know (e.g., and control) how and which configurations may be kept active by a WTRU. Release based on a tracking area may make use of RAN tracking area codes, which may group cells (e.g., similar to the highway example).

In some examples, release conditions may be defined in terms of a RAN registration area, e.g., where multiple tracking areas may be defined. A RAN registration area may use existing or new cell or cell group identities, which may be specified to be used in release conditions.

A release condition may be a non-measurement events/triggers based configuration release. Release conditions for CHO configurations/candidates may be specified, for example, in terms of non-measurement data. In some examples, GPS coordinates may be provided for TRPs. A WTRU may release CHO candidates associated with a set of TRPs, for example, if/when the WTRU's distance from the set of TRPs exceeds a given threshold. The association of TRPs and CHO candidate cells may be provided by the network. In some examples, the network may provide the GPS coordinates. A WTRU may release non-volatile configuration/candidates, for example, if WTRU coordinates (e.g., in terms of longitudes/latitudes) exceed configured values.

In some examples (e.g., for gaming scenarios where a device may be undergoing frequent handovers among a small subset of cells), cells may be configured as non-volatile CHO with timers. The timers may be reset, for example, each time the WTRU performs CHO to one of the configured CHO candidates. A successful CHO among the set may imply that the WTRU is still in the vicinity and prone to implement another CHO, e.g., potentially from the same set of cells. Resetting the timers may avoid the timers getting expired, which may permit the WTRU to implement a subsequent CHO without interruption (e.g., and without configuration overhead). A network being able to configure the PCell as one of the non-volatile CHO candidates may be (e.g., extremely) advantageous, for example, to support a WTRU moving frequently among a small subset of cells as its PCell follows the rotation events, which may occur in combination with limited translational mobility.

A release condition (e.g., for rotational mobility focused scenarios) may be triggered by an event when the WTRU hands over to a cell that is not part of the non-volatile CHO candidates. The triggering of the event may imply (e.g., in some deployment scenarios) that the WTRU has moved out of the boundary where the originally configured CHO candidates were useful, which may lead to the release of the candidates and associated configurations.

In some examples (e.g., having larger rotational mobility than translational mobility), non-measurement data based conditions may be specified to release the non-volatile configurations/candidates. A WTRU may release a non-volatile configuration, for example, if the WTRU moves away a certain distance from a reference location (e.g., specified as the device location and/or in terms of a reference point from the network, such as a serving or a different TRP location, or a general network provided reference location).

Features associated with a proactive non-volatile CHO are described herein. Feature discussed with respect to a non-volatile CHO candidate may be extended to proactive configurations. A WTRU may provide assistance information to a network (e.g., a node). The network may configure non-volatile proactive CHO candidates, for example, based on the received WTRU assistance information, the network deployment of cells/beams and network nodes, and/or the network data/WTRU profile. In some examples, the candidates may be bound to the geographic locations of the WTRU. In some examples, the WTRU may be provided with the locations and/or orientation of beams from a set of network nodes. The WTRU may derive the best node/beam/cell, for example, based upon its location/orientation. CHO candidates may be configured as non-volatile, e.g., as described herein. A WTRU may not release CHO configurations, for example, even if the WTRU undergoes a handover after receiving a proactive non-volatile CHO configuration.

In examples, proactive conditional handover may be combined with features associated with non-volatile conditional configurations/candidates.

Features associated with a non-volatile proactive conditional handover procedure are described herein. Proactive features may be associated with a WTRU undergoing a conditional handover with non-volatile conditional configurations. One or more of the following may apply.

A WTRU may send assistance information to the network (e.g., base station, node, etc., where node may be used as an example herein). The assistance information may comprise, for example, one or more of the following groups of information: radio-measurement-quantity-based-data; non-radio-measurement-quantity-based-data (e.g., including contextual information); and/or WTRU-capability-and-Implementation-details. The node may prepare a set of proactive non-volatile CHO configurations, for example, based on the WTRU assistance information, a WTRU profile, and/or the network deployment/configuration. The node may transmit the set of configurations to the WTRU. The WTRU may receive the proactive CHO configuration from the node. The proactive CHO configuration may comprise, for example, a set of non-volatile conditional configurations. A (e.g., each) configuration may be indicated for a scenario/condition. A (e.g., each) configuration may comprise, for example, one or more of the following: a set of CHO candidate (cell, beam) pairs; a mapping of each candidate (cell, beam) pair to geographic coordinates and/or orientation for Device Mobility and External Mobility; a mapping of each candidate (cell, beam) pair to geographic coordinates and/or orientation; a priority of (cell, beam) pairs, for example, if/when multiple (cell, beam) pairs may have overlap over geographic zones/orientations; an execution condition for each conditional configuration; and/or a release condition for each non-volatile conditional configuration.

The WTRU may start the proactive conditional handover processing, for example, if/when the WTRU is undergoing compromised link quality (e.g., serving cell quality going below a configured threshold), where one or more of the following may be performed. The WTRU may obtain/receive information from local sensors (e.g., GPS, accelerometer, gyroscope, etc.), which may be combined with radio measurements. The WTRU may evaluate the change in local sensor data and/or configured conditions, for example, to determine device mobility or external mobility (e.g., as per the configuration to determine Device Mobility or External Mobility).

The WTRU may select the Device Mobility CHO configuration, for example, If the WTRU determines Device Mobility. The WTRU may determine the candidate (cell, beam) pairs (e.g., as selected candidates from the selected configuration mapping table), for example, using the WTRU's determined geographic coordinates (e.g., position/location, orientation, etc.) and/or radio measurements.

The WTRU may select the External Mobility CHO configuration, for example, if the WTRU determines external mobility. The WTRU may determine the candidate (cell, beam) pairs (e.g., as selected candidates from the selected configuration mapping table), for example, using the WTRU's determined geographic coordinates (e.g., position/location, orientation, etc.).

The WTRU may select the highest priority CHO candidate (cell, beam) pair among the determined candidates. The WTRU may activate the antenna panel associated with the selected CHO candidate. The WTRU may evaluate the configured execution conditions for the target CHO candidate. The WTRU may perform the conditional CHO to the CHO target cell on the target beam, for example, if the execution condition is satisfied. The WTRU may evaluate the release conditions for non-volatile configurations/candidates. The WTRU may continue evaluating the execution conditions (e.g., and may execute the conditional configuration upon fulfillment), for example, if the release condition(s) is (are) not satisfied. The WTRU may release the associated non-volatile configurations/candidates, for example, if the release conditions are fulfilled.

Features associated with the non-volatile proactive CHO may include (e.g., additionally or alternately include) one or more of the following. The (e.g., two) sets of conditional handover configurations may be associated with Device Mobility and External Mobility. The sets of CHO configurations may be indicated to be associated with QoS requirements of one or more applications/services, which may be running at the WTRU device. The sets of CHO configurations may be indicated to be associated with one or more WTRU power consumption requirements. The sets of CHO configurations may be indicated to be associated with a WTRU subscription. In some examples, a (e.g., only one) unified configuration may be provided to the WTRU. The release condition for the non-volatile configuration may be defined, for example, in terms of a timer expiry. The release condition for the non-volatile configuration may be defined, for example, in terms of a threshold. The non-volatile configuration may be released, for example, if/when the number of executions exceeds the configured threshold. The release condition for the non-volatile configuration may be defined, for example, to trigger based on (e.g., upon) the WTRU changing state from RRC Active. The release condition for the non-volatile configuration may be defined, for example, in terms of a configured (group-) sequence, e.g., where the subsets of non-volatile candidates may be associated with an (e.g., one) entry of the configured sequence (e.g., in a suitable manner). The release condition for the non-volatile configuration may be defined, for example, in terms of a RAN notification area and/or a RAN tracking area identity. The WTRU may release the associated non-volatile configuration, for example, in case of a change in the RAN notification area and/or RAN tracking area identity. The release condition for the non-volatile configuration may be defined, for example, in terms of one or more WTRU location coordinates. The release condition for the non-volatile configuration may be defined, for example, in terms of one or more non-measurement data quantities, e.g., WTRU distance from a reference location exceeding a configured threshold.

Features associated with a non-volatile proactive CPC are described herein. Non-volatile conditional (re)configuration (e.g., as described herein) may be applied in the context of conditional handover. Non-volatile configuration may (e.g., also) be applied to a conditional CPC and/or CPA. In some examples, a WTRU may be configured to perform a conditional CPC with a non-volatile configuration and/or non-volatile CPC candidates. Proactive features may be associated with (e.g., the secondary cell group for) a WTRU undergoing a conditional PSCell change with one or more non-volatile conditional configurations. One or more of the following may apply.

A WTRU may send assistance information to the network (e.g., base station, node, etc., where node may be used as an example herein). The assistance information may comprise one or more of the following groups of information: radio-measurement-quantity-based-data; non-radio-measurement-quantity-based-data (e.g., including contextual information); and/or WTRU-capability-and-Implementation-details. The node may prepare a set of proactive non-volatile CPC configurations, for example, based on WTRU assistance information, a WTRU profile, and/or the network deployment/configuration. The node may transmit the set of configurations to a WTRU. A WTRU may receive a proactive CPC configuration from the node, which may comprise a set of non-volatile conditional configurations. A (e.g., each) configuration may be indicated for a scenario/condition. A (e.g., each) configuration may comprise, for example, one or more of the following: a set of CPC candidate (cell, beam) pairs; TRP locations, an association of cells with TRPs, a set of beams for a (e.g., each) candidate cell with angular coordinates (e.g., azimuthal and/or elevation angles), beam widths in horizontal and/or vertical planes, and/or beam range parameters, which may provide the association of TRPs/cells/beams with cells and/or beam identities; a mapping of a (e.g., each) candidate (cell, beam) pair to geographic coordinates and/or orientation for Device Mobility and External Mobility; a priority of (cell, beam) pairs, e.g., if/when multiple (cell, beam) pairs may have overlap over geographic zones/orientations; a conditional configuration with events having triggers over radio measurement and/or non-radio measurement quantities; and/or a release condition for a (e.g., each) non-volatile conditional configuration. The WTRU may prepare an On-The-Ground coverage ensemble, for example, using the deployment information from the network and/or topographical information from its local storage/sensors. The WTRU may build the zones (e.g., according to the configuration signaling), for example, as part of the coverage ensemble fabrication.

The WTRU may start the proactive conditional PSCell change processing, for example, if/when the WTRU is undergoing compromised PSCell link quality (e.g., cell quality going below a configured threshold), where one or more of the following may be performed. The WTRU may obtain information from local sensors (e.g., GPS, accelerometer, gyroscope, etc.), which may be combined with radio measurements. The WTRU may determine current values for its location/orientation parameters. The WTRU may find its current zone in the coverage ensemble, for example, using the estimated values of its location/orientation. The WTRU may find the candidate (cell, beam) pairs corresponding to its determined zone in its locally prepared On-The-Ground overage ensemble. The WTRU may short-list the candidates that may be part of the proactive CPC configuration. The WTRU may select the highest priority CPC candidate (cell, beam) pair among the determined candidates. The WTRU may activate the antenna panel associated with the selected CPC candidate. The WTRU may evaluate the configured execution conditions for the target CPC candidate, which may be a combination or composite over radio and non-radio measurements (e.g., Proposed Events OD1/2 combined with Events A3/A4/A5, etc.). The WTRU may determine the RACH configuration from the conditional configuration corresponding to the selected CPC (cell, beam) pair, for example, if the one or more execution conditions are satisfied. The WTRU may perform the conditional CPC on the target candidate (cell, beam) pair, for example, using the determined RACH parameters. The WTRU may evaluate the release conditions for non-volatile configurations/candidates (e.g., as described herein). The WTRU may continue evaluating the execution conditions (e.g., and may execute the conditional configuration upon fulfillment), for example, if the release condition(s) is (are) not fulfilled. The WTRU may release the associated non-volatile configurations/candidates, for example, if the release condition(s) is (are) fulfilled.

Features associated with the non-volatile proactive CPC may include (e.g., additionally or alternately include) one or more of the following. The CPC configuration may comprise (e.g., two) sets of conditional PSCell change configurations, which may be associated with Device Mobility and External Mobility. The sets of CPC configurations may be indicated to be associated with QoS requirements of one or more applications/services, which may be running at WTRU device. The sets of CPC configurations may be indicated to be associated with one or more WTRU power consumption requirements. The sets of CPC configurations may be indicated to be associated with a WTRU subscription (e.g., active subscription). The set of CPC configurations may be associated with the WTRU speed/velocity. A different antenna panel activation may have one or more other conditions configured, which may keep the link to the master cell group intact, e.g., despite the change of panel for the candidate PSCell.

The WTRU may remove a selected CPC candidate from its short-listed candidates that may provide coverage in its on-the-ground coverage ensemble and/or for which it has received CPC configuration, for example, if execution conditions are not fulfilled for the selected CPC candidate. The WTRU may (e.g., then) select the highest priority CPC candidate from the remaining short-listed candidates, e.g., and perform the next steps.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-13. (canceled)

14. A wireless transmit/receive unit (WTRU) comprising:
a processor configured to:
send assistance information, wherein the assistance information indicates a characteristic associated with the WTRU;
receive conditional handover (CHO) configuration information based on the assistance information, wherein the CHO configuration information includes an external mobility CHO configuration and a device mobility CHO configuration;
determine a radio link failure;
select the external mobility CHO configuration or the device mobility CHO configuration associated with the radio link failure; determine a CHO candidate cell from the selected external mobility CHO configuration or the selected device mobility CHO configuration;
determine that an execution condition is satisfied for the CHO candidate cell; and
send a RACH transmission to the CHO candidate cell.

15. The WTRU of claim 14, wherein processor is further configured to:
determine a location associated with the WTRU and an orientation associated with the WTRU, wherein the determination of the CHO candidate cell is based on the location and the orientation.

16. The WTRU of claim 14, wherein the processor is further configured to:
determine a RACH configuration based on the CHO candidate cell, wherein the RACH transmission is sent in accordance with the RACH configuration.

17. The WTRU of claim 14, wherein the CHO candidate cell is associated with one or more beams, and wherein the processor is further configured to:
determine a RACH configuration based on a strongest beam of the one or more beams associated with the CHO candidate cell, wherein the RACH transmission is sent in accordance with the RACH configuration.

18. The WTRU of claim 14, wherein the radio link failure indicates degradation of a serving link.

19. The WTRU of claim 14, wherein the determination that the execution condition is satisfied is based on a radio measurement and a non-radio measurement.

20. The WTRU of claim 14, wherein the processor is further configured to:
receive coverage information; and
switch an active antenna panel based on the coverage information and the CHO configuration information.

21. The WTRU of claim 20, wherein the coverage information indicates a network deployment of cells and beams and is received via one of: a WTRU dedicated signal or broadcast system information.

22. The WTRU of claim 14, wherein the determination of the radio link failure is based on a radio measurement being below a threshold.

23. The WTRU of claim 14, wherein the selection of the external mobility CHO configuration or the device mobility CHO configuration is based on a non-radio measurement.

24. A method associated with a wireless transmit/receive unit (WTRU) comprising:
sending assistance information, wherein the assistance information indicates a characteristic associated with the WTRU;
receiving conditional handover (CHO) configuration information based on the assistance information, wherein the CHO configuration information includes an external mobility CHO configuration and a device mobility CHO configuration;
determining a radio link failure;
selecting the external mobility CHO configuration or the device mobility CHO configuration associated with the radio link failure; determine a CHO candidate cell from the selected external mobility CHO configuration or the selected device mobility CHO configuration;
determining that an execution condition is satisfied for the CHO candidate cell; and
sending a RACH transmission to the CHO candidate cell.

25. The method of claim 24, further comprising:
determining a location associated with the WTRU and an orientation associated with the WTRU, wherein the determination of the CHO candidate cell is based on the location and the orientation.

26. The method of claim 24, further comprising:
determining a RACH configuration based on the CHO candidate cell, wherein the RACH transmission is sent in accordance with the RACH configuration.

27. The method of claim 24, wherein the CHO candidate cell is associated with one or more beams, further comprising:
determining a RACH configuration based on a strongest beam of the one or more beams associated with the CHO candidate cell, wherein the RACH transmission is sent in accordance with the RACH configuration.

28. The method of claim 24, wherein the radio link failure indicates degradation of a serving link.

29. The method of claim 24, wherein the determination that the execution condition is satisfied is based on a radio measurement and a non-radio measurement.

30. The method of claim 24, further comprising:
receiving coverage information; and
switching an active antenna panel based on the coverage information and the CHO configuration information.

31. The method of claim 30, wherein the coverage information indicates a network deployment of cells and beams and is received via one of: a WTRU dedicated signal or broadcast system information.

32. The method of claim 24, wherein the determination of the radio link failure is based on a radio measurement being below a threshold.

33. The method of claim 24, wherein the selection of the external mobility CHO configuration or the device mobility CHO configuration is based on a non-radio measurement.
